(19) United States
(12) Patent Application Publication
(10) Pub. No.: US 2025/0147300 A1
(43) Pub. Date: May 8, 2025

(54) Dynamic Micro-Optic Security Devices, Their Production and Use

(71) Applicants: Bank of Canada, Ottawa (CA); National Research Council of Canada, Ottawa (CA)

(72) Inventors: Daniel Brassard, Longueuil (CA); Alex Boutin, Longueuil (CA); Charles Douglas Macpherson, Santa Barbara, CA (US); Badr Omrane, Ottawa (CA)

(21) Appl. No.: 18/721,305

(22) PCT Filed: Dec. 21, 2022
(86) PCT No.: PCT/CA2022/051875

§ 371 Date: Jun. 18, 2024

(30) Foreign Application Priority Data
Dec. 22, 2021 (CA) 3143656

(51) Int. Cl. G02B 26/00; B42D 25/29; B42D 25/324; B42D 25/342; B42D 25/36

(52) U.S. Cl. CPC G02B 26/004; B42D 25/324; B42D 25/342; B42D 25/36; B42D 25/29

(57) ABSTRACT

Disclosed are devices with dynamic optical properties suitable for use as security or authentication devices, for example for documents or items of importance or value, in order to help prevent counterfeit of the same. Such devices, at least in selected embodiments, enable observation of dynamic changes or moving entities within the device by collective or enhanced imaging of the dynamic changes or moveable entities, the motion or position of which may otherwise be difficult to observe, or indiscernible to, the naked eye.

### CROSS REFERENCE TO RELATED APPLICATION

This application claims the priority right of Canadian patent application 3,143,656 filed Dec. 22, 2021, the contents of which are incorporated herein by reference.

### FIELD OF THE INVENTION

The present invention relates to the field of optical devices, particularly optical devices that may be used, for example, as security features for items of value, documents and bank notes, for authentication purposes.

### BACKGROUND

Documents or items of importance or high value may be susceptible to counterfeit. Such documents and other items of value may include, for example, banknotes, cheques, passports, identity cards, credit cards, certificates of authenticity, and other documents for securing value or personal identity, as well as labels and tags for high-value items and packaging or the like. To improve security, and to help avoid counterfeit, such documents and items may include specific conspicuous or inconspicuous security features or devices that are difficult for counterfeiters to replicate. Optionally, the security features or devices may be applied or adhered to the substrate surface of the document or item. Alternatively, they may be integrated into the document or item, or the substrate thereof.

For some applications, it may be preferable for security devices to be very thin so that they do not protrude significantly from the surface of the document or item. For some applications such as documents, it may also be preferable for security devices to be flexible so that they can bend and flex with the substrate of the document during normal use. Examples of such devices include holograms, thin films, and micro-optic features.

In the case of micro-optic devices, such devices are typically known to comprise two-dimensional arrays of convex microlenses in association with an array of printed or etched images or image icons, wherein a design or offset nature of the images relative to the microlenses may give rise to various moiré effects that are known in the art.

While micro-optic devices have demonstrated usefulness for security and authenticity, counterfeit prevention remains a challenge. Over time, counterfeits employ increasingly sophisticated techniques in their attempts to replicate security features and devices. Accordingly, there is a continuing need in the art for improved security features and devices to provide authenticity to items and documents of value and/or importance. In particular, there is a need for security features and devices suited to paper, polymer or plastic substrates and documents, which provide optical effects that are difficult to deconstruct or replicate. Moreover, the development of an active security device or feature with a thin design profile, that is durable, that does not require external power, that has a scalable manufacturing route, that can be applied to the banknote with existing equipment, and that is highly overt and intuitive, and which requires only a low level of interaction by public to activate the dynamic features of the device, would represent a major breakthrough in document security.

### SUMMARY

It is an object of the invention, at least in selected embodiments, to provide a security device for an item or document that is difficult to deconstruct and/or replicate.

It is another object of the invention, at least in selected embodiments, to provide an item or document with one or more security devices or features for authentication, wherein the one or more security devices or features are difficult to deconstruct and/or replicate.

It is another object of the invention, at least in selected embodiments, to provide a method of authentication for an item or document of importance or value.

Selected embodiments encompass an optical device that combines a form of image or virtual image generation, together with at least one observable, detectable or dynamic effect to be observed in the image or virtual image. The observable, detectable or dynamic effect may optionally only be observable by virtue of the image or virtual image generation, or may be observable or detectable by the naked eye, or alternatively with the assistance of a viewing or detection device. Moreover, the nature of the observable, detectable or dynamic change may take any form, including but not limited to spatial changes, movement, colour changes, changes of hue or brightness, changes of appearance, changes of pattern, changes of apparent texture, dynamic changes for image icons, changes in image magnification, any of which are enhanced or observable in the image or virtual image. In selected embodiments, for example, an image generator of any kind as herein described may be combined with dynamic or changeable images or image icons, for observation or detection of the dynamic observable or detectable changes.

In one exemplary embodiment there is provided a
security device comprising:
an array of compartments;
one or more entities, with at least a majority of the compartments containing one or more of the entities therein, each entity moveable within the compartment within which it is contained when the device is subjected to an external influence or force, wherein resulting movement of at least some of the entities includes common, at least partially synchronized movement thereof, within and relative to their respective compartments, across at least a portion of the compartments; and
an image generator to selectively combine at least some of the common, synchronized movement of the entities within and relative to their respective compartments into an observable image.

Selected embodiments comprise a moiré magnification device, comprising:
as the image generator, an array of microlenses or micromirrors;
as the array of compartments, a 2-dimensional array of microchambers in association with the array of microlenses or micromirrors;
wherein the microlenses and microchambers are arranged such that the array of microlenses or micromirrors generate a moiré magnified image of at least a portion of the microchambers and/or their contents, as the observable image.

In further selected embodiments each microchamber is filled with a composition comprising:
(i) a liquid, such that the liquid is sealed into each microchamber; and
(ii) at least one entity immersed in the liquid within each microchamber, the at least one entity insoluble or immiscible in the liquid, the at least one entity freely movable by rotation and/or translocation within the liquid when the device is subjected to an external influence or force.

In selected embodiments, the array of microchambers comprises an area of adjacent microchambers each filled with the same or substantially the same compositions compared to other microchambers in said area, so that when the device is subjected to the external force the compositions within the adjacent microchambers within said area react within their respective microchambers in a uniform or substantially uniform manner in terms of movement of the entities they contain, such that the collective movement of the entities within the microchambers of the area forms at least a part of the moiré magnified image.

In selected embodiments, each entity is freely movable within and through the liquid within which it is immersed, by dynamic displacement of the liquid when the device is subjected to an external influence that is an external force.

In selected embodiments the array of microchambers comprises an area of adjacent microchambers each filled with the same or substantially the same compositions compared to other microchambers in said area, so that when the device is subjected to the external influence or force the compositions within the adjacent microchambers within said area react within their respective microchambers in a uniform or substantially uniform manner in terms of movement of the entities they contain and/or the dynamic displacement of the liquid caused by movement of the entities they contain, such that the collective movement and/or the dynamic displacement forms at least a part of the moiré magnified image.

Further embodiments provide the use of any device as described herein, as a security or authentication device for a document or item.

Further embodiments provide a document or item comprising, as a security or authentication device, at least one device as described herein.

Further embodiments provide a method of checking the authenticity of a document or item, by observing and/or manipulating at least one device as defined herein.

Further embodiments provide a method of checking the authenticity of a document or item, by observing and/or manipulating at least one device as defined herein by human hand and/or the unaided human eye.

### BRIEF DESCRIPTION OF THE DRAWINGS

FIG. 1 in general provides photographs showing two different devices that combine microlens arrays overlying arrays of fluid-filled microchambers containing blue or transparent fluid.

FIG. 1a is a photograph of a closer image of a device within a circular window portion of a sample bank note.

FIG. 1b is a photograph of a device as mounted on a microscope slide. Both devices provide bright and overt moiré magnification effects with magnified virtual images of the fluid-filled microchambers influenced by the angle of observation.

FIG. 2 in general provides photographs to show dynamic effects of moiré magnified particle sedimentation within fluid-filled microchambers.

FIG. 2a provides a series of photographs of the same moiré magnified image over time immediately after the device is flipped over.

FIG. 2b provides a still image from a video at 5× magnification to view microlens arrays placed above microchambers filled with fluid containing particles that sediment under gravity.

FIG. 2c provides a photograph of a still image from a video at 10× magnification, as viewed from an underside of a device without the influence of the microlens array.

FIG. 3a schematically illustrates in a microscopic cross-section side view the motion of particles in fluid, within fluid-filled microchambers as the device is flipped over rapidly and placed horizontal and motionless upon a horizontal surface. For simplicity and for ease of understanding, only two microchambers and two microlenses are illustrated in cross-section.

FIG. 3b schematically illustrates a top plan view of a device incorporating the device schematically illustrated in FIG. 3a, as if part of a bank note, which is flipped over as illustrated in FIG. 3a.

FIG. 3c provides a series of photographs taken over time immediately after the device is flipped over of:
(a) Macroscopic views of a working device of FIGS. 3a and 3b. Timing (steps 1 to 5): 0 s; 2.5 s; 3.5 s; 4.5 s; 6.0 s. Scale bar: 5 mm.
(b) Microscopic views of a working device of FIGS. 3a and 3b without microlenses present. Timing (steps 1 to 5): 0 s; 2.0 s; 3.0 s; 3.5 s; 6.0 s. Scale bar: 50 μm.
(c) Microscopic view of a working device of FIGS. 3 and 4a with microlens present. Timing (steps 1 to 5): 0 s; 1 s; 2 s; 4 s; 6.0 s. Scale bar: 100 μm.

FIG. 4a provides a photograph of a moiré magnified image of fluid and particle filled hexagonal microchambers, with the device oriented vertically with respect to gravity, so that the particles that appear in the moiré magnified image are observed in mostly a sedimented state in bottom portions of the virtual microchamber images. Scale bar: 5 mm.

FIG. 4b provides a photograph of multiple devices each with alternative degrees of rotation of the moiré magnified images, such that observed sedimentation of particles within moiré magnified images of microchambers appears to occur in directions other than the direction of the force of gravity (lighter colour portion of the hexagonal microchambers shows sedimented particles).

FIG. 5a provides a schematic side view of a device in cross-section, as it undergoes a series of rotations between which the device is maintained at a vertical orientation with respect to gravity. For simplicity and ease of understanding, only two microlenses and two fluid and particle filled microchambers are shown in cross-section, to illustrate how the particles move and settle during each of the steps. The first illustration shows the device in a motionless horizontal state before it undergoes the steps.

FIG. 5b schematically illustrates the appearance of the same device illustrated in FIG. 5a, with the same steps, but as the device may appear to a user of the device. The first illustration is a top plan view of the device as though forming part of a bank note, with moiré magnified images of the microchambers visible to the user. The remaining illustrations provide a top side view of the device as the bank note adopts various vertical orientations with respect to gravity.

FIG. 5c provides a macroscopic side view photographs of a working device with a moiré magnified image, following rotation of the device. Timing of steps 1 to 4:0 s; 2 s; 5 s; 10 s. Scale bar: 5 mm.

FIG. 5d provides a macroscopic side view photographs of various working devices corresponding to FIG. 5a that are held vertically, but with different microlenses arrays that provide different rotation of moiré magnified images. Arrows show the direction of sedimentation in the magnified images. The size of the cells in magnified image is about 10 mm in (a), 2.5 mm in (b) and 3.0 mm in (c).

FIG. 6a provides a photograph of a moiré magnified image of microchambers generated by an example working device as described herein, within which bubbles are present at the ‘top’ of the hexagonal microchambers in the images (opposite the sedimented light-coloured particles) such that virtual moiré magnified bubble images are generated.

FIG. 6b provides a photograph of a moiré magnified image of hexagonal microchambers generated by an example device as described herein, within which bubbles are present within the microchambers, such that virtual moiré magnified bubble images are generated. In this photograph taken after the device has been flipped over, the particles are part way through their sedimentation, and the bubble is seen as moving through, and tracing a path through, the sedimenting particles on the left side of the moiré magnified image.

FIG. 6c provides a photograph of a moiré magnified image of hexagonal microchambers generated by an example device as described herein, within which bubbles are present within the microchambers, such that virtual moiré magnified bubble images are generated.

FIG. 7a provides schematic side cross-sectional illustrations of a device comprising microlenses, together with fluid-containing microchambers each also containing a bubble of gas (e.g. air), as the device undergoes a series of steps including flipping and tilting of the device relative to gravity.

FIG. 7b schematically illustrates the appearance of the same device illustrated in FIG. 7a, with the same steps, but as the device may appear to a user of the device. The device is illustrated as if present on a portion of a bank note, with moiré magnified images of microchambers and the bubbles they contain.

FIG. 8 provides schematic side cross-sectional illustrations of example devices comprising microlenses, together with fluid-containing microchambers each also containing a bubble of gas (e.g. air), with (a) showing a curved top wall of the microchambers when the device is at rest on a horizontal surface, and with (b) showing a top wall with a groove or channel such that each bubble has a tendency to stay in each groove or channel when the device is at rest on a horizontal surface.

FIG. 9a provides schematic side cross-sectional illustrations of a device comprising microlenses, together with fluid-containing microchambers each also containing a bubble of gas (e.g. air) as well as microscopic elements or particles that are also less dense than the fluid within which they are contained, as the device undergoes a series of steps including flipping and tilting of the device relative to gravity.

FIG. 9b provides top plan view photographs of a working device comprising microchambers, the majority of which contain a bubble, as well as particles that are more dense than the fluid medium within which they are contained, with row (a) providing macroscopic views from above the device, with time after flipping (of steps 1 to 3): 0 s; 1 s; 6 s. Scale bar: 5 mm; and with row (b) providing microscopic views from above a device without microlenses present, with timing (of steps 1 to 3): 0 s; 1 s; 6 s. Scale bar: 50 μm. Force of gravity pointing downwards into the sheet of drawings.

FIG. 9c provides top plan microscopic photographic views from above working devices using different coloured fluids for each of (a) to (c). Steady state. Force of gravity pointing downwards into the sheet of drawings.

FIG. 10 provides macroscopic photographic side views of a working device, with the force of gravity pointing downwards relative to the sheet of drawings-Scale bar: 5 mm. Timing (of the photographs providing steps 1 to 6).
1. 0 s (initial state);
2. 1 s (just after reorientation);
3. 2 s (1 s after reorientation);
4. 11 s (just after completing additional rotation to 360° compared to initial state);
5. 13 s (2 s after step 4);
6. 40 s (20 s after a final rotation step, nearly reaching new equilibrium state). FIG. 10 schematically illustrates a device with a “hide-and-reveal” functionality for virtual text images.

FIG. 11 schematically illustrates a device in side cross section just after it is flipped over (left side), and some time after it has been flipped over and left to settle in a horizontal position (right side).

FIG. 12 schematically illustrates the device illustrated in FIG. 11 in top plan view, just after it is flipped over (left side) and some time after it has been flipped over and left to settle in a horizontal position (right side).

FIG. 13 schematically illustrates in top plan view to show how the entirety of a device as illustrated in FIGS. 11 and 12 may appear to a user as if positioned to form part of a bank note, with moiré magnified images showing little or no text content (left side) immediately after the device is flipped over and placed in a motionless, horizontal position, and with text appearing within the moiré magnified images some time later (right side).

FIG. 14 schematically illustrates a device as if mounted upon a bank note, that employs random or Brownian motion of particles suspended in fluid-filled microchambers, with microlenses to provide magnification of certain portions of the microchambers, thereby to amplify the optical effect that the particles can have as they undergo random or Brownian motion, including random translational and/or rotational motion.

FIG. 15 in general provides simulated rendered images of a device corresponding to that shown in FIG. 14.

FIG. 15a, in a top portion of the rendered image, shows a device with individual microlenses magnifying small portions of underlying textured substrate to simulate microchambers containing the fluid and randomly moving particles, whereas the bottom portion of the photograph shows the textured substrate without overlying microlenses.

FIG. 15b provides a rendered image of a closer view of the lower portion of FIG. 15a.

FIG. 15c provides a rendered image of a closer view of the upper portion of FIG. 15a, with microlenses magnifying portions of the textured substrate beneath, and appearing to switch between dark and light emitted light through each microlens according to the random dark or light shaded portions of the textured substrate beneath that intersect a focal point of each microlens.

FIG. 16 provides an example of the magnification and rotation angle of a moiré magnified image that is obtained for various values of θₒ and S.

FIG. 17 provides an example of the magnification and rotation angle of a moiré magnified image that is obtained for various values of θₒ and S.

FIG. 18 illustrates schematically the process developed to generate local perturbations in moiré magnified images.

FIG. 19 provides a general configuration considered for the numerical simulations shown in subsequent figures.

FIG. 20 provides the results of a numerical simulation showing an example of local perturbations in the magnified image

FIG. 21 provides the results of a numerical simulation showing an example of local perturbations in the magnified image.

FIG. 22 shows the results of a numerical simulation showing an example of more complex local perturbations in the magnified image, with a rotation specified of the magnified image by 90° along a maple-leaf shaped region, and a magnification from 50 on the edge of the device to 100 in the center.

FIG. 23 shows the results of a numerical simulation showing an example of more complex local perturbations in the magnified image, with a rotation specified of the magnified image by 90° along a maple-leaf shaped region, and a magnification from 50 on the edge of the device to 100 in the center.

FIG. 24 provides another example of a more complex image deformation. In this case, a rotation angle was specified for the magnified image changing continuously from 180 to 270 deg around a central point located in the corner of the device with a constant magnification factor of 100.

FIG. 25 provides another example of a more complex image deformation. In this case, a rotation angle was specified for the magnified image changing continuously from 180 to 270 deg around a central point located in the corner of the device with a constant magnification factor of 100.

FIG. 26 provides another schematic illustration of the presence of an image generator such as microlens array used to amplify the visualisation of Brownian motion (BM), as it may appear on a device that forms part of a bank note.

FIG. 27 illustrates example embodiments for devices comprising different zones with alternative optical effects. Such alternative optical effects may be caused by different properties of either the microchamber array and/or the microlens array in different areas of the device.

FIG. 27a illustrates top plan views of an example device, with an area in the shape of a maple leaf exhibiting alternative microchamber rotation and scale compared with the surrounding area.

FIG. 27b shows how the optical properties of the microchamber array for the leaf area are different from those of the surrounding area—in this instance, the leaf area is scaled and rotated by a different amount relative to the microlens array (0.990× and) 0.0° and relative to the surrounding area (1.010× and) 0.573°.

FIG. 27c shows a micrograph of the two different types of microfabricated microchamber arrays located inside and outside the maple leaf area.

FIG. 27d provides six examples labeled A to F of possible devices configurations leading to different image magnifications and image rotations inside the leaf area and in the outer region.

FIG. 28 provides schematic illustrations showing how the devices A-F listed in FIG. 27d may appear to a user when held vertically, with the numbers showing degrees of relative magnification in the different regions of the device (the maple leaf areas exhibiting 50% or 25% magnification relative to the magnification in the surrounding area), together with the arrows showing the apparent dynamic motion of particles collectively observed in the moiré magnified image, resulting from rotated moiré magnified images.

FIG. 29 provides photographs a), b) and c) of working devices corresponding to those schematically illustrated in FIGS. 27 and 28, showing a maple leaf shape with a lower magnification and different rotation relative to the surrounding areas. In each photograph the device is positioned within a window of a banknote substrate. Dynamic movement and collective virtual imaging of the movement of particles within microchambers (lighter colour within the hexagonal moiré magnified microchambers) may be observed as the device is tilted or flipped over. The alternative direction of the dynamic motion within the maple leaf relative to the surrounding area is similar to device layout B illustrated schematically in FIG. 28.

FIG. 30 generally provides photographs of a working example device with microchambers each containing a liquid and a combination of floating green particles and sedimenting grey particles, with moiré magnification of the microchambers achieved with an associated microlens array.

FIG. 30a shows a virtual moiré image as observable by a user, showing the relative positions within the magnified microchamber image of the different particle types.

FIG. 30b provides a series of photographs of the same device at various times after reorientation by rotating the device about its plane. Common motion of particles within the microchambers is observed in the moiré magnified image, as the green particles generally float up one side of the magnified microchamber image, while common motion of the sedimenting grey particles is observed as they generally pass down an opposite side of the magnified microchamber image.

FIG. 31 provides photographs showing moiré magnified images of a working embodiments, in which the three-dimensional structures of the microchambers are visible and perceptible in the magnified image when the device is manipulated and/or tilted, thereby providing a corresponding three-dimensional virtual image of the microchambers.

FIG. 31a provides still images of this effect, with magnification of microchambers containing a liquid.

FIG. 31b also provides still images of this effect, with magnification of microchambers containing a liquid.

FIG. 31c shows magnified microstructures of empty microchambers (empty in that they contain air rather than liquid) that are amenable to such three dimensional moiré magnification.

FIG. 31d further shows magnified microstructures of empty microchambers (empty in that they contain air rather than liquid) that are amenable to such three dimensional moiré magnification.

FIG. 32a provides schematically a top plan view of a hexagonal array of microchambers each comprising surface relief at the base of each microchamber (on an internal surface of the microchambers opposite the microlens array) of dollar signs approximately 5 μm in height from the floor of each microchamber.

FIG. 32b provides schematically a top plan view of a hexagonal array or microchambers similar to FIG. 32a, but with each microchamber comprising surface relief in the shape of snowflakes extending 3-5 μm in height from the floor of each microchamber.

FIG. 32c shows a perspective scanning electron micrograph of a fabricated device corresponding to that shown in FIG. 32a, showing microchambers with fabricated dollar signs in relief extending in height only part way of the full height of the lumen of the microchambers. In this way, the surface relief generated in each microchamber may be similar to that illustrated schematically in FIG. 11.

FIG. 32d shows schematically a top plan view of two arrays of microchambers, with the dark dollar sign or snowflake shapes indicative of the shapes of the microchambers themselves, and their side walls.

FIG. 32e schematically illustrates alternative concepts in which the microchambers are effectively a “negative” of those shown in FIG. 32d.

FIG. 32f provides a photograph of a top plan view of a working example moiré magnification device, where the microchambers are each in the shape of a dollar symbol ($).

FIG. 33a schematically illustrates, assuming perfect microlenses, that the characteristic distance that a spherical particle needs to move in the plane of the microlenses to create a change in the image contrast is given approximately by the particle radius (i.e. L˜r).

FIG. 33b shows schematically that, for particles experiencing Brownian motion in the configuration of FIG. 33a, the time constant, required to change significantly the image of the microlenses, increases very rapidly with particle size (˜r³).

FIG. 34a shows a 1× view of a simulated feature or device on a bank note, with Brownian motion of spherical particles of 1.5 μm size placed under a microlens array.

FIG. 34b shows a 100× microscopic view of FIG. 34a through simulated microlenses of a simulated feature or device on a bank note, with Brownian motion of spherical particles of 1.5 μm size.

FIG. 34c shows a 400× microscopic view without microlenses present, of a simulated feature or device on a bank note, with Brownian motion of spherical particles of 1.5 μm size.

FIG. 35 shows a schematic microscopic view of 4 μm cylindrical flakes placed under a microlens array experiencing translational and rotational Brownian motion. The simulation studies the effects of flake rotation upon the perception of the flakes as they undergo Brownian motion, first evaluated for 4 μm diameter flakes, with illumination by a 20 cm diameter light source placed on the side of the bank note.

FIG. 36 shows the amount of reflected light visible by an observer as a function of the rotation angle of the flakes placed under a microlens array. Large contrast changes (>20 to 1) with small changes in the flake angle were obtained in this configuration. Various reflections spikes were also observed due the complex light path through the microlens array and flake reflection.

FIG. 37 illustrates a further simulation, showing that fast shimmering and good contrast can be obtained through rotational Brownian motion of reflective flakes—in this case 4.0 μm low roughness cylindrical flakes, with a large side light.

FIG. 37a shows a 1× view of the same.

FIG. 37b shows a 100× microscopic view of the same.

FIG. 38 generally illustrates a working example to evaluate Brownian motion effects with a 54 μm pitch MLA at high Moiré magnification, with an ink containing flat reflective flakes.

FIG. 38a shows photos (stills from videos) of a device in a window of a bank note at various magnifications, showing moiré magnification of particles undergoing Brownian motion.

FIG. 38b shows a microscopic bottom view of the microchambers present in the device, without moiré magnification as no microlenses are observed in this bottom view.

FIG. 39 shows an example computer simulated micro-optic device incorporated into a simulated bank note showing magnified image of microchambers filled with a transparent liquid and each containing a gas bubble.

FIG. 40 provides photographic images (with magnified versions inset) of top plan views of a working device comprising an array of hexagonal microchambers, each containing a single red particle, as observed in the simulation embodiments, with higher degrees of positional variation or uncertainty in the particle position causing blurring of the bubble's appearance in the simulated moiré magnified image (top row of images). The middle and lower rows of images show microscopic top and side schematic views of the same device (without simulated moiré magnification), showing increasing degrees of positional variation for the particles in the microchambers from left to right, which in turn gives rise to increased degrees of blurring of the particle magnified images, as visible in the top row from left to right.

### DEFINITIONS

Array: refers to any two or three dimensional optionally ordered array of, for example, lenses, microlenses, compartments, microchambers, holes, channels, masking structures, etc. that are ordered in any way. For example, 2-dimensional arrays may include hexagonal, rectangular, concentric or any other type of array or patterns for the elements of the array.

External influence: pertains to any force, action, radiation, field, movement, or any change of any force, action, radiation, field, movement, and the like that has an effect upon a security device as described herein, or any part thereof, to cause fluid in the device or elements within the fluid to be redistributed within the device. The influence may involve physical contact with the device (e.g. mechanical pressure upon the device) or may be a remote influence without physical contact (e.g. radiation of any type falling upon the device). An external influence may also be selected from the following non-limiting list of examples:
a change in temperature;
exposure to visible or beyond visible light;
shaking, tipping, flipping, or vibrating the device;
acceleration or deceleration;
an electric field;
a magnetic field;
a change in potential difference across the device or any part thereof;
a change in pressure upon the device or any part thereof;
induced high or low g-forces; and
bending, folding, flexing or pressing the device, or any part thereof.

In some exemplary embodiments an external influence may be brief and temporary and yet still be sufficient to achieve at least temporary or momentary redistribution of fluid or other elements in a security device sufficient for a change in properties, such as optical properties or optical appearance of the device. For example, a brief burst of external stimulus may in some examples trigger an optical change that is permanent or that lasts sufficient time (e.g. 1 second to a few minutes) for user observation. In other exemplary embodiments it may be necessary to apply a continuous or semi-continuous external stimulus to the security device to achieve redistribution of fluid or entities that can be observed by a user. In some such embodiments, removal of the external stimulus may then cause the distribution of the fluid or entities to revert back to a situation similar to or indistinguishable from that before the external stimulus was applied, such that the security device then re-assumes its properties or an optical appearance prior to application of the external stimulus. Fluid: any of, a liquid, a gas, a mixture or dispersion or solution or colloid or suspension of a gas in a liquid, a liquid foam, a mixture or dispersion or colloid or suspension of a liquid in a liquid, an emulsion, a mixture or dispersion or colloid or suspension of a solid in a liquid, a sol, a gel, a liquid crystal; an oil/water mixture optionally comprising a surfactant; aqueous solutions, organic solvents and solutions, isoparaffins, a liquid dye, a solution of a dye in water or an organic solvent, a dispersion or suspension of a pigment in a liquid optionally with colour-changing and or colour-shifting properties; a magnetic fluid or a ferrofluid (dispersed or suspended magnetic particles in a liquid that respond to an applied magnetic field); an electrophoretic or electrokinetic fluid (dispersed or suspended charged particles in a liquid that respond to an applied electric field); an electrorheological fluids (e.g. fluids that change viscosity in response to applied electric field such as that supplied by Smart Technology Limited, fluid LID3354S), a magnetorheological fluid, a shear thickening or thixotropic material; a high refractive index oil, a low refractive index oil, a fluoroinated fluid, Fluoroinert™ electronic liquids such as 3M FC-770; an ionic liquid or liquid electrolyte, an ionic solution, a liquid metal, a metallic alloy with a low melting point such as gallium or and indium containing alloys (such as Indalloy® alloys offered by Indium Corporation); a liquid with a large temperature expansion coefficient; a solution or a dispersion whereby a dissolved or dispersed phase (a gas, a liquid, a solid) goes into or out of solution or dispersion in response to an external stimulus (such as, but not limited to, a change in pressure and or temperature). Optionally, the fluid may comprise a single phase of a liquid, gas or particulate solid, or alternatively the fluid comprises more than one phase. Optionally, the fluid may undergo a phase change in response to one or more external stimulus, wherein a phase change may comprise a transition of at least a portion of the fluid from one state (e.g. solid, liquid or gas) to any other state.

Image generator: refers to any device, assembly, or arrangement that is able to combine similar or common dynamic changes of any kind, or common positions or common movements of items or entities that are within a device as disclosed herein, to display at least some of them as a combined, single or otherwise discernable image or virtual image. Such devices may or may not employ electronic processing to achieve an image or virtual image. Such devices may or may not generate an image or virtual image that is discernible or observable to a user by the naked eye, or alternatively may generate an image that is discernible, detectable or observable with the assistance of a further screening or observation tool. In selected embodiments, an array of microlenses provides one example of an image generator, whereby the microlenses generate a combined image of icons by moiré magnification, wherein microlenses are as defined herein or otherwise known in the art. Other examples of image generators include but are not limited to, for example, an array of holes, chambers, channels, masking structures, compartments (etc.) that have similar pitch and rotation angle compared to the compartment where the entities or microscopic entities are movable. In other embodiments, an image generator may comprise an array of micromirrors, such as concave micromirrors, the collective observation of which generates a virtual image such as a moiré effect, wherein micromirrors are as defined herein or otherwise known in the art. For embodiments, that employ micromirrors, the micromirror arrange may be placed “beneath” a microchamber array when the device is viewed relative to a user's perspective, to provide a moiré effect. This may contrast to selected embodiments that employ microlens arrays, where the microchamber arrays are typically placed “beneath” the microlens array when the device is viewed relative to a user's perspective, to provide a moiré effect.

Microfluidics: is known as the study of the behavior, manipulation, and control of fluids that are confined to structures of micrometer (typically 0.1-100 [symbol] m) characteristic dimensions.

Microfluidic devices: are known to be characterized by conduits or channels with diameters ranging roughly between 100 nm and 100 microns, optionally involving particles with diameters ranging roughly from 10 nm to 10 microns. At these length scales, the Reynolds number is low and the flow is usually laminar, but the mass transfer Peclet number is often large, leading to unique microfluidic mixing regimes.

Microchambers: refers to chambers or compartments of a device, typically arranged in arrays such as ordered arrays, with each suitable to contain a fluid (liquid and/or gas) and entities within the fluid that are enabled to move about within the individual chambers or compartments, for example by displacement of the fluid. In some embodiments, the microchambers may be at least substantially sealed to prevent fluid loss, evaporation, ingress or egress from the chambers. The microchambers may also have any shape, depth, configuration or design in terms of their structure, side walls, compressibility, materials, thickness, volume, internal or external dimensions. In some embodiments microchambers may have internal size dimensions in the range of 0.01 to 1000 microns.

Microlens: refers to any optical device that is able to focus incident light falling upon the lens, by diffraction or refraction, wherein dimensions of the lens are less than 1000 microns, or less than 100 microns, or less than 50 microns, or less than 25 microns, or less than 10 microns across or in diameter. The lens height and/or thickness of the lens may optionally be less than 300 microns, or less than 25 microns, or less than 1 micron. In general, the diameter may dictate the perceived resolution, whereas the thickness of the lens may dictate optical properties such as focal length, or the suitability of the feature for application to various substrates such as ID cards, paper, polymer bank notes, etc. In some embodiments, a refractive microlens maybe extend from or protrude from a substrate material. Such microlenses may be convex or similar, and be comprised of the same material as the substrate material, or may be comprised of the substrate material, or may comprise a different material to the substrate material. Other suitable microlenses may be diffractive microlenses separate from or integral with or formed within the substrate material. Selected diffractive microlenses may simulate or form Fresnel-type lenses, thereby to provide a diffractive structure with diffractive properties varying radially from a centre of the lens position. Other microlenses may comprise a more traditional Fresnel structure, for example, with circular grooves, or circular ridges formed with binary, multilevel or continuous varying surface relief. Further versions and types of microlenses will be apparent to one of skill in the art from the present disclosure as well as common knowledge in the art. Other microlenses may be lenticular in nature. All such microlenses are encompassed within the present definition. Microlenses may be arranged in an ordered two dimensional array of microlenses, for example for the production of moiré devices.

Micromirror: refers to any reflective optical device that is able to reflect, focus or disperse reflected light. Typically, micromirrors have dimensions that are less than 1000 microns, or less than 100 microns, or less than 50 microns, or less than 25 microns, or less than 10 microns across or in diameter. The micromirror height and/or thickness of may optionally be less than 300 microns, or less than 25 microns, or less than 1 micron. Micromirrors may be general flat, convex or concave. To generate an ordered, two-dimensional micromirror array suitable as an image generator as defined herein the micromirrors or the array may be concave and arranged in any fashion.

Moveable entity or entity: refers to any entity, feature, item, substance, bubble, droplet or particle that is able to move, either freely, at random, continuously or only at certain times, or in an ordered or semi-ordered way, either in response to an external stimulus or spontaneously, within a device as described herein. Such moveable entities may be single or plural, or optionally may comprise a multitude of entities at least some of which have the capacity to move in a random, co-ordinated or semi-co-ordinated fashion. Entities may be as dense, more dense or less dense than a fluid or media within which they are contained and within which they move. Examples of particles include flakes and/or those that are fabricated or engineered to have precise geometric shape-see for example the Liquidia PRINT process (particles with precise control over the size, three-dimensional geometric shape and chemical composition). Moveable entities may be charged or uncharged, magnetic or non-magnetic, superparamagnetic, more dense or less dense than surrounding media or fluid. Moreover, moveable entitles May comprise any one or more gas, liquid or solid, or any combination thereof. Further, the moveable entities within the devices may take any form, shape, configuration, colour, substance, state or density. Optionally, in selected embodiments the entities may comprise one or more of the following non-limiting group: liquids, gases, solids, particles, flakes, beads, Janus particles, liquid-containing particles, gas-containing particles, hollow particles such as hollow glass beads, bubbles, foam particles, flowable or non-flowable foams (optionally in the presence of surfactants or stablizers to help prevent bubble merging), and foam beads. In accordance with selected embodiments, entities are typically retained within compartments within the devices disclosed, as described herein. In some embodiments such compartments are in the form of microchambers as described herein. Regardless of the size of the compartments employed, one, more than one, or a plurality of entity “types” may be retained in each of multiple compartments of the device, with multiple compartments of a device thus retaining entities therein. A single compartment may comprise one “type” of entity, or multiple “types” of entity. Moreover, different “types” of entities may be differentiated from one another in terms of one or more of their phase, size, shape, density, materials, charge or any other chemical or physical properties. Moreover, a single compartment may comprise one type of entity such as, for example, a droplet of a liquid immiscible in the fluid media within the compartment, as well as another type of entity such as, for example, a plurality of cylindrical metal particles between 10 and 12 microns in length. Various degrees of tolerance may be employed in the manufacture or use of different any types of entities. For example, in some embodiments it may be desired to employ entities manufactured with specific and narrow tolerances in terms of their size, shape, and other physical properties of the entities of the same type relative to one another (e.g. bubbles that are the same size, or almost all the same size, in the different compartments of the device; or flat-sided disc-shaped metal particles that are 3 microns in diameter +/−only 0.05 microns). The use of tight tolerances for entities present in a device may be useful to generate very close commonality in the way the entities move in the compartments, relative to other compartments containing other entities of the same type, when the device is subjected to an external influence or force. In turn, very similar motion of the entities (due to them being very nearly identical in nature across the compartments present in the device) may give rise to a desired higher image quality or lack of image blurring, for example, in corresponding moiré magnification that provides virtual images of the entities. Improved commonality of movement of the entities may thus be desired in some instances. However, in other embodiments types of entities may be employed that have wider manufacturing tolerances or wider variation in terms of their physical and chemical properties. This may be desired to provide blurring of the resulting moiré magnified images of the entities, resulting from variation or averaging of their motion and position across different compartments of the device, when the device is subjected to an external influence or force. In still further embodiments, a device may include a first type of entity with tight manufacturing tolerances, or little variation in terms of the physical and chemical properties of the entities, and a second type of entity with intentionally higher degrees of variation in terms of the physical and chemical properties of the entities. In such embodiments, when viewed as a moiré magnified image, the image may provide a clearer image of the entities of the first type (as they move with a greater degree of commonality across the compartments) and a less clear image of the entities of the second type (as they move with a greater degree of variation across the different compartments). In still further embodiments, compartments within a device may include multiple types of particles of the same material (e.g. metal particles) with each type being a different size or shape to the other types of entities present. For example, a device may comprise compartments with five types of silver particles, wherein all of the particles are generally spherical, but with the different types having spherical particle size diameters of 2, 5, 10, 20 and 50 microns respectively, with only +/−0.05 microns size variation between particles of the same type (i.e. tight tolerances for the size of the particles of each type). In this way, each type of particle may be caused to move with significant commonality in the compartments across the device, with the movement of each type of entity clearly and separately viewable in the moiré magnified image (due to tight manufacturing tolerances giving rise to significant commonality of movement across the device compartments), but in a manner that is distinct from the movement of the other types of entities present. This in turn may give rise to more complex observed motion of entities in the moiré magnified image, with the motion of the five types of entities viewable but distinguishable from one another in the virtual image. In yet further example embodiments, compartments within a device may include a large number of particles having a distribution of properties, including size, shape, color, roughness, material, density, phase, reflectivity, or any other chemical or physical properties. Even when particles with a wide distribution of properties are present in the compartments, their dynamic displacement within the chambers can lead to observable dynamic effects in a moiré magnified image as long as particle distribution in each chamber is such that the average collective movement leads to a substantially similar optical effect from one chamber to another. Accordingly, any combination of particle types may be employed depending upon the embodiment and the desired optical effect to be achieved.

Nanofluidics: is known to be the study of the behavior, manipulation, and control of fluids that are confined to structures of nanometer (typically 1-100 nm) characteristic dimensions. Fluids confined in these structures exhibit physical behaviors not observed in larger structures, such as those of micrometer dimensions and above, because the characteristic physical scaling lengths of the fluid, (e.g. Debye length, hydrodynamic radius) very closely coincide with the dimensions of the nanostructure itself.

Nanofluidic devices: are known to be characterized by comprising one or more conduits or channels with diameters ranging roughly between 1 nm and 100 nm, optionally involving particles with diameters ranging roughly from 0.1 nm to 10 nm.

Optical change: refers to any change in the appearance of a security device as disclosed herein, or components thereof, that is microscopic or macroscopic in nature, and which is visible to the eye or to a suitable ‘reader’ or detector in either visible or non-visible light or by other forms of electromagnetic radiation. An optical change would include, but is not limited to, a color change in the visible part of EM spectrum, a change in location or distribution of a fluid or an elements or components within the fluid, a change in refractive index for example or a fluid or device component, change in light transmission or reflection for example or a fluid or device component.

Polymer: refers to any polymer or polymer-like substance suitable to form a substrate material e.g. in the form of a sheet-like or roll-like configuration to be formed or cut into a size suitable for use as in security documents. The polymer may be a substantially uniform sheet of polymer material, or may take the form of a laminate structure with layers or polymer film adhered together for structural integrity, such as disclosed for example in international patent publication WO83/00659 published Mar. 3, 1983, which is incorporated herein by reference. Polymers may include but are not limited to UV Curable resins, polypropylene, PMMA, polycarbonate, polytetrafluoroethene (PTFE), PET, BOPP, BOPET, PEN, PP, PVDF and related co-polymers such PVDF-TrFE.

Region (of a substrate): refers to a part of a substrate that includes a specific or defined portion of the substrate that has a refractive index that differs from that of the remainder of the substrate due to substrate post-production modification. Such a region may comprise for example a laser-modified track as described herein, or any modified substrate, polymer, voids, abrogation, or anomaly that achieves the change in refractive index for the material of the region or a part thereof. In selected embodiments the net effect of the material modification is to redirect the propagation of light by optical means of refraction, Fresnel reflection, Rayleigh or Mie scattering, or induction of localized absorption zone. In selected embodiments the collective response of such optical effects from an array of similar modification zones is to induce diffractive and interference effects then aimed to spectrally filter and redirect light with controlled ranges of wavelength and diffraction angles.

Security document: refers to any polymer- and/or non-polymer-based document of importance or value. In selected embodiments, a security document may include features or devices intended to show that the document is a genuine, legitimate or authentic document, and not a non-genuine, illegitimate or counterfeit copy of such a document. For example, such security documents may include security features such as those disclosed herein. Such security documents may include, but are not limited to, identification documents such as passports, citizenship or residency documents, drivers' licenses, bank notes, cheques, credit cards, bank cards, and other documents of monetary value.

Security device or feature: refers to any device or feature that may be added to or incorporated into a security document for the purposes of making that security document more difficult to copy, replicate, or counterfeit, including structures or features incorporated into the substrate material or substrate sheet of the security document, or resulting from modification of the substrate material or substrate sheet. Substrate sheet/substrate material: refers to any material or combination of materials used to form the main structure or sheet of a security document. The material is typically formed into a sheet or planar member and may be composed of at least one substance selected from but not limited to paper, plastic, polymer, resin, fibrous material, metal, or the like or combinations thereof. The substrate sheet may comprise more than one material, layered, interwoven, or adhered together. The material may be smooth or textured, fibrous or of uniform consistency. Moreover, the material may be rigid or substantially rigid, or flexible, bendable or foldable as required by the security document. The core material may be treated or modified in any way in the production of the final security document. For example, the material may be printed on, coated, impregnated, or otherwise modified in any other way as described herein. The substrate material may be transparent and include materials selected from, but not limited to, polymers, dielectrics, semiconductor wafers (silicon is transparent in infrared), glass windshields, architectural glass, display glass, ultrathin flexible glass), etc.

### DETAILED DESCRIPTION OF SELECTED EMBODIMENTS

Described herein are security devices that, at least in selected embodiments, are useful as security or authentication features for items and/or documents of importance or value. Selected embodiments encompass the devices themselves, items or documents comprising them, as well as methods for their manufacture and use. The inventors have endeavoured to develop a new class of security device that, in selected embodiments, provide distinct, dynamic optical properties. Moreover, some embodiments of the security devices as disclosed herein may be caused to change their appearance or optical properties by simple manipulation of the device by the user, or by application of an external influence or force upon the device, or a change of external influence or force upon the device, by the user. In this way, such devices may provide a means for rapid authentication, without necessarily requiring the use of a further external source of energy or screening means. Accordingly, in some embodiments a consumer or user may themselves be able to trigger a change in optical appearance of the device, suitable to verify the authenticity of an item or document to which the device is attached or integrated. In other embodiments, dynamic optical properties may be present, observable or detectable even without the application of an external influence.

Selected embodiments may therefore, potentially, include one or both of two levels of authentication comprising: (1) an appearance of the device before or without exposure to or application of an external influence, and/or (2) a change in appearance of the device upon exposure of the device to an external influence, or application of an external influence to the device. With regard to (2), the change in appearance of the device may appear sudden or progressive, depending upon structure and arrangement of components of the device, and their movement or displacement in response to the external influence.

Accordingly, selected devices herein disclosed provide security features that, in some embodiments, can give rise to dynamic visual changes for example when a document or item comprising the device is tipped or flipped upside down, to obtain a level 1 security feature that can be easily recognized and used by the general public. The speed of the dynamic visual effects according can also be adjusted or tuned, according to the structure and/or components of the device, so that visible changes persist for specific durations after the manipulation of the document. For example, the authentication of a document can be achieved by simply observing the dynamic color changes that occur for a few seconds after flipping the document upside down. The fact that these devices can create dynamic effects (e.g. color change) that persist after the manipulation of the note represents a key distinction compared to some previous optically variable security features where effects are generated through a change of the angle of observation or illumination.

The integration of more advanced visual effects on security documents is a key element that can help increasing the awareness of the general public to the level 1 security features, thus improving counterfeiting resistance. In general, there is a continuing need to improve and develop level 1 security features to keep up with the technological innovations available to counterfeiters. Of particular interests are the features that are not only counterfeiting resistant, but can also be clearly distinguished from previous generation of security features by the general public.

Selected embodiments disclosed herein provide dynamic movement effects that are observable as moiré magnified virtual images. Such dynamic effects result, at least in part, from the physical movement of entities present within the devices, with such physical movement of entities collated or combined by an image generator into a moiré magnified image. In some embodiments the physical movement of the entities may be impossible or difficult to see with the naked eye, and yet the moiré magnified imaging permits a user to observe such physical movement in the form of a virtual image.

For clarity, selected moiré devices of the prior art provide simulated motion and depth effects, including orthoparallactic motion effects of icon images. However, the icons themselves in such prior art devices are typically static, and the observed motion and/or depth effects for the observer are caused by the moiré magnification and virtual imaging of those static icons. Accordingly, selected embodiments as disclosed herein provide an additional level of dynamic movement to the moiré devices, because the static icons of the prior art devices are effectively replaced (at least in part) with icons comprising entities that are themselves able to undergo physical movement (e.g. translocation and/or rotation), and this movement of such entities further contributes to the dynamic appearances of the devices.

In this way, selected embodiments therefore permit one or both of the following mechanisms to achieve a dynamic appearance to the devices:
1. Movement effects achieved by moiré magnification of entities that are themselves capable of physical movement (e.g. translocation and/or rotation) in the device; the virtual moiré image permitting such physical movement to be visualised or detected, or more readily visualized or detected; and/or
2. Optionally, additional motion effects achieved in a more “traditional” way for moire-type devices, by icon image offset to achieve motion and depth effects.

Selected embodiments therefore provide new levels of dynamism to the optical effects, which may be generated and tailored for specific applications.

Selected embodiments provide dynamic security devices that can create a magnified image that reveals, preferably to the naked eye, the collective and substantially synchronized displacement of microscopic entities (particles, bubbles, flakes, droplets, etc.) dispersed in a regular array of microscopic chambers following manipulation of the device (e.g. flipping, tilting, bending, shaking, etc.) or application of an external force (magnetic, electric, acceleration, pressure, centrifugal force, light, sound, etc.). As discussed herein, in selected embodiments the type of dynamic effects that these devices can generate are clearly distinct compared to the effects that are possible in many security devices disclosed in prior art, which makes them particularly appealing as a new type of Level 1 security feature.

Selected embodiments provide devices that enable a visual change, or an image or a virtual image in which the change of appearance is visible to the naked eye. In other embodiments, the devices may be more covert in nature, such that the optical change is detectable by or enhanced by the use of a screening tool, or in the presence of selected types of incident electromagnetic radiation.

Selected embodiments encompass any optical devices that combine any form of image or virtual image generation, together with any form of dynamic effect to be detected or observed in the image or virtual image. The dynamic effect may optionally only be observable by virtue of the image or virtual image generation, or may be observable or detectable by the naked eye, or alternatively with the assistance of a view or detection device. Moreover, the nature of the dynamic change may take any form, including but not limited to spatial changes, movement, colour changes, changes of hue or brightness, changes of appearance, changes of pattern, changes of apparent texture, dynamic changes for image icons, changes in image magnification, any of which are enhanced or observable in the image or virtual image. In selected embodiments, for example, an image generator of any kind as herein described may be combined with dynamic or changeable images or image icons, for observation or detection of the dynamic changes.

In certain embodiments, the devices may comprise a plurality of moveable entities that are able to be displaced and/or that are able to rotate, with some degree of conformity or commonality between the movement of the moveable entities within the device, for example when an external influence is applied to the device. Such devices may further comprise means to at least partially, or selectively, observe at least part of the conformity or commonality of movement of the moveable entities, such that the collective common movement of the moveable entities becomes observable or perceivable by a user of the device, either with or without the additional assistance of a screening or observation tool or other means.

Accordingly, selected embodiments provide a security device comprising an array of compartments, with each compartment containing one or more moveable entities that have the capacity for independent movement within the compartments when the device is subjected to an external influence or force. The array may be a one, two or three-dimensional array, or other arrangement of the compartments. Typically, though not necessarily, the compartments are entirely separate and distinct from one another such that the moveable entities within them are confined to individual compartments by virtue of their structure and construction, as well as the nature of the moveable entities within them. Regardless, movement of the moveable entities within the compartments, for example when the device is subjected to an external influence or force, comprises at least some degree of common, effectively synchronized movement of at least some entities across at least a portion of the compartments. In other words, at least some of the moveable entities exhibit a degree of commonality in one or more of the direction, flow, motion, rotation, displacement or translocation of their movement in response to the external stimulus or force, even though they may be located within or isolated to separate compartments of the array of compartments. Any types, configuration and construction of the compartments may be utilized, and any types of moveable entities may be utilized, with any type of motion or displacement, depending upon the nature of the device and the embodiment in question.

Such devices further include an image generator as herein defined, to selectively combine at least some of the common, synchronized movement of the entities within the separate compartments into an observable image. Any image generator as defined herein, or as generally understood in the art, may be employed for this purpose. The image generator thus enables at least some of the commonality or consistency between movement of the moveable entities across multiple compartments to be visualized, observed or perceived together as a single or multiple images, optionally as virtual images. Optionally the image generator may actively or passively, intentionally or unintentionally, “filter” out or average out any noise that might be created by the occurrence of any non-common or unsynchronized movement of the moveable entities between them multiple compartments (if any). Essentially, therefore, selected embodiments may permit the common or synchronized movement to be enhanced in terms of its visual perception, detection or appearance. In other embodiments, the common or synchronized movement may be difficult or impossible to observe in the device without the enhancement, magnification, or improvement in detection, perception or observation provided by the image generator, to generate the observable or detectable image.

The compartments of the device may take any form, shape or configuration individually or relative to one another, and may be of consistent or inconsistent form, shape or configuration across the array of compartments, or may vary across the array. Further, the compartments may be constructed via any method, and comprise any form of material to define the compartments, such as the walls of the compartments. Optionally, the compartments may comprise walls to prevent loss or leakage of the one or more entities contained in each compartment, and to separate the contents of the compartments from one another.

Further, the moveable entities within the devices may take any form, shape, configuration, colour, substance, state or density. Optionally, in selected embodiments the entities may comprise one or more of the following non-limiting group: liquids, gases, solids, particles, flakes, beads, Janus particles, liquid-containing particles, gas-containing particles, bubbles, foam particles, and foam beads. Such moveable entities may be caused to undergo any form of movement within the compartments of the device in response to any external stimulus, including but not limited to any one or more of: translation, rotation, displacement, falling, floating, spinning etc. and combinations thereof. Optionally, in some embodiments, the moveable entities may undergo any form of random or non-coordinated or non-common movement that is not necessarily observable or detectable as part of the observable or detectable image, or that is selectively removed from the observable or detectable image.

Moreover, the moveable entities may move to any degree within the compartments, but in some embodiments may be caused to move at least 10%, or at least 20%, or at least 50%, or at least 80%, or 100%, of the largest internal dimension of the compartment within which they are contained, when under the external influence or reacting thereto. The moveable entities may move at any speed within the compartments when under the external influence. In selected embodiments, however, most if not all of the moveable entitles may complete their movement within the compartments in response to the external influence within 0.01 to 500 seconds, or 0.1 to 60 seconds, or 1 to 20 seconds, after application or removal of the external influence, to or upon the device.

In terms of the external influence that, in selected embodiments, may cause movement of the moveable entities, the external influence may take any form including but not limited to: a magnetic field or a change in a magnetic field, an electric field or a change in an electric field, gravity, a force other than gravity, acceleration or a change in acceleration, centrifugal force or a change in centrifugal force, temperature change, temperature gradient, pressure or change in pressure. For example, in some embodiments the external influence or force comprises gravity, and the entities are caused to fall or to float within the compartments under the influence of gravity, thereby to generate said common, synchronized movement. However, in other embodiments the external influence may comprise one or more selected from:
shaking the device;
tipping the device;
flipping the device;
applying pressure to the device;
removing pressure from the device;
applying a discontinuous or continuous force to the device;
rotating the device;
re-orienting the device with respect to gravity;
   or any related change or any other external influence suitable to cause movement of the moveable entities present within compartments of the device.

Moreover, for greater certainly, the movement of the moveable entities in response to the external influence or force upon the device or removal thereof, especially the nature of the at least partial common, synchronized movement of the moveable entitles, may take any form including but not limited to: translocation, rotation, diffusion, falling under the influence of gravity, and floating in a gaseous or liquid medium.

In selected embodiments, the devices comprise compartments in which each compartment comprises or contains, other than the one or more entities, one or more fluid media. In some such embodiments, the fluid media within each compartment may be flowable about the compartment in response to the external stimulus, and commonality of fluid flow within different compartments in the array of compartments provides the aforementioned common, synchronized movement, wherein the fluid itself within each compartment constitutes the at least one moveable entity.

However, in alternative embodiments the fluid media completely or substantially fills each compartment other than the moveable entities, such that the moveable entities are optionally contained in or immersed in the fluid media. In the latter of these embodiments, at least partial common or synchronized movement of the contents of the compartments may be achieved, for example, by movement of the moveable entities contained in the fluid media, with corresponding fluid displacement of the fluid media, rather than by movement of the fluid media itself within the compartments.

When referring to “fluid media”, any type of fluid media may be utilized in the context of selected embodiments described herein. In some embodiments the fluid media may comprise one or more liquid and/or gaseous media.

Certain, selected embodiments of the devices disclose herein are moiré magnification devices. For example, such devices may comprise, as the image generator, an array of microlenses of any type, size or form, including convex, refraction, diffraction, standard and Fresnel microlenses. The microlenses may take any size, but smaller sizes may be preferred for higher-resolution devices. Indeed, microlenses may be utilized with a diameter or average diameter of less than 1,000 microns, less than 100 microns, less than 50 microns, or less than 10 microns. These dimensions also apply to micromirrors, and arrays of micromirrors, for embodiments that include them, as part of or forming the image generator.

Further, such devices may comprise, as the array of compartments, a 2-dimensional array of microchambers in association with the array of microlenses or micromirrors. In such embodiments, the microlenses/micromirrors and microchambers may be arranged in such a way that the array of microlenses/micromirrors generate a moiré magnified image of at least a portion of the microchambers and/or their contents, as the observable image. The degree of magnification of the moiré image may be adjusted for each embodiment such that a smaller or larger portion of select microchambers, or indeed an entirety of select microchambers, is observable as part of the composite moiré magnified observable image. The degree of magnification may be chosen depending upon the nature of the microchambers, and/or the moveable entities they contain, and/or the nature of the movement of the entities that is intended to be observed as the observable image.

In further selected embodiments involving moiré magnified image generation, each of the microchambers may contain: (i) a liquid, such that the liquid is sealed into each microchamber; and (ii) at least one entity or moveable entity immersed in the liquid within each microchamber. In this way, each entity is insoluble or immiscible in the liquid of a microchamber, and yet each entity is freely movable by rotation and/or translocation within the liquid when the device is subjected to an external influence or force. However, in selected embodiments the array of microchambers comprises an area of adjacent microchambers each filled with the same or substantially the same compositions compared to other microchambers in said area. Accordingly, when the device is subjected to the external force the compositions within the adjacent microchambers within said area may “react” at least partially in a uniform or substantially uniform manner in terms of the movement of the entities that they contain, such that the collective movement of the entities within the microchambers of the area forms at least a part of the moiré magnified image.

In corresponding, selected embodiments involving moiré magnification, each entity is freely movable within and through the liquid within which it is immersed, by dynamic displacement of the liquid when the device is subjected to an external influence that is an external force. For example, the array of microchambers may comprise an area of adjacent microchambers each filled with the same or substantially the same compositions compared to other microchambers in the area, so that when the device is subjected to the external influence or force the compositions within the adjacent microchambers within said area “react” at least partially in a uniform or substantially uniform manner in terms of movement of the entities they contain and/or the dynamic displacement of the liquid caused by movement of the entities they contain. In this way, the collective movement and/or the dynamic displacement may form at least a part of the moiré magnified image.

In further corresponding embodiments, each entity, or at least a portion of each entity, has a density that is different to the density of the liquid within which it is immersed. In other embodiments, the density of the entirety of the entities may differ from that of the liquid within which it is immersed, as would be the case, for example, with entities comprising metal particles immersed in a liquid or medium that contains an aqueous solution, a hydrocarbon solution, a fluorinated or halogenated liquid or solution, or a silicon oil solution. In still further embodiments, the entities may each have non-uniform densities with at least portions of each entity having a density that is different to the density of the liquid within which it is immersed, as may be the case, for example, with Janus spheres immersed in an aqueous or other liquid.

In embodiments in which the microchambers contain one or more liquids, the nature or composition of the liquids may take any form. In some embodiments, water, aqueous liquids and solutions, or organic liquids or oil-based liquids may be used. Moreover, the liquids may include any additives to change or tune for example the colour, reactivity, viscosity, or other properties of the liquid as required for a particular application.

The density of the liquid may also be chosen relative to the density of the moveable entities. For example, in some embodiments at least some of the entities may each have an overall average density that is greater than the density of the liquid within which they are immersed, such that they have a tendency to sink and/or to sediment within the microchambers under the force of gravity. For example, in such embodiments the at least one entity in each microchamber may comprise one or more of: particles, flakes, beads, Janus particles, and immiscible liquid particles, wherein the overall density 10) of each entity is greater than the liquid within which they are contained or immersed within each microchamber. For example, such entities may include metals, metallic particles or flakes.

The speed of sedimentation under gravity of such entities may be tailored according to the embodiment and the desired optical effect. Further the speed of sedimentation may depend for example upon the size, shape, surface properties, charge, mass, density and relative density (relative to the liquid) of the entities, as well as the properties, density and viscosity of the liquid within which they are contained. For example, in some embodiments at least 90% of the entities that optionally each have an overall average density that is greater than that of the liquid within which they are immersed, sediment within the microchambers within 0.01-500, 1-60 or 0.2-20 seconds following stationary placement of the device. However, other embodiments and applications may require alternative, tailored, slower, faster, or wider ranging sedimentation rates for the entities, and any such rates may be accommodated.

In still further embodiments, at least some of the entities forming part of the compositions may each have an overall average density that is less than the density of the liquid within which they are immersed, such that they have a tendency to float within the microchambers under the force of gravity, absent an external force upon the device other than gravity. For example, in such embodiments the at least one entity in each microchamber may comprise one or more selected from the following non-limiting group: particles, flakes, beads, Janus particles, immiscible liquid particles, gas-containing particles, bubbles, foam particles, and foam beads, wherein the overall density of each entity is less than the liquid within which they are contained or immersed within each microchamber.

As for embodiments related to the speed of sedimentation, the speed of floatation may also be tailored according to the desired embodiment and optical effect. For example, in some embodiments at least 90% of the entities that each have an overall average density that is less than that of the liquid within which they are immersed may be designed to float within the microchambers within 0.01-500, or 1 to 60, or 0.2-20 seconds following stationary placement of the device. However, other embodiments and applications may require alternative, tailored, slower, faster, or wider ranging floatation rates for the entities, and any such rates may be accommodated.

Still further embodiments may employ compartments that contain moveable entities of more than one type, for example include those than can tend to float and those tend to sink in the same liquid media within which they are contained. Such entities may or may not interact with one another, depending upon their structure and properties. For example, microbubbles may interact selectively with microparticles as required according to the embodiment. Selected examples as herein described illustrate such embodiments.

Still further embodiments employ moveable entities of more than one size, or more than one density, or more than one charge, or more than one degree of hydrophobicity, or more than one degree of any other physical or chemical characteristic, in different compartments or within the same compartment. Such different or different types of moveable entities may interact directly or indirectly with one another in any way, or may not interact with one another other than by alternative types or degrees of motion within the compartments. In any event, commonality of movement between the compartments may nonetheless be observable via the image generator.

The compartments or microchambers, in accordance with any embodiment described here, may comprise any structure, wall materials or wall configurations. For example, in some embodiments the compartments or microchambers may comprise one or more of the following non-limiting features or configurations:
cuboid microchambers;
hexagonal prism microchambers
spherical or elliptical microchambers;
asymmetrical microchambers;
microchambers comprising at least some curved walls;
microchambers with an hour-glass configuration;
microchambers with sloped walls;
microchambers with walls comprising surface content or relief; and
microchambers comprising features forming specific artworks or that are shaped in the form of a specific artwork. For example, the microchambers shaped in the form of or containing walls in the form of a dollar sign, a Maple leaf, a snow flake or any other artwork that may provide appealing effect to the end user, as discussed herein.

The shape and configuration of the compartments or microchambers and their component walls, may assist in the generation of a desired optical effect, for example by re-directing, slowing, speeding up, or changing the motion of the entities within the compartments or microchambers. For example, if a device is re-oriented with respect to gravity, such that moveable entities within compartments or microchambers are caused to move by sinking or sedimentation under gravity according to a new orientation of the device, the slope, shape and configuration of the walls may cause some entities to sediment quickly and others to sediment more slowly even if the entities and their direct liquid environment are indistinguishable from one another. This in turn may provide an interesting or desired optical effect, when the common or synchronized movement of the entities is viewed as the observable or detectable image.

In some embodiments, at least some of the microchambers are structured to guide or to position selected moveable entities, for example upon application of the external influence, or upon removal of the external influence, for example to position the moveable entities into or out of the focal plane of the microlenses, or to transition the moveable particles through the focal place of the microlenses. In some such embodiments, the moveable entities may have a structure or constitution such that they tend to dissipate or diffuse within the compartments when not guided or positioned within the compartments by the presence or absence of the external influence (and the structure of the compartments). For example, in some embodiments an image or virtual image of the moveable entities may be caused to appear, disappear or re-appear via the image generator over time according to the distribution of the entities within the compartments. For example, the entities may be caused to be temporarily fixed in position within the compartments in a consistent manner by gravity, or the presence of a magnetic or electric field, and yet the entities may dissipate or diffuse away from those fixed positions when the external influence is reduced or removed from the device. For example, in the case of magnetic solid particle moveable entities, the moveable entities may be caused to adopt a specific distribution within microchambers in a presence of a nearby magnet or magnetic field, with the adopted distribution intersecting the focal plane of the microlenses, whereas removal of the magnetic field may cause the magnetic particles to diffuse in a random or relatively random manner within the compartments, or to sediment or float under gravity, such that their previous, collectively observable positions within the microchambers can no longer be observed in the image or virtual image created by the microlenses, and the image or virtual image to the observer thereby seems to dissipate or disappear over time.

In still further embodiments, at least some of the microchambers may comprise walls with surface content or surface relief, wherein the surface content or relief is visible as part of a moiré magnified image, at least when the device is appropriately oriented with respect to gravity, such that the entities move within the microchambers to arrange themselves with respect to the surface content or relief. For example, in further embodiments at least some of the entities may have an overall average density that is greater than the liquid medium within which they are immersed, such that those entities sink within the microchambers thereby to fill or to surround the surface content or relief positioned at a ‘bottom’ of the microchambers when appropriately oriented with respect to gravity. In still further embodiments at least some of the entities may have an overall average density that is less dense than the liquid medium within which they are immersed, such that those entities float within the microchambers thereby to fill or surround the surface content or relief positioned at a ‘top’ of the microchambers when appropriately oriented with respect to gravity. Selected devices may indeed include compartments or microchambers with surface content or relief on opposing walls, such that appropriate orientation of the device with respect to gravity causes some entities to sediment, while others float, with both sedimenting and floating entities arranging themselves on or about surface content or relief both at the “bottom” and “top” of the compartments or microchambers, respectively. Further, regardless of whether devices include entities that tend to float or sink, having content or relief on opposing walls may permit, at least in some embodiments, alternative content to be revealed or exposed as the device is flipped over one way, and then back again.

For greater certainty, the compartments or microchambers described herein, when they contain a liquid, may comprise one or more liquids of any form, including but not limited to: aqueous liquids, water, organic liquids, oils, that optionally may contain solutes, salts, buffers, dyes, surfactants, charge dissipation agents, viscosity enhancing agents, and viscosity reducing agents.

For the moiré magnification devices disclosed herein, special effects can be achieved in some embodiments by optionally adapting or designing the relative pitches and/or angles of the microlenses relative to the microchambers within at least some portions of the device. In this way, a moiré magnified image may be rotated such that the apparent movement of the entities and/or the dynamic displacement of the liquid within the microchambers can be observed to progress in a direction non-parallel to the actual movement of the entities, for example non-parallel to the direction of gravity, or opposite to gravity, such that the movement and/or the dynamic displacement appears to defy gravity. Alternatively, in some embodiments comprising multiple areas of the device, each with alternative pitches and/or angles of the microlenses relative to the microchambers, a composite moiré magnified image may be generated in which the movement of the entities and/or the dynamic displacement of the fluid within the microchambers appears to progress in multiple different directions, at least some of which are non-parallel to gravity and non-parallel to a plane of the microlens array. In such embodiments, the observed movement of the entities and/or the dynamic displacement of the liquid within which they are contained, may appear to defy gravity in multiple different directions. Device design, in terms of relative pitch, rotation or angles for the microlenses relative to the microchambers for different areas of the device, may thus provide interesting and diverse optical effects such as the appearance of movement away from or towards a central position, or in multiple different directions, which in some embodiments may generate or simulate a moving image.

In further embodiments, selected devices may enhance, magnify or emphasize random motion of entities rather than common, co-ordinated or synchronized motion. In such alternative embodiments, the optical effects may be striking or subtle, including for example the appearance of random on-off colour changes, shimmering or flashing effects for individual or multiple components of the devices, such as magnification means, lenses or microlenses. For example, selected embodiments provide a security device comprising: one or more compartments, optionally an array of compartments, each containing one or more entities that have the capacity for independent movement within the compartments, when the device is subjected to an external influence or force. For example, the resulting movement of the entities may comprise or correspond to randomized or Brownian motion of the entities within at least a portion of the compartments, as they are caused to move and optionally knock against one another and/or particles in the fluid within which they are contained. Such devices may optionally further comprise a form of magnifier to magnify the randomized or Brownian motion of the entities as they move within each compartment, or a plurality of compartments, into an observable optical effect or image.

In such embodiments, the entities may comprise any form of entity capable of undergoing random or Brownian motion. Such entities may, for example, be selected from one or more of: liquids, gases, solids, particles, flakes, beads, Janus particles, liquid-containing particles, gas-containing particles, bubbles, foam particles, and foam beads. As for previously described embodiments, the devices may comprise compartments to prevent loss or leakage of the one or more entities, and to separate the contents of the compartments from one another. Brownian or random motion of entities may occur in some examples without need for an external influence, but in other examples may be enhanced, reduced, or triggered by an external influence. Examples of the types of external influence or force that might affect a capacity of the entities to undergo random motion include, but are not limited to, one or more selected from:
shaking the device;
tipping the device;
flipping the device;
applying more or less pressure to the device;
applying a brief, discontinuous or continuous force to the device;
rotating the device; and
re-orienting the device with respect to gravity.

In certain embodiments involving randomized motion of entities, the one or more entities are particulate, and other than the one or more entities, each compartment may be filled with one or more liquid, each compartment otherwise containing the one or more entities immersed therein. In this way, when the particles are caused to move randomly in the liquid, no fluid flow or limited fluid flow of the liquid within the compartments is expected to occur other than liquid displacement as the particles move through the liquid, especially if the compartments are of generally fixed and inflexible size, shape and conformation (and optionally convective flow if temperature gradients exist).

In embodiments involving randomized motion of entities, the magnifier may take any form. However, in some embodiments the magnifier may comprise an array of microlenses as defined herein, each capable of individual magnification. Further, the array of compartments may comprise an array of microchambers in association with the array of microlenses, wherein the microlenses and microchambers are arranged such that each microlens magnifies a small portion of an associated microchamber corresponding to the microlen's focal point, to provide an image of that small portion of the microchamber to an observer. Accordingly, the focal length of the microlenses may be adapted or chosen to magnify any part of an associated microchamber, including but not limited to a far wall of a microchamber relative to the microlens, a near wall of the microchamber relative to the microlens, or any point in the microchamber therebetween. Similarly, the magnifier may comprise an array of micromirrors as defined herein, each capable of individual magnification.

Furthermore, in selected embodiments involving randomized motion of entities, each microchamber may optionally be filled with a composition comprising: (i) a liquid, such that the liquid is sealed into each microchamber; and (ii) a plurality of particulate entities immersed in the liquid within each microchamber. Generally, such entities may be insoluble or immiscible in the liquid, and thus independent to the liquid without a tendency to dissolve or dissipate into the liquid. Further, the entities may be freely movable within the liquid by rotation and/or translocation, including by random or Brownian motion, either spontaneously or when the device is subjected to an external influence or force. For example, the entities may comprise particles or flakes, such that the random or Brownian motion of the particles or flakes causes each microlens to appear to flash “on” or “off” (or switch between colours, or between lighter and darker shades), depending upon the relative position and/or orientation of one or more of said particles or flakes as they intersect or pass across the focal point of each microlens within an associated microchamber, as they move randomly or by Brownian motion within each microchamber, at any given time. In this way, each microlens an array of microlenses may be seen to flash or colour switch rapidly (e.g. from 0.01 ms to 1000 ms), providing a flashing or shimmering effect to the array.

In embodiments involving randomized motion of entities, optionally each entity may be freely movable within and through the liquid within which it is immersed (within each compartment) by dynamic displacement of the liquid, when the device is subjected to the external influence or force.

In embodiments involving randomized motion of entities, optionally the microlenses are convex microlenses, optionally with an average diameter of less than 100 μm.

In embodiments involving randomized motion of entities, optionally the device includes an array of micromirrors instead of microlenses, wherein the micromirrors are concave micromirrors, optionally with an average diameter of less than 10,000 μm.

In some embodiments involving randomized motion of entities, optionally, the at least one entity in each microchamber comprises metal, metallic particles or flakes. Reflective particles, optionally include reflective flat sides, may also be employed in certain embodiments to give rise to enhanced reflective effects especially as such particles rotate and reflect light at different angles relative to an observer.

In some embodiments involving randomized motion of entities, liquids within microchambers may take any form and, for example, may comprise one or more of: aqueous liquids, water, organic liquids, oils, solutes, salts, buffers, dyes, viscosity enhancing agents, or viscosity reducing agents.

Further embodiments encompass any device as disclosed herein as a security or authentication device.

Further embodiments encompass the use of any device as disclosed herein, to provide security or authentication to a document or device.

Further embodiments encompass any document or item comprising, as a security or authentication feature or features, any one or more device as disclosed herein or any combination thereof. Such documents or items may have the one or more device adhered thereupon, or integrated therein, by any means. Accordingly, the array of compartments and the entities they contain may be adhered to or integral with an image generator as described, such that the resulting device adheres or integrates to a document substrate. In other embodiments, the document substrate may be located between the compartments and the image generator. For example, a clear or transparent or translucent substrate may be used for a particular document, and the compartments adhered to one side thereof, with the image generator (e.g. a microlens or micromirror array) adhered to the other side thereof, such that the compartments and the image generator are nonetheless in optical association with one another through the substrate material to form the device and provide a desired optical effect for the devices as described herein. Such embodiments may be particularly useful to provided added security to the document, as the resulting devices essentially comprising components separated by the document substrate that cannot be readily removed from the substrate and reconstructed on a new substrate material. Further, removing one or other of the compartment array or microlens/micromirror array from one side of the substrate will not result in the separation of the security device from the substrate. This in turn may help prevent a would-be counterfeiter from removing the device from the substrate, and reconstructing or transferring the device elsewhere.

Further, any documents or items may comprise any form of material to which the security device(s) is/are adhered or integrated, including for example any of the following non-limiting group: papers, plastics, metals, alloys, resins, polymers, natural products, fabrics, woods, paints, coatings, lacquers, glass, stone etc.

Various embodiments, data and experimental results are illustrated and described with reference to the following examples, which are non-limiting with respect to any embodiment disclosed herein and/or encompassed by the appended claims.

### Examples

### Example 1—Combining Micro-Optics and Micro-Fluidic Features into a Single Device

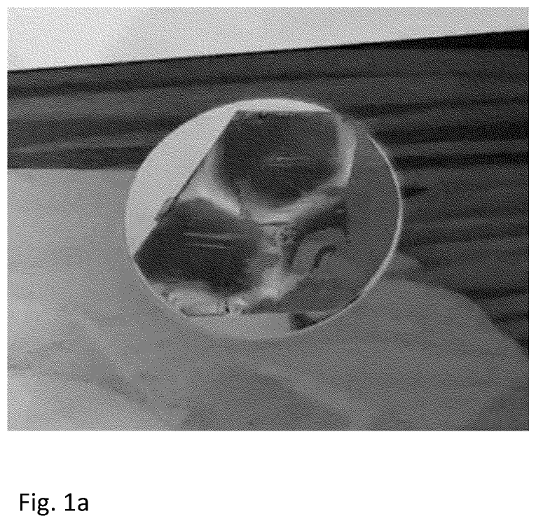

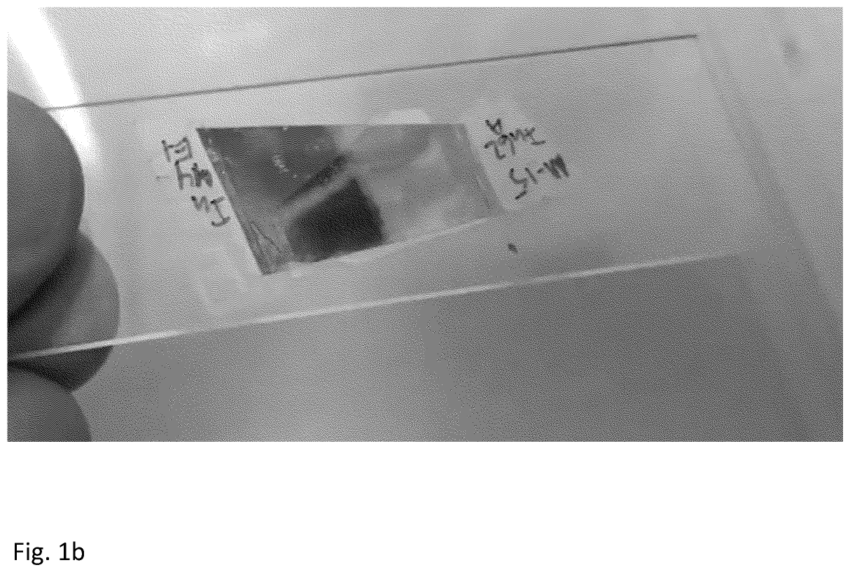

Devices that combine both micro-optics and micro-fluidic features into a single device may, at least in some embodiments, have striking optical appearances. An example of such a device is shown in FIG. 1.

FIG. 1a provides a photograph showing two items with security devices, each of which combine a liquid-containing microfluidic structure overlaid with a hexagonal array of microlenses: a sample prototype bank note shown in the upper portion of FIG. 1a, and a microscope slide shown in the lower portion of FIG. 1a. FIG. 1b shows a photograph with a closer view of the circular security device on the sample prototype bank note, with the large darker patches within the circular device being a Moiré magnified image of the (blue/darker) liquid within liquid-filled hexagonal microchambers located beneath the microlenses. FIG. 1c shows a photograph with a closer view of the device mounted on the microscope slide, again with the large darker patches within the circular device being a Moiré magnified image of the (darker/blue) liquid within liquid-filled hexagonal microchambers located beneath the microlenses. Bright and overt Moiré magnified effects were observed, with a virtual image of the microchambers clearly visible.

### Example 2—Sedimentation and “Virtual Lateral Displacement” Effects

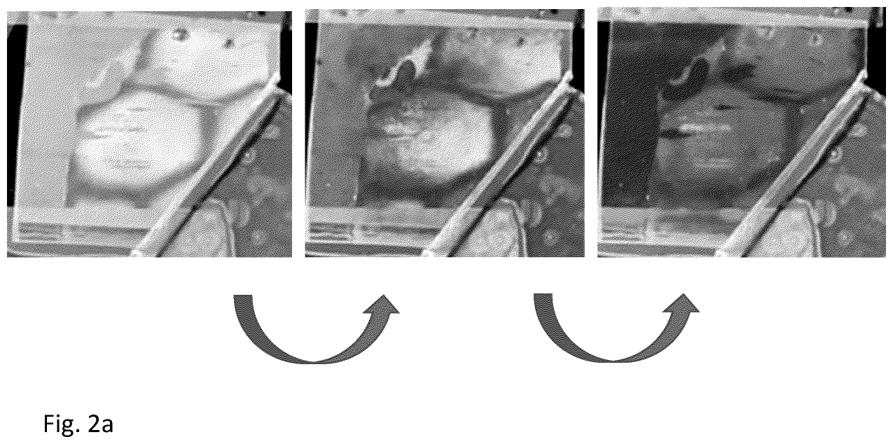

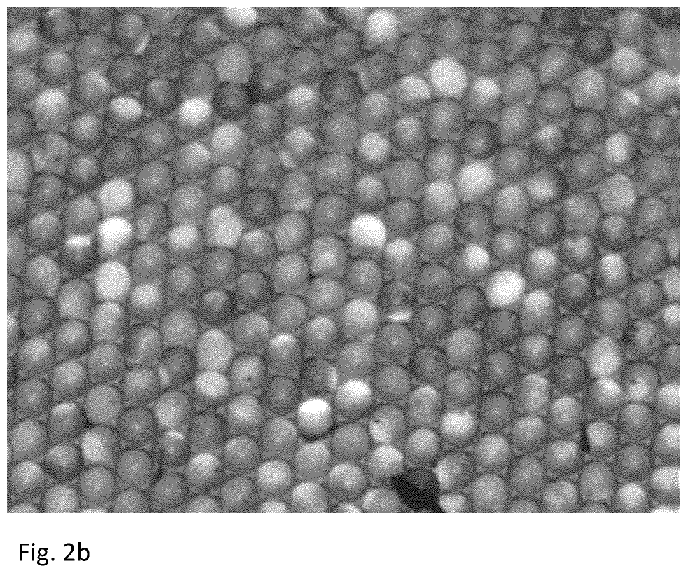

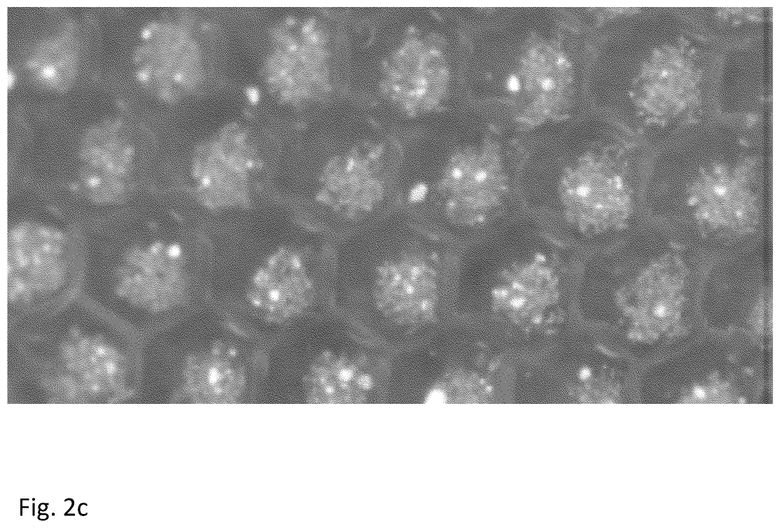

Further investigations studied the optical effects of Moiré magnification of an array of microchambers each filled, or at least substantially filled, with a liquid containing particulate flakes, wherein the flakes comprised a material that is more dense than the liquid, such that they had a tendency to sediment within the liquid by falling under the influence of gravity within each microchamber. As shown in FIG. 2a, the presence of microlenses enabled observation of a Moiré magnified image of the microchambers, with the flakes (collectively a paler shade) contrasting with the blue/darker shade of the liquid within which they were contained within the microchambers. Each of the photos of FIG. 2a shows a progression of time after the device had been flipped over from right to left (rather akin to flipping the page of book), and then placed motionless upon a horizontal surface.

The left photo of FIG. 2 shows the Moiré magnified appearance of the microchambers immediately after flipping the device over, with the flakes briefly present with a fairly even distribution at the uppermost side of the microchambers beneath the microlenses (i.e. magnified microchambers appear pale in colour due to the presence of the particles at the focal plane of the microlenses). After a few seconds, the flakes begin to fall and to sediment under the force of gravity. The middle photo of FIG. 2a shows the appearance of the same device a few seconds after the left photo of FIG. 2a, with the blue/darker colour of the liquid appearing to progress across the Moiré magnified microchambers from left to right. After several more seconds the Moiré magnified image of the microchambers appears as per the right panel of FIG. 2a, with only the blue, darker colour of the liquid now visible, the pale-coloured flakes now having fallen to the “bottom” side of the microchambers (with respect to gravity for the orientation of the device), with the darker blue liquid now above the sedimented flakes, and at least partially obscuring their observation in the Moiré magnified image. Strikingly, the Moiré magnified images enabled collective observation of the common motion of the flakes (and the fluid containing them) within the microchambers in the array of microchambers present, as a Moiré magnified image, even though the motion of the individual flakes might not necessarily be visible or readily visible to the naked eye without the Moiré magnification.

FIG. 2b provides a photograph of a 5× magnified image of the individual microlenses from underneath the device prior to flipping it over (such that the microlenses are positioned between the camera and the microchambers). FIG. 2c provides a photograph of a 10× magnified image of the individual microchambers from underneath the device a few seconds after flipping it over (such that the microlenses are no longer positioned between the camera and the microchambers).

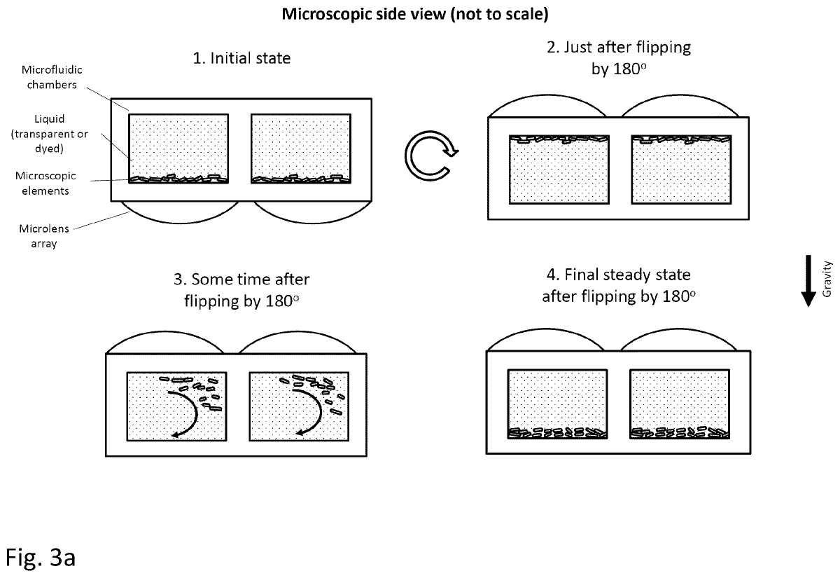

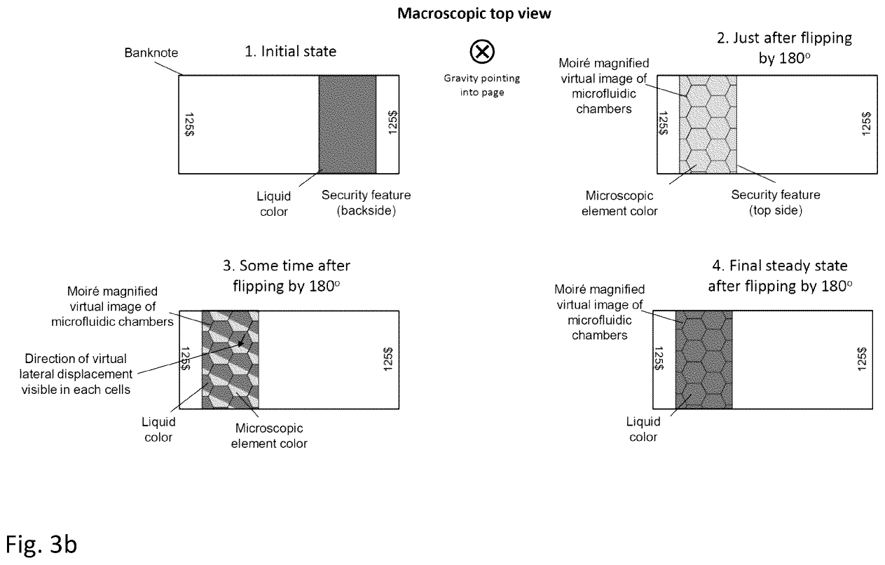

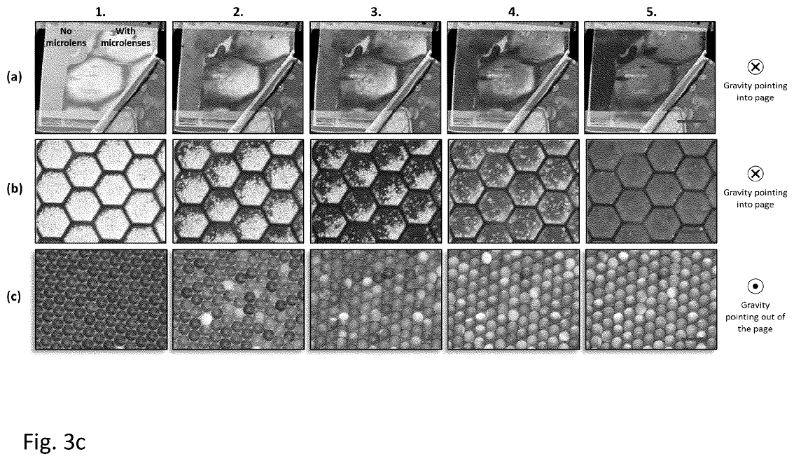

FIG. 3a provides a schematic, side, cross-section view of the device illustrated and described with reference to FIG. 2a, and the three progressive photographs shown in FIG. 2a. In FIG. 3a the direction of the force of gravity is shown, vertically downward with respect to the device illustrated.

FIG. 3a, illustration 1 “Initial state”, shows the device with just two microlenses and two microchambers shown for simplicity, with each microchamber being filled with a liquid other than the presence of microscopic elements or flakes that are freely moveable within the liquid, that have a density that is greater than the liquid. Therefore, in FIG. 3, illustration 1 “Initial state” the flakes are shown at rest, having previously fallen and sedimented within the microchambers to adopt a position at the “bottom” of the microchambers with respect to gravity.

FIG. 3a, illustration 2 “Just after flipping by 180°”, illustrates the flakes now positioned at the “top” of the microchambers with respect to gravity, just prior to them beginning to fall and sediment within the liquid of each microchamber. Accordingly, this corresponds to FIG. 2a, left photograph.

FIG. 3a, illustration 3 “Some time after flipping by 180°”, illustrates the flakes beginning to fall within the microchambers, but due to the direction of the flipping combined with the fluid dynamics of the liquid, the flakes tend to fall down on the right side of the microchambers as illustrated. Accordingly, this tendency leads to the observed progressive colour change effect from left to right in terms of the blue/darker liquid becoming increasingly observable over time, corresponding to FIG. 2a, middle photograph.

FIG. 3a, illustration 4 “Final steady state after flipping by 180°”, illustrates the flakes having settled or sedimented under gravity, having assumed a more even distribution, now at the “bottom” of the microchambers with respect to gravity. This corresponds to FIG. 2a right photograph, in which the pale colour of the flakes is now less visible with the darker/blue colour of the liquid becoming more dominant, in the moiré magnified image.

Therefore, in summary FIG. 3a shows a microscopic cross-section side view of an embodiment of the invention (not to scale). The device includes an array of microscopic (or “microfluidic”) chambers (microchambers), each containing at least one microscopic entity that is dispersed in a fluid (i.e. air or liquid, preferably a liquid) that can be collectively displaced with the application of an external influence or force. The device also includes an “image generator” that is able to magnify the overall collective displacement of the microscopic entities in each chambers. As an example, as shown the image generator can be a microlens array having properties (e.g. array pitch and direction) substantially similar to that of the array of microscopic chambers giving rise to a moiré magnification sufficient to reveal the structure of the microscopic chambers to the naked eye. Typically, from the perspective of the user or observer of the device, the device is viewed on a side with the microlens array, with the microchamber array “beneath” the microlens array. In other words, at least in some embodiments the microchamber array may be viewed through the microlens array to achieve a desirable moiré effect. However, a micromirror array can also be employed as an alternative to a microlens array. In micromirror embodiments that involve a two-dimensional array of concave micromirrors, the micromirror array may optionally be positioned “beneath” the microchamber array, such that an observer views the device with the microchambers uppermost relative to the user. In this way, the micromirror array may be located on a side of the device opposite the user, otherwise typically adjacent to or in optical co-operation with the microchambers, thereby to achieve an alternative moiré effect from the perspective of the observer or user of the device.

As shown in FIG. 3a, when the device is manipulated (for example by being flipped upside-down by 180°) the microscopic entities start to sediment by falling under the gravity in a locally similar way in multiple chambers of the array. It was observed that, depending on the rotation axis used for the flipping action and speed of flipping action, the microscopic entities would typically experience a significant lateral displacement in one direction perpendicular to gravitation. As the direction of this lateral displacement depends on the overall rotation axis of the entire device, it is typically similar in all microscopic chambers, giving rise to a collective and substantially synchronized lateral motion of the microscopic entities. After some time, the microscopic entities sediment back to the bottom of the microscopic chambers reaching substantial mechanical equilibrium. Observation of the entities as they fall into or out of the focal plane of the microlenses, or as they fall through the focal plane of the microlenses, determines the appearance (both current and dynamic) appearance of the resulting moiré magnified image.

FIG. 3b generally provides another schematic illustration of the same embodiment illustrated and described with reference to FIGS. 2 and 3a. In FIG. 3b the security device is shown as a larger panel of a security document such as a bank note, with the bank note shown in plan view from above, with the bank note shown as if placed horizontally at rest upon a table top. The device again includes an array of microlenses (this time not individually visible) and an array of microchambers (this time not individually visible), wherein the contents of the microchambers are viewable from both the “front side” of the bank note, and also from the “back side” of the bank note, with the array of microlenses providing a moiré magnified image of the microchamber array at least when the device is viewed from the “front side” of the bank note.

Accordingly, FIG. 3b illustration 1 “Initial state”, shows the device in the same orientation as FIG. 3a illustration 1 but as shown from above on the back side of the bank note. At rest, in this orientation and from this viewpoint, the darker/blue colour of the liquid In the microchambers is prevalent; the flakes having fallen or sedimented as illustrated in FIG. 3a illustration 1 to the “bottom” of the microchambers, with no microlenses present on the back side of the bank note to provide a moiré magnified image.

FIG. 3b, illustration 2 “Just after flipping by 180°”, illustrates a top plan view of the bank note now with the front side visible; the flakes are now briefly positioned at the “top” of the microchambers with respect to gravity, and are visible as a paler colour than the liquid as they exist momentarily in the focal plane of the microlens array, before the flakes begin to fall and sediment within the liquid of the microchambers. Accordingly, this corresponds to FIG. 2a, left photograph, and to FIG. 3a illustration 2. However, the microchambers from the front side of the bank note are now observable as a moiré magnified image due to the presence of the array of microlenses between the observer and the microchambers, and this is illustrated schematically by the hexagonal appearance, as a magnified virtual image of the hexagonal microchambers of the device.

FIG. 3b, illustration 3 “Some time after flipping by 180°”, illustrates the flakes now beginning to fall within the microchambers, in accordance with both FIG. 2a middle photograph and FIG. 3a illustration 3. Due to the direction of the flipping combined with the fluid dynamics of the liquid, the flakes tend to fall down on the right side of the microchambers as illustrated in FIG. 3a illustration 3. In this instance, however, the pitch and offset of the microlenses to the microchambers causes a rotational effect such that the progressive colour change of the moiré magnified image appears to show the progressive lateral displacement of the flakes in a direction that is different from the direction in which the device was flipped over, as the flakes in different regions of the microchambers fall through or into the focal plane of the microlens array.

FIG. 3b, illustration 4 “Final steady state after flipping by 180°”, illustrates the device again shown in top plan view, with the flakes having settled or sedimented under gravity, having assumed a more even distribution now at the at the “bottom” of the microchambers with respect to gravity. This corresponds to FIG. 2a right photograph, as well as FIG. 3a illustration 4, with the pale colour of the flakes now less visible and with the darker/blue colour of the liquid becoming dominant in the moiré magnified image, again schematically illustrated with the hexagonal appearance of moiré magnified hexagonal microchambers of the device.

FIG. 3b shows the corresponding macroscopic visual effects that can may generated by the embodiment shown in FIG. 3a. When observed from above the device (i.e. gravity pointing into the page) the user originally sees the backside of the security feature (assuming that it is located on a transparent window). In the state shown in FIG. 3b step 1, the device backside initially has the color of the fluid, as the particles are sedimented to the bottom of the chamber (see FIG. 3b, step 1), away from the observer. As the device is flipped (FIG. 3b, step 2), the image generator allows the observer see a magnified image revealing the structure of the microscopic chambers to the naked eye, for example a hexagonally tessellating “honeycomb-like” array of microchambers. While in this embodiment the microchambers may be only few tens of micrometers in size, the moiré magnification process can be controlled as known in the art to create an image where the microfluidic chambers are easy to see by the naked eye, for example having dimensions of 5 mm or more. The magnified image of the microchambers generally assumes the color of the microscopic entities or flakes, as they are now closer to the observer or fall within the focal plane of the microlens array (as shown in FIG. 3b, step 2). As the microscopic entities start to sediment, the collective and substantially synchronized lateral displacement shown in FIG. 3b, step 3 can be presented to the observer by the image generator (e.g. microlens array) to create a moiré magnified image revealing the collective lateral displacement of the particles (as shown in FIG. 3b, step 3). After some time (FIG. 3b, step 4), the magnified image of the microscopic chambers acquires the darker/blue color of the fluid as the microscopic entities are now sediment back to the bottom of the microscopic chambers, away from the observer or out of the focal plane of the microlens array.

In summary, the device shown in FIG. 3b magnifies and reveals, as a virtual image, collective displacement of microscopic entities or flakes by generating dynamic lateral displacement visual effects visible to the naked eye as a moiré magnified image, that persists after manipulation of the device. Without the image generator, the device may show a gradual color or contrast change, but the lateral displacement dynamic effect may not be visible to the naked eye.

Accordingly FIG. 3c demonstrates the dynamic contrast that may be generated after flipping a device corresponding to that described in FIGS. 3a and 3b for an observer placed above the device. In terms of timing, FIG. 3c provides in the rows of images:
(a) Macroscopic views of the device of FIGS. 3a and 3b. Timing (steps 1 to 5): 0 s; 2.5 s; 3.5 s; 4.5 s; 6.0 s. Scale bar: 5 mm.
(b) Microscopic views of the device of FIGS. 3a and 3b without microlenses present. Timing (steps 1 to 5): 0 s; 2.0 s; 3.0 s; 3.5 s; 6.0 s. Scale bar: 50 μm.
(c) Microscopic “bottom” views of the device of FIGS. 3a and 3b with microlenses present. Timing (steps 1 to 5): 0 s; 1 s; 2 s; 4 s; 6.0 s. Scale bar: 100 μm.

In terms of technical detail, the device in FIG. 3c contained silver-color microscopic particles (average size of about 3 μm with a range of about 1 to 5 μm) dispersed in blue-colored liquid encapsulated in an hexagonal array of ˜54 μm wide and ˜30 μm deep microscopic chambers. The microscopic particles were selected to be denser than the liquid and therefore sedimented in few seconds to the bottom of the microchambers after change in orientation. A microlens array (˜54 μm pitch, ˜75 μm focal length) was placed on top of the microscopic chamber array with relative pitch and orientation similar between the two, giving rise to moiré magnification factor of about 180 (i.e. in the magnified image, each microscopic chamber is about 10 mm wide). The lateral displacement described previously is visible from steps 1 to 5 in about 6 s following the 180° flip of the device (i.e. the blue/darker color gradually appeared from the top left to bottom right in each magnified virtual microchamber image). One region of the device contained only the microchambers without the microlens array. In this region, a gradual color change was observed with time, without the lateral displacement effect being visible. FIG. 3c row (b) shows microscopic top views of a corresponding device in a region that does not contain a microlens array revealing the sedimentation and substantially synchronized collective lateral displacement of the microscopic particles that occurs in all microscopic chambers following the flipping action. FIG. 3c row (c) shows microscopic bottom views of a similar device in a region that contains a microlens array, showing the change in contrast of the microlens array with the sedimentation of the particles.

It is noteworthy that the security devices described according the embodiments presented above will also naturally produce the interesting visual effects that are known in the art for micro-optic security devices when the devices is tilted (or when a change in the angle of observation occurs), including: float or sink effects, orthoparallactic movement, change of form, shape or size of the image as the device is viewed from different viewpoints, etc. Further, the fact that the devices contain microscopic chambers with significant depth can create 3D moiré magnification effects that can reveal the depth of the microchambers in the magnified image. In some embodiments this 3D effect may be particularly visible when the fluid is transparent and when it has high refractive index difference compared with chamber sidewalls. The combination of traditional effects generated through angle of observation with dynamic effects triggered by the manipulation, and continuing after manipulation, may be particularly intriguing to the general public, and increase the efficiency and public acceptance of the device as a level 1 security feature.

### Example 3—Dynamic Sedimentation Effects with Vertical Device Orientation

Additional studies employed the same device or a similar device as to that illustrated and described with respect to Examples 1 and 2, but with analysis of the dynamic effects as the device is flipped over in various orientations, with vertical starting and finishing (rest) positions.

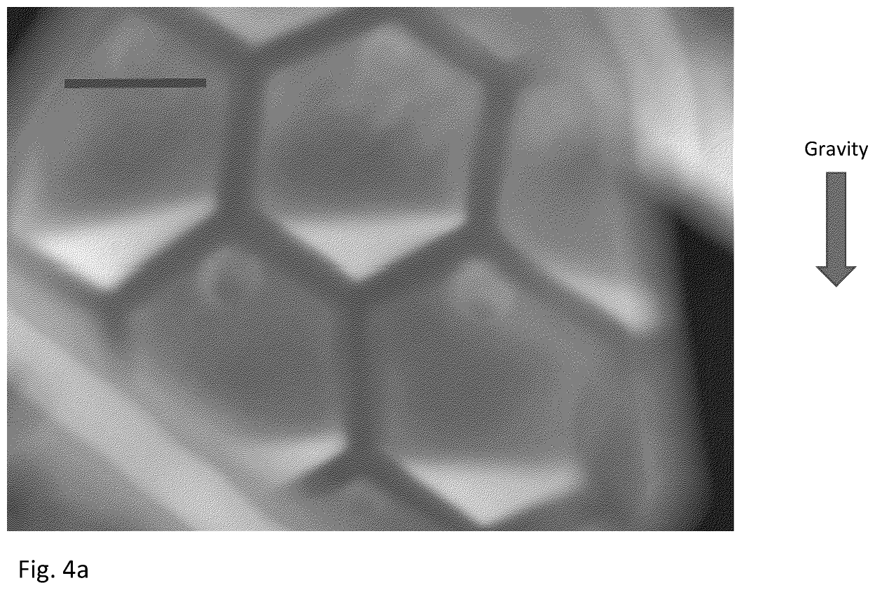

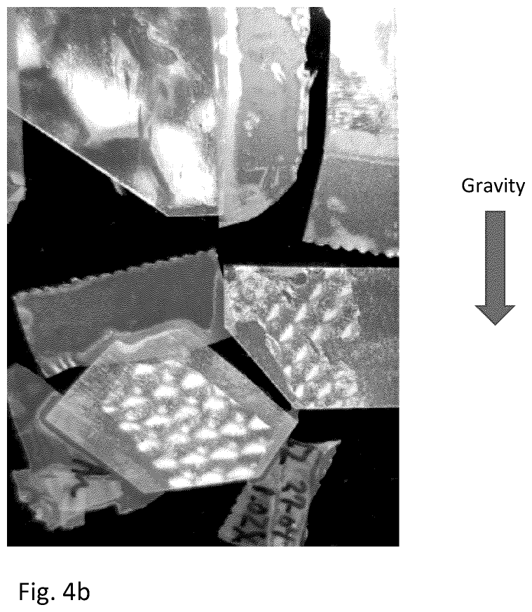

FIG. 4 generally illustrates dynamic effects with such initial vertical orientation. In FIG. 4a, a moiré magnified image is shown of a hexagonal array of hexagonal microchambers as observed through an overlayed hexagonal array of microlenses, with the device oriented vertically in terms of the plane of the device. As for previous examples, the flakes are initially observed collectively as a pale sedimented material now located at the “bottom” of each of the moiré magnified microchamber images with respect to gravity. Meanwhile, the darker/blue colour of the liquid (within which the flakes are immersed) substantially otherwise fills the microchambers above the location of the sedimented flakes. FIG. 4b provides a photograph of several different devices each with corresponding moiré magnified images. However, the devices in FIG. 4b each have different degrees of image rotation for the moiré magnified images in accordance with the different ways in which the microlens arrays are overlayed upon, and offset relative to, the microchamber arrays. In this way, although the flakes within each vertically oriented device have sedimented to the “bottom” of the hexagonal microchambers of each device with respect to gravity, the moiré magnified images provide the impression that the flakes are positioned (and will subsequently move when the device is flipped) in a gravity-defying manner.

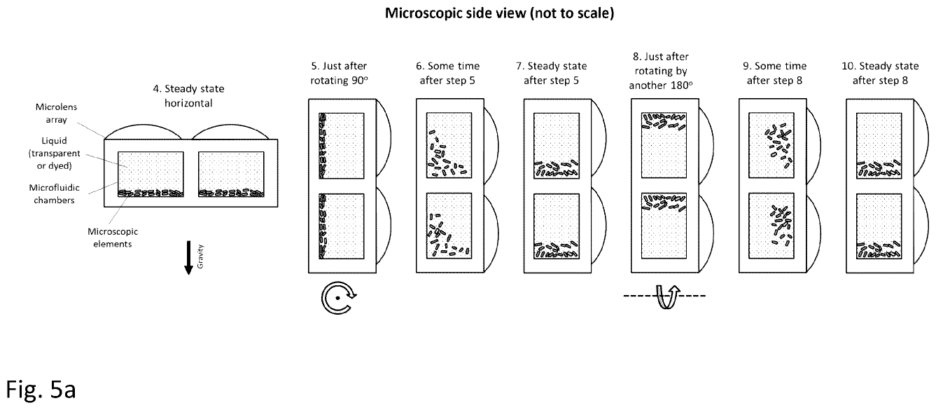

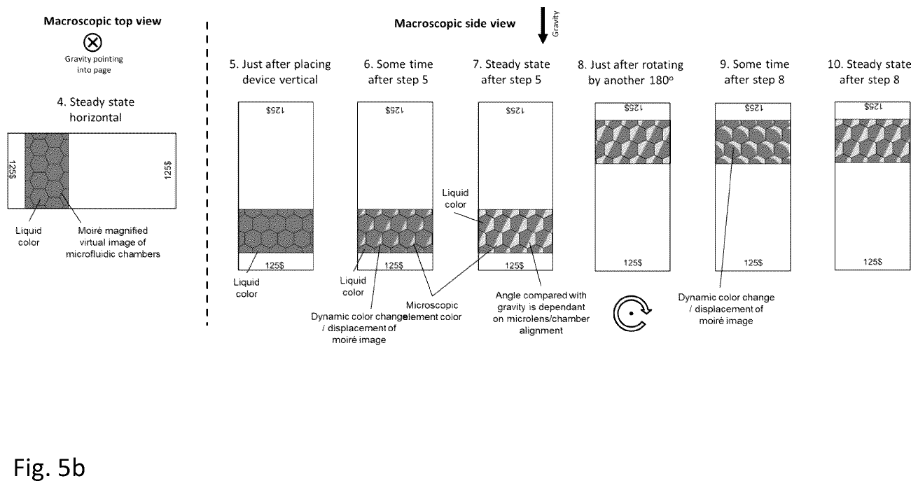

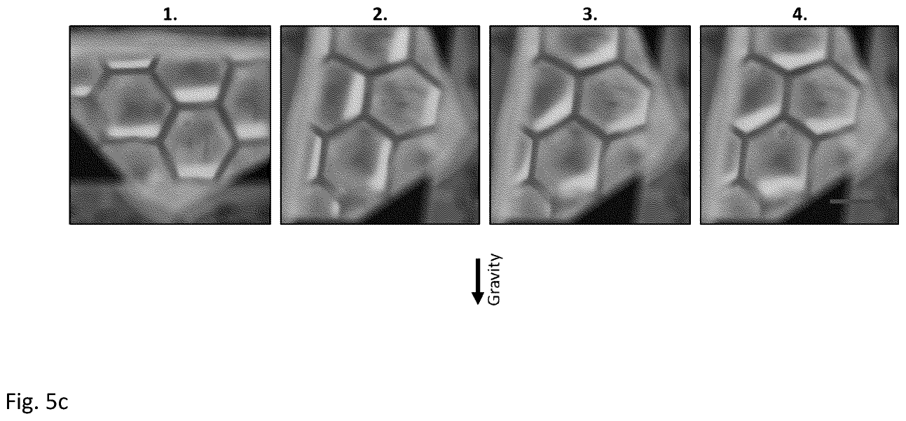

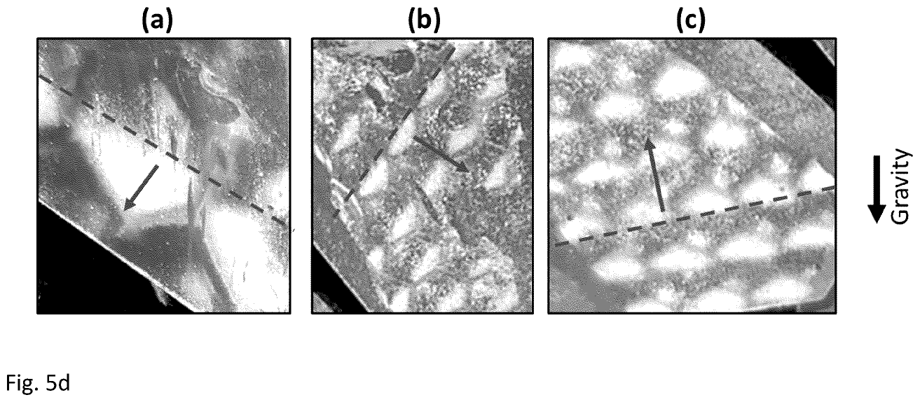

FIG. 5a schematically illustrates, in side cross-sectional view, a device again corresponding to that illustrated for example in FIG. 4. Again, only two microlenses and two microchambers of an array of the same are shown for simplicity. Initially, in FIG. 5a illustration 4 “Steady state horizontal” the device is shown as if placed horizontal and motionless upon a table, with the flakes having already settled or sedimented under gravity to the ‘bottom’ of the microchambers with respect to gravity (opposite the microlenses). The device is then rotated through 90° about a horizontal axis perpendicular with the plane of the paper (as illustrated) such that the device adopts a vertical position with respect to the plane of the arrays of microlenses and microchambers. As shown in FIG. 5a illustration 5 “Just after rotating 90°” the flakes briefly remain in their original position as per FIG. 5a illustration 4. However, as shown in FIG. 5a illustration 6 “Some time after step 5” the flakes begin to fall or sediment in the liquid under gravity, partly by sliding or migrating down the left side of the microchambers as shown, until the flakes again settle at the new “bottom” of the microchambers with respect to gravity, as shown in FIG. 5a illustration 7 “Steady state after step 5”.

In FIG. 5a, the device is then rotated again, this time through 180° about a horizontal axis parallel with the plane of the paper (as illustrated). Initially, after this second rotation, the device adopts a state as shown in FIG. 5a illustration 8 “Just after rotating by another 180°”, with the flakes momentarily located at the new “top” of the microchambers with respect to gravity. Soon after, the flakes begin to fall or sediment, again through the liquid of the microchambers, as shown in FIG. 5a illustration 9 “Some time after step 8”, until they once again sediment and come to rest at the new “bottom” of the microchambers with respect to gravity, as shown in FIG. 5a illustration 10 “Steady state after step 8”.

FIG. 5b schematically illustrates the appearance of a device corresponding to that illustrated in FIG. 5a, as it may appear on a security document such as a bank note. The steps and illustrations in FIG. 5b each correspond to those shown in FIG. 5a, with the same device this time shown as a complete device from the perspective of an observer, visible on both sides of a bank note. In FIG. 5b illustration 4 the device is shown in above plan view, as if the device is placed horizontally and motionless upon a table, with the flakes having settled or sedimented under gravity. As shown, the Moiré magnified image of the hexagonal microchambers, shown schematically as the hexagonal array, is dominated by the darker/blue colour of the liquid rather than the paler colour of the flakes.

The remaining illustrations 5 to 10 in FIG. 5b show the same banknote with the same device but in vertical orientation. Therefore, the illustrations are broad-side elevational views of the vertically orientated banknote. In FIG. 5b illustration 5 “Just after placing the device vertical” the flakes have not yet moved within the microchambers, and so are not yet visible in the moiré magnified image of the microchambers. However, as the flakes begin to fall and migrate downwards under gravity through the liquid within the microchambers, they begin to become visible as part of the moiré magnified image as they sediment (FIG. 5b illustration 6) until they have substantially completed their sedimentation within the microchambers (FIG. 5b illustration 7). As illustrated, the moiré magnified image does not show the sedimented flakes at the lower part of the microchambers due to a rotation of the moiré magnified image caused by selected microlens/microchamber alignment.

The remaining illustrations 8 to 10 of FIG. 5b show the visual effects of the further rotation shown in FIG. 5a illustrations 8 to 10, at least from a side of the banknote from which the Moiré magnified image can be readily observed by virtue of the microlens array. Initially, immediately after this further 180° rotation, the flakes have yet to fall under gravity within the microchambers, and the Moiré magnified image initially appears as FIG. 5b illustration 8 “Just after rotating by another 180°”. Some time later, as the flakes begin to fall under gravity within the microchambers, the device appears as shown in FIG. 5b illustration 9 “Some time after step 8”, until the flakes at least substantially complete their sedimentation under gravity within the microchambers, and the device appears as shown in FIG. 5b illustration 10 “Steady state after step 8”. Strikingly, therefore, the combination of the microchamber array and the microlens array permits observation of the dynamic, collective, common motion of the flakes within the microchambers as a moiré magnified image as the device is rotated or flipped as described. The microlenses collectively permit the common or synchronized motion of the flakes to be combined and observed as a moiré magnified image with dynamic optical effects.

Accordingly, as shown in FIGS. 5a and 5b, selected devices can also be used to generate interesting dynamic effects when placed in the vertical orientation. Starting from the configuration shown in the final step 4 of FIGS. 3a and 3b, the device may be rotated to be placed in the vertical orientation, leading to the gradual sedimentation of the microscopic entities toward the sidewalls of each microscopic chamber (steps 5 to 7 of FIG. 5a). This collective and substantially synchronized displacement is resolved and magnified by the image generator to generate a dynamic color change in the magnified image that is visible to the naked eye, giving the impression of movement in the magnified image. At the end of step 7 of FIG. 5a, the device can also be flipped in another vertical orientation as shown in steps 8 to 10 of FIGS. 5a and 5b, leading to further dynamic effects as the microscopic entities sediment back to mechanical equilibrium. According to the embodiment, the sedimentation direction of the microscopic entities in the magnified image might be different than the actual sedimentation direction of the microscopic entities depending upon the configuration of the image generator. Indeed, as known in the art, depending on the relative scale and orientation of the microlens and microchamber arrays, the magnified image can be rotated, which can lead to the impression that the particles sediment in a different direction compared to the direction of gravity. As an example, depending on the configuration of the image generator, the apparent direction of sedimentation in the magnified image can be aligned with gravitation, opposed to direction of gravitation, perpendicular to the direction of gravitation, or at any other angles. As discussed more herein, different regions of the device can have different directions of sedimentation in the magnified image, with abrupt or smooth transitions between each regions to create visually appealing or visually intriguing dynamic effects.

Working examples in this regard are illustrated for example in FIGS. 5c and 5d. FIG. 5c provides a macroscopic side view of the device. Timing (steps 1 to 4): 0 s; 2 s; 5 s; 10 s. Scale bar: 5 mm. A dynamic macroscopic moiré magnified visual effect was generated with a device corresponding to that described in FIG. 5a, placed in the vertical orientation. As in step 1 of FIG. 5a, the device was in substantial mechanical equilibrium (i.e. image taken after a long rest period). The microscopic entities, which were silver-colored particles selected to be denser than the fluid, were therefore sedimented to the sidewall in at least a majority of the microchambers present. This regular pattern was then formed into a viewable image by the microlens array to create a moiré magnified image clearly showing the hexagonal structure and arrangement of the microchambers, with blue/darker ink and the lighter silver-color of the sedimented particles. In this example, the magnified image was not significantly rotated, leading to a sedimentation direction generally aligned with gravity in the moiré image. As the device was rotated rapidly (per step 2 of FIG. 5a), the magnified image of the microscopic entities was initially seen to follow the device rotation. The magnified image then displayed a dynamic color change following the collective and substantially synchronized sedimentation of the microscopic entities in the microchambers (per step 3 of FIG. 5a). Finally, the magnified image of the microscopic entities became static after few seconds when the particles reached a new equilibrium (per step 4 of FIG. 5a).

In the example shown in FIG. 5c, the configuration of the device provides a visual impression to the user that they are seeing directly particles sedimenting within the device, whereas in fact they are observing a virtual image formed by magnifying thousands of microscopic chambers each experiencing collective and substantially synchronized displacement of microscopic entities.

FIG. 5d provides macroscopic side views of an example device. Here it can be seen that, with rotational displacement of the moiré magnified image, sedimentation over time appears to occur in a direction other than the direction of the force of gravity. In FIG. 5d, arrows show the appearance of the direction of sedimentation in the magnified images. The size of the cells in magnified image is about 10 mm in (a), 2.5 mm in (b) and 3.0 mm in (c). Thus FIG. 5d provides various examples of devices where the microlens and microscopic chamber arrays were assembled to produce significant rotation of the magnified image. In these examples, the devices, which contained lighter silver-colored particles that were denser than the blue-colored liquid, were in substantial mechanical equilibrium (i.e. image taken after a long rest period). The arrows show the apparent direction of sedimentation in the magnified images. Important deviations compared with the direction of gravity are visible. When these devices are rotated, the magnified image of the particles generally sediments back toward the direction shown by each arrow.

Configurations in which the security devices described herein are held vertically may be of particular interest as this leads to the creation of dynamic, potentially rapid visual effects that may be easy to generate and observe by the public, overt, and difficult to counterfeit. It is also interesting to note that the apparent displacement speed of the microscopic entities in the moiré magnified image can be many, potentially at least hundreds of time faster than the actual average displacement speed of the microscopic entities within the microchambers, due to magnification factor. Therefore, this may lead to dynamic visual effects that can appear to be physically “impossible” to an observer considering the expected relatively slow sedimentation speed of microscopic particles and microchambers that are small enough to fit into a security device with a thin or very thin profile or cross-section (e.g. <30 μm).

### Example 4—Virtual Imaging of Bubbles Contained within Microchambers

The Examples thus far have focused upon microchambers containing liquid media with microscopic entities, particles or flakes immersed therein, wherein the entities have an overall density that is greater than the liquid media. As such they have a tendency to fall and sediment within the microchambers under gravity. However, other embodiments may additionally or alternatively employ moveable entities that are less dense than the fluid media, such that they have a tendency to float within the microchambers under the influence of gravity.

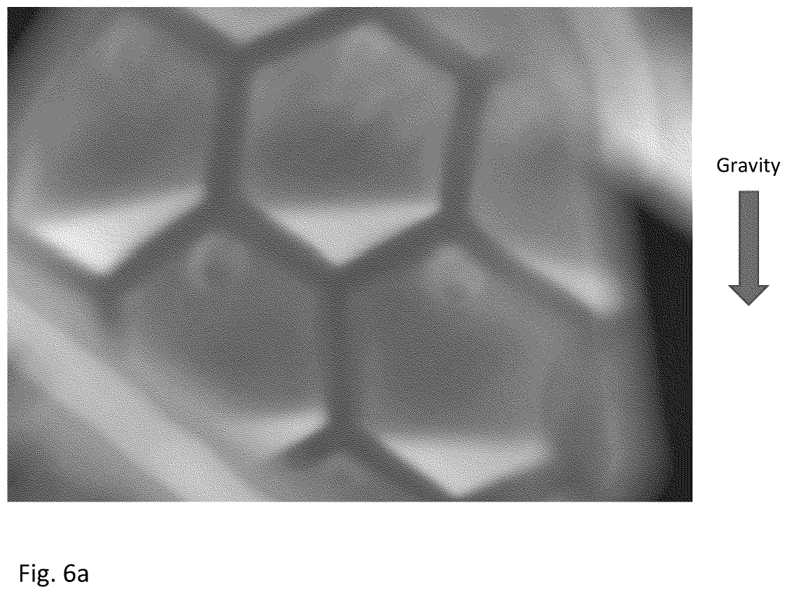

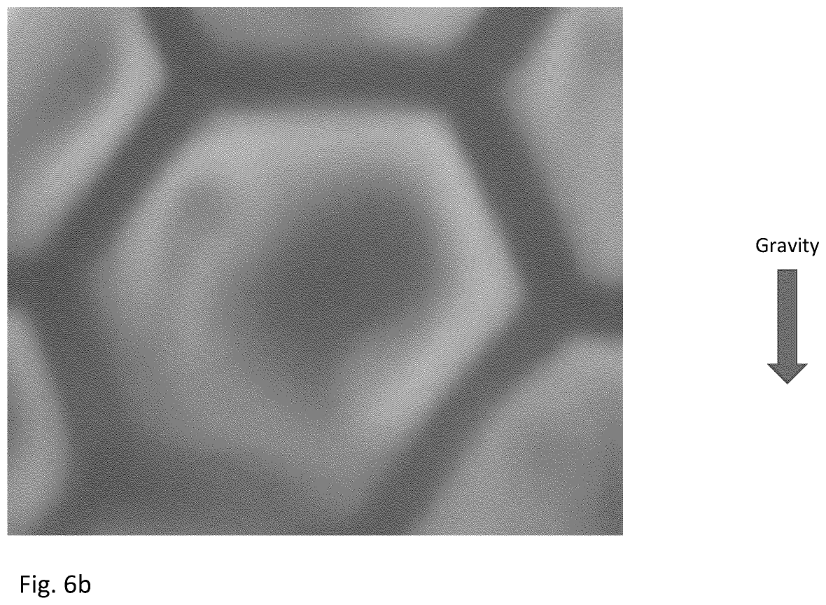

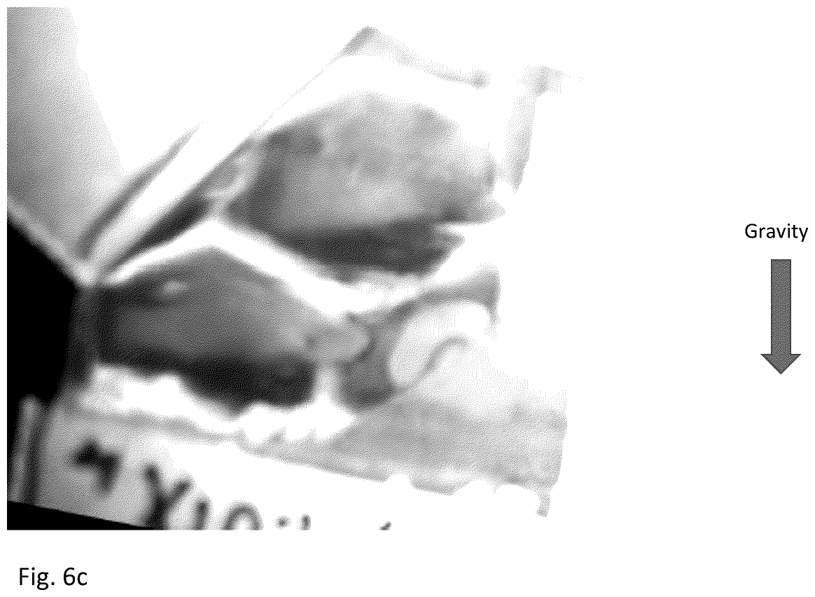

For example, studies have been done on microbubbles when consistently present within microchambers of an array of microchambers. FIGS. 6a, 6b and 6c in general provide photographs showing virtual, moiré magnified images of microbubbles, the bubbles existing as common features within hexagonal microchambers. The motion of the microbubbles can also be observed again as the device is tilted, flipped or moved as the device is reoriented with respect to gravity. In the case of FIG. 6b, the bubble motion also affects the motion of other particles (collectively a lighter colour) moving, swirling or displaced within the microchambers, the common movement of which is also visualized to an observer as a virtual moiré magnified image.

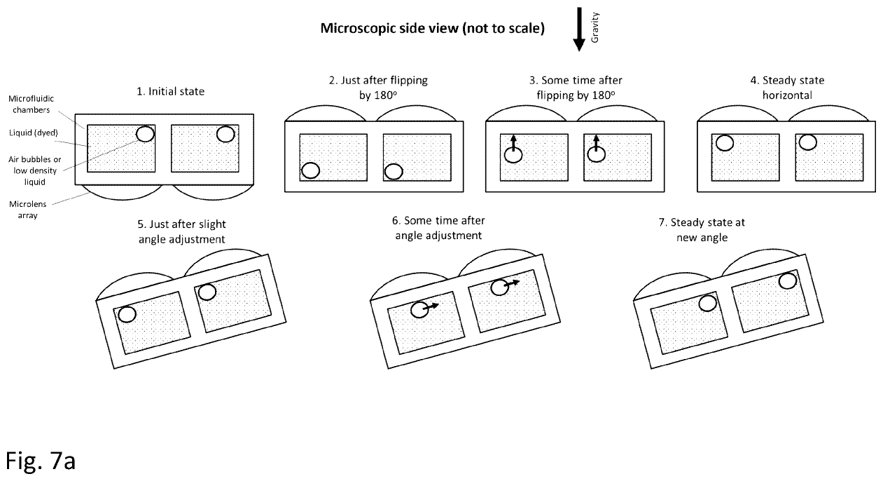

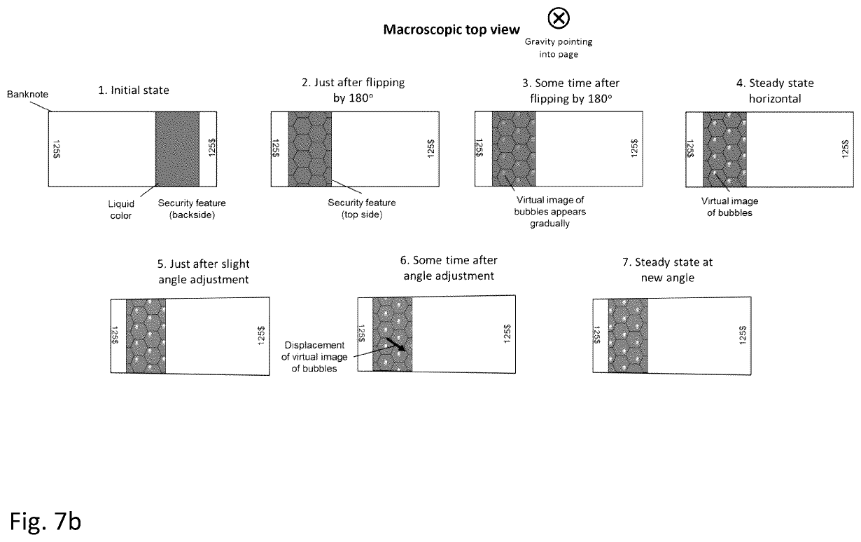

FIG. 7a schematically illustrates a device shown in elevational cross-section, the device comprising an array of microchambers containing fluid, together with an array of microlenses. For simplicity, only two microchambers and two microlenses are illustrated. Each microchamber is filled with a liquid other than the presence of a single air bubble (microbubble) within each microchamber that is less dense that the liquid within which it is contained, but otherwise able to move within the liquid as the device is moved or reoriented with respect to gravity.

FIG. 7a illustration 1 “Initial state” shows the device in side-view cross-section, as if placed horizontally upon a table. The bubbles are positioned within the microchambers at the “top” of the microchambers with respect to gravity. When the device is flipped over by 180° and then placed back down on the table in a horizontal, motionless position, the bubbles momentarily adopt a position as illustrated in FIG. 7a illustration 2 “Just after flipping by 180°”, such that they are briefly at the “bottom” of the microchambers with respect to gravity. However, after some time (e.g. less than a second, or a few seconds, or many seconds) the bubbles begin to float up through the liquid of the microchambers as illustrated in FIG. 7a illustration 3 “Some time after flipping by 180°”, until they float to the new “top” of the microchambers with respect to gravity, as shown in FIG. 7a illustration 4 “Steady state horizontal”.

Note that the bubbles are positioned in the top left corner of the microchambers in FIG. 7a illustration 4. However, slight adjustment and tipping slightly away from horizontal as shown in FIG. 7a illustration 5 “Just after slight angle adjustment” causes the bubble effectively to slide across the “top” inner surface of the microchambers as shown in FIG. 7 illustration 6 “Some time after angle adjustment”. Eventually, the bubbles adopt a new position in the top right corner of the microchambers as shown in FIG. 7a illustration 7 “Steady state at new angle”.

FIG. 7b schematically illustrates how the device shown in FIG. 7a would appear to a user of the device, for example if the device were adhered to or formed an integral part of a security document such as a bank note. The illustrations in FIG. 7b correspond to the device positions shown in FIG. 7a. Accordingly, FIG. 7b illustration 1 “Initial state” shows a top plan view of a reverse side of the bank note and the device as placed horizontal and motionless on a horizontal surface, with the dark blue liquid colour dominating the appearance of the device. Since the microlenses are positioned on the opposite side of the device from this viewpoint, a moiré magnified image is not generally observed. Therefore, although the microbubbles are present at the “top” inner surface of the microchambers, they are not observed as no moiré magnified image is present.

When the device is flipped over by 180° and then placed once again motionless in a horizontal position (as if placed upon a table) the device initially appears as shown in FIG. 7b illustration 2 “Just after flipping by 180°”, with a moiré magnified image only showing the dark blue liquid within the microchambers. However, after some time the bubbles within the microchambers begin to float up towards the new “top” inner surface of the microchambers with respect to gravity, and as they do a virtual moiré magnified image of the bubbles starts to appear as shown in FIG. 7b illustration 3 “Some time after flipping by 180°”. Eventually, the bubbles become a strong feature of the moiré magnified image as they more fully intersect the focal plane of the microlenses as shown in FIG. 7b illustration 4 “Steady state horizontal”, in which the bubbles are positioned on one side of the moiré magnified image corresponding to their position in the microchambers.

Subsequently, as the device is tipped slightly from the horizontal position, the bubbles begin to migrate across the “top” inner surface of the microchambers with respect to gravity, so that they appear transiently in the “middle” of the moiré magnified images of the microchambers, as shown in FIG. 7b illustration 6 “Some time after angle adjustment”. Eventually, the bubbles come to rest in a new position corresponding to that shown in FIG. 7b illustration 7, such that the moiré magnified image appears as shown in FIG. 7b illustration 7 “Steady state at new angle”, with the bubbles repositioned but otherwise remaining in the focal plane of the microlenses.

Accordingly, FIGS. 7a and 7b show an example embodiment where the microscopic entities have a density lower than that of the dispersion liquid in each microscopic chamber—for example one or more gas bubbles, one or more liquid droplets otherwise immiscible with the dispersion liquid, or one or more solid particles having a density less than that of the dispersion liquid. In this case, the flipping action triggers the collective and substantially synchronized upward displacement of the bubbles, droplets or less dense particles in each microscopic chamber (steps 2 to 4 of FIGS. 7a and 7b). As shown schematically in FIG. 7b, this collective displacement can generate dynamic visual changes in the magnified image. The friction force experienced by such bubbles, droplets or particles can optionally be minimized by selecting a dispersion liquid that wets the surface of the microscopic chambers substantially more that the bubbles, or droplets or minimizes particle interactions with sidewalls In this case, a slight angle adjustment of the device is sufficient to create significant collective lateral displacement of the bubbles or droplets in each of the microchambers (as shown in steps 5 to 7 of FIGS. 7a and 7b). The dynamic visual effect obtained in the magnified image is in some respects partially similar to that obtained with a bubble level (see FIG. 7a steps 5 to 7), except that the actual displacement direction of the magnified image of the bubbles or droplets can optionally be rotated compared to the actual displacement direction of the bubbles or droplets (as described previously).

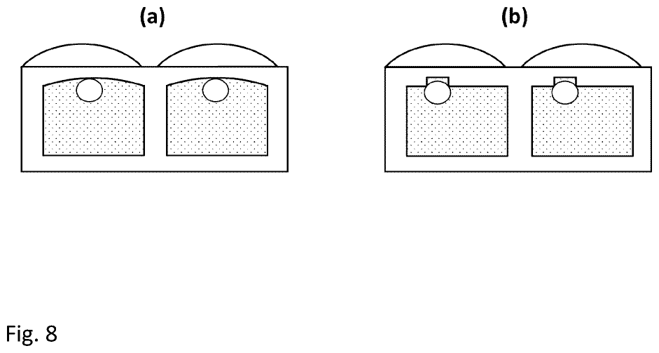

It is important to note that, if microbubbles or droplets positioned in each microchamber are not sufficiently synchronized in terms of their positions in the microchambers, or if their positions are changing randomly across the array of microchambers, the image generator may not be able to use the regular structure of the array to provide a clear and overt magnified image of the bubbles or droplets. As shown in the examples provided in FIG. 8, various structures such as channels (of various shapes, lengths or cross sections), bumps, holes, or curvature (etc.) in the walls of the microchambers may be added to each microchamber to favor collective alignment and synchronization of the bubbles or droplets in the microchambers, which can enhance the sharpness of the magnified image of the droplets or bubbles. The fabrication can also be optimised to ensure formation of bubbles or droplets of similar sizes across the array.

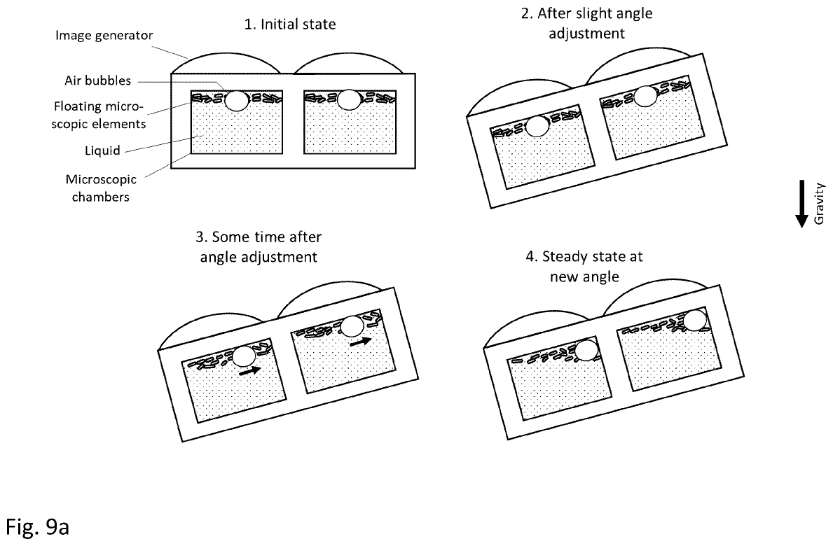

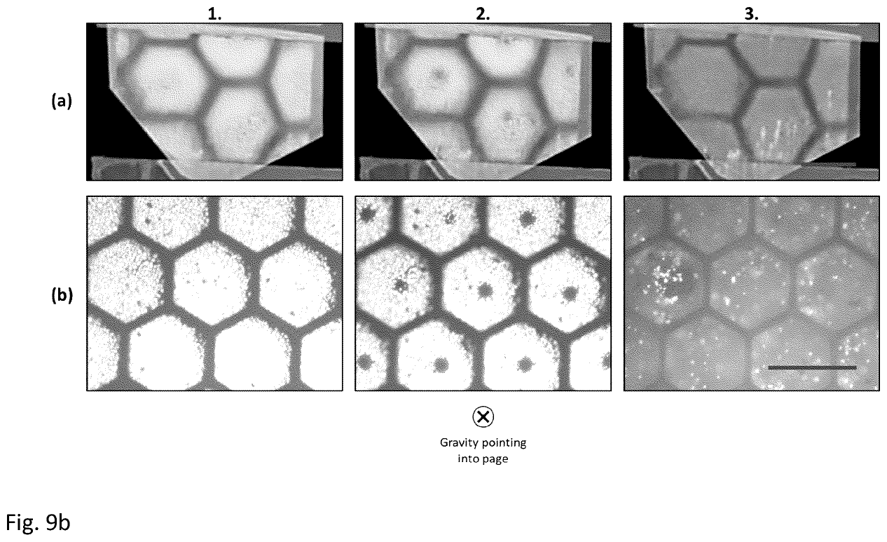

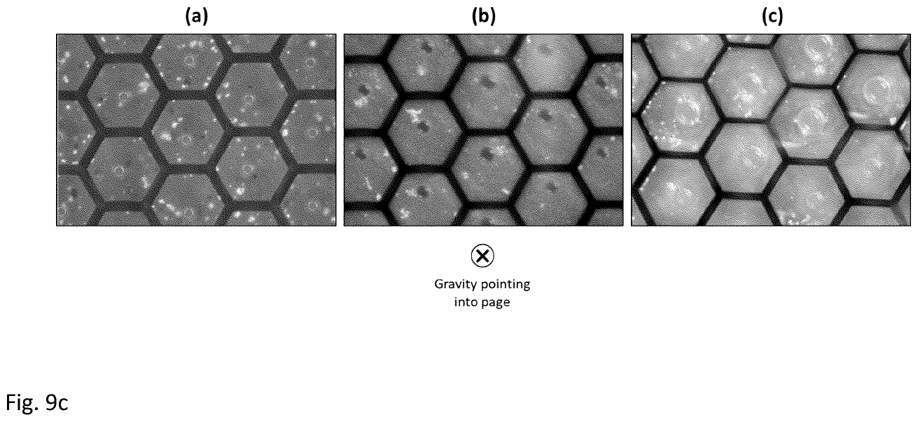

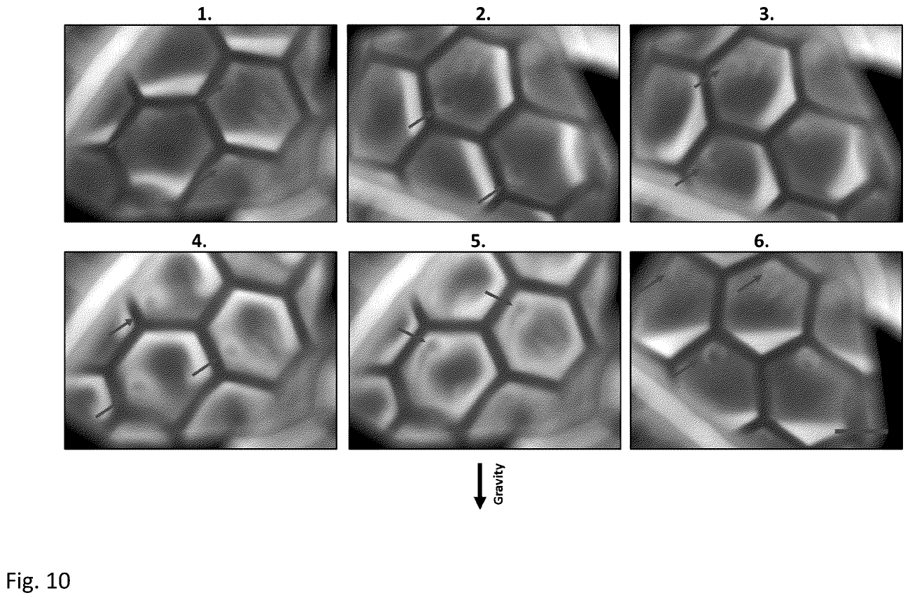

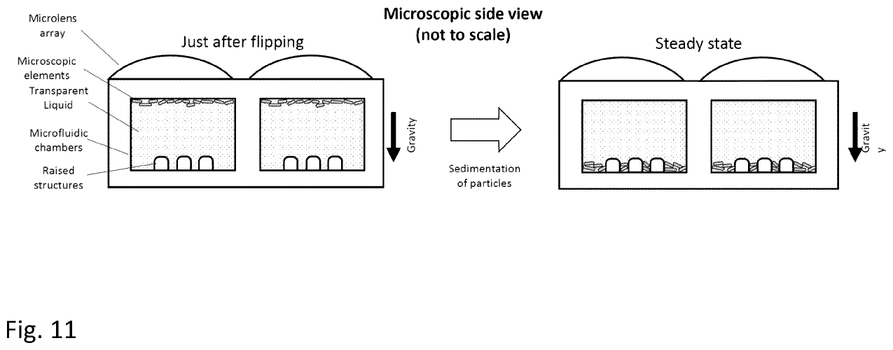

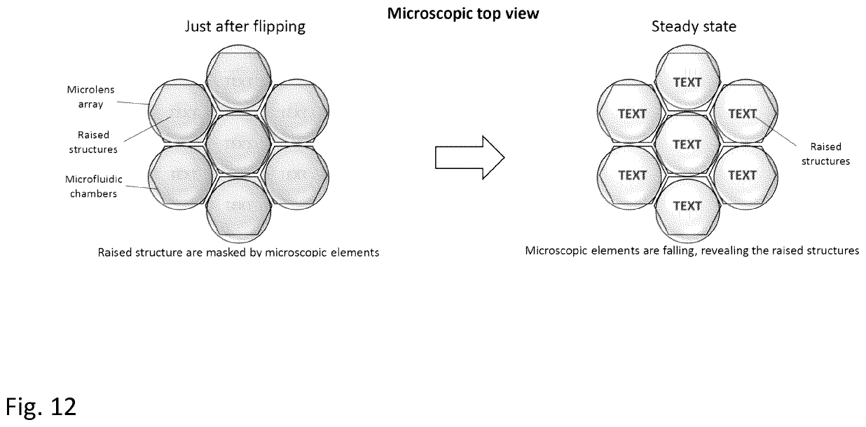

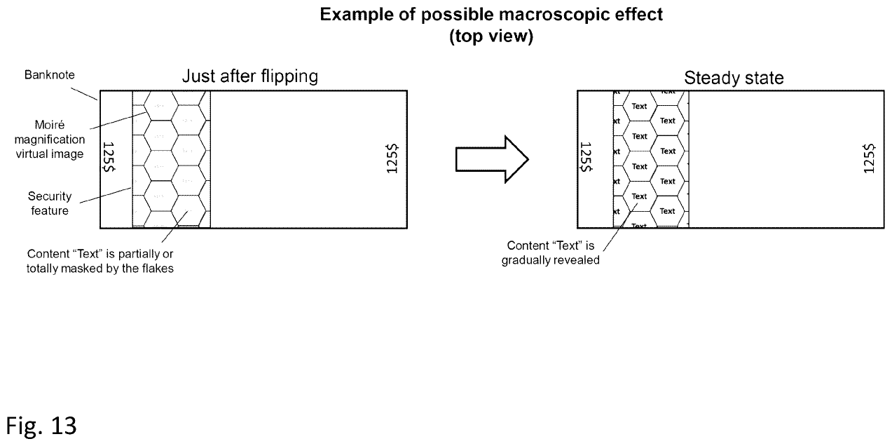

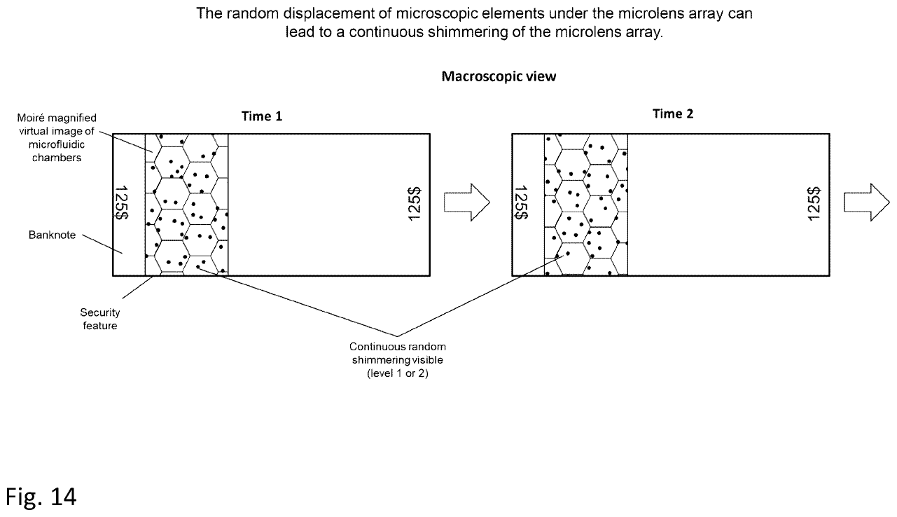

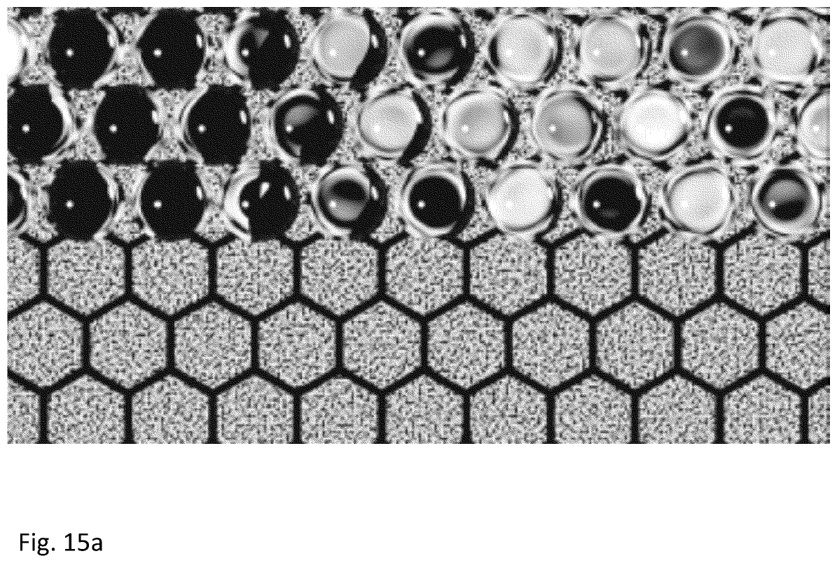

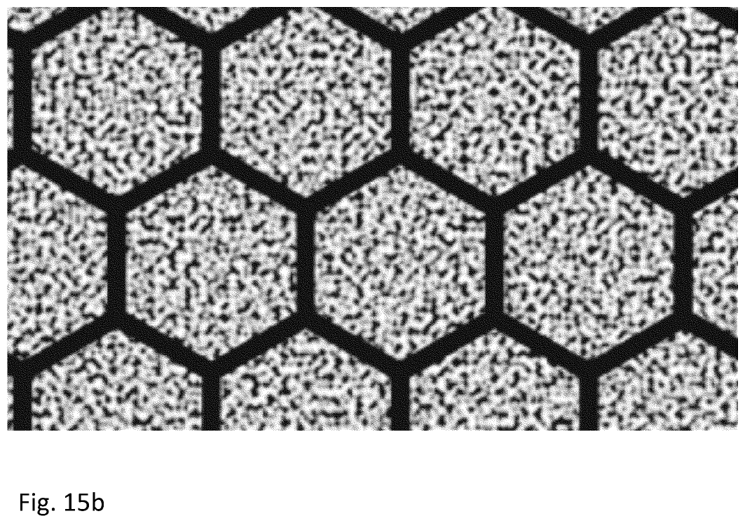

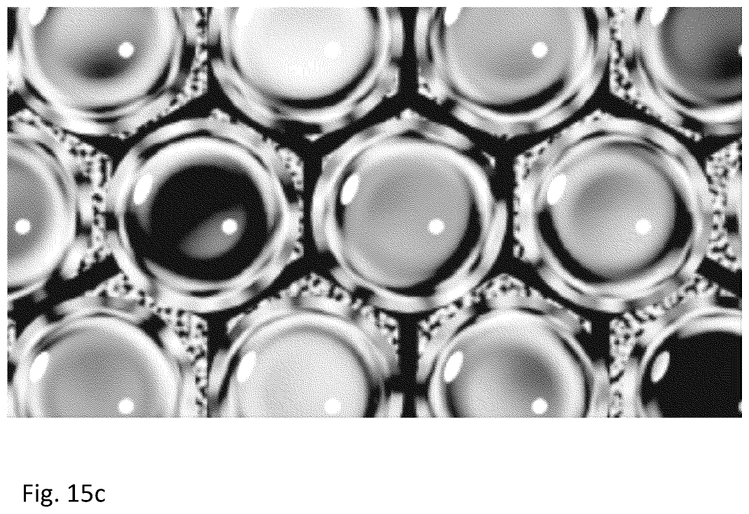

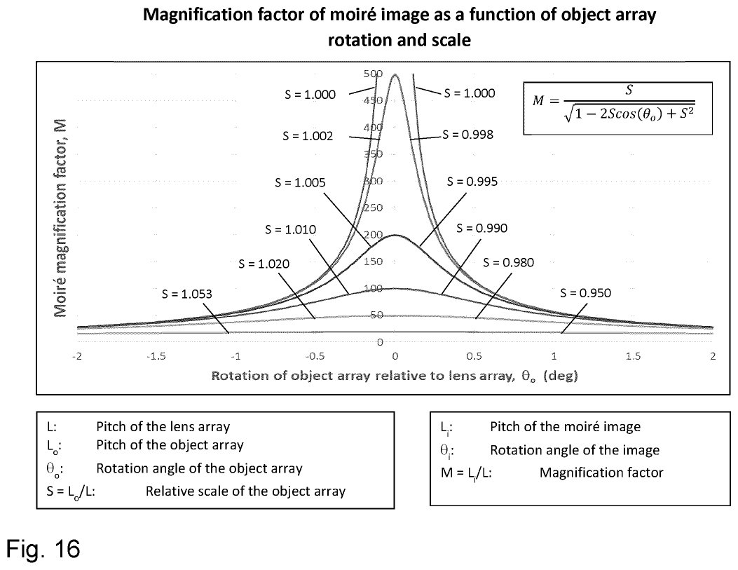

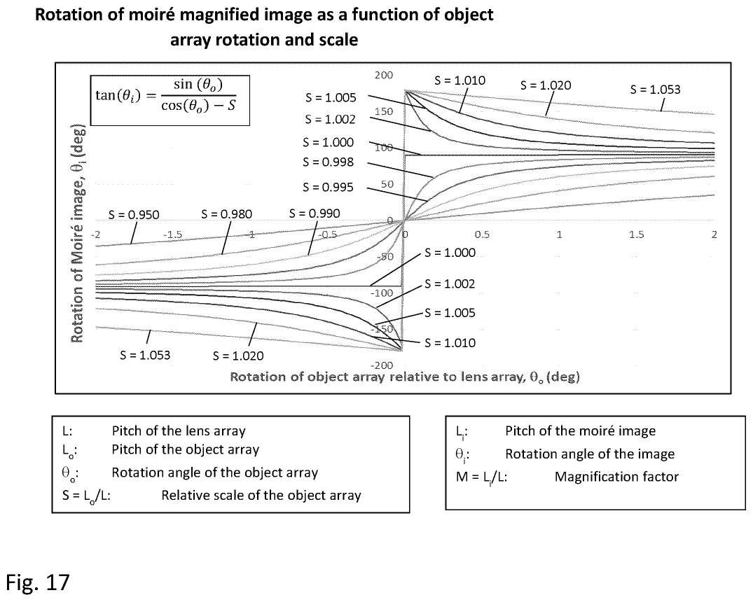

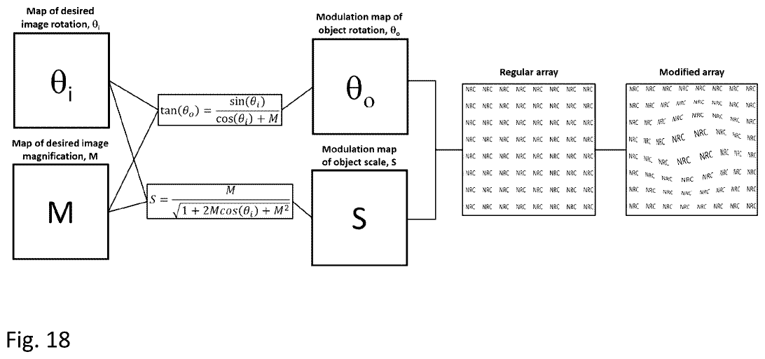

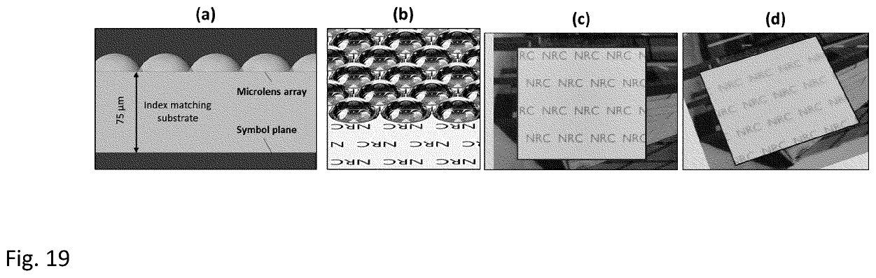

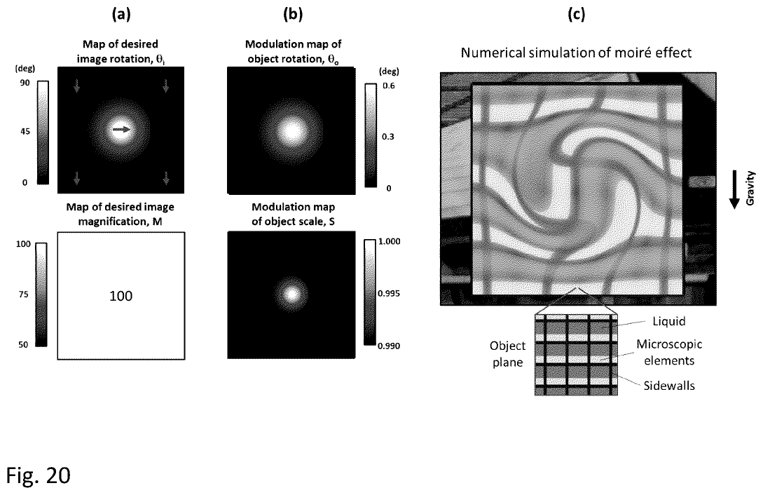

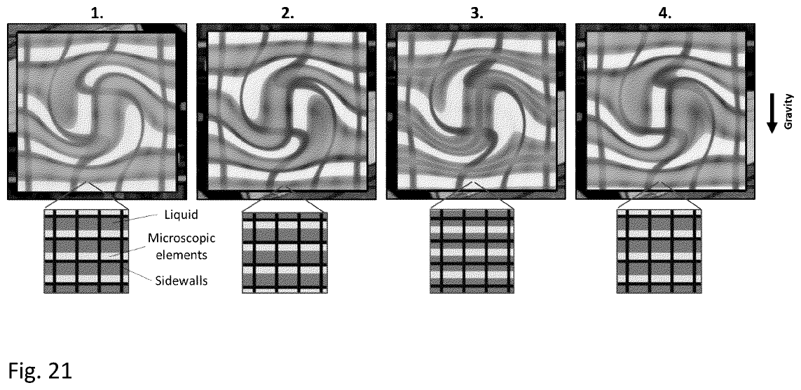

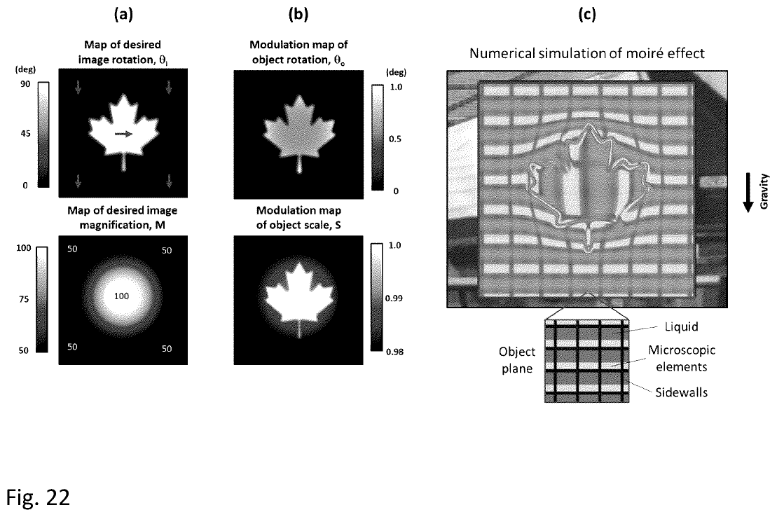

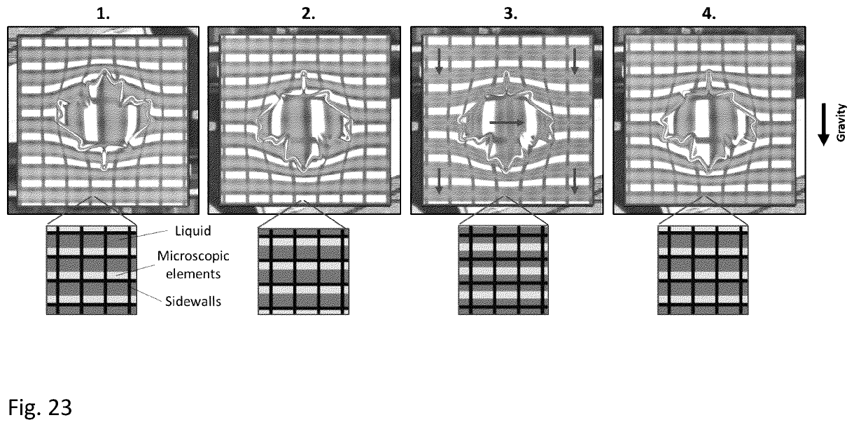

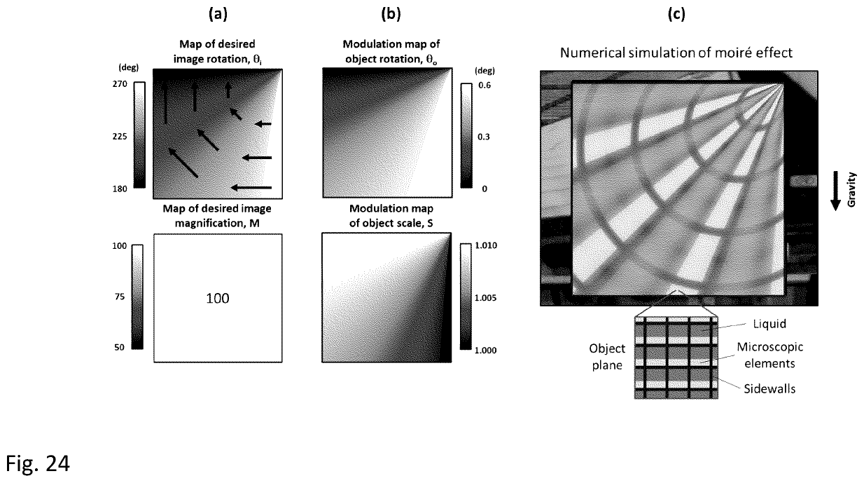

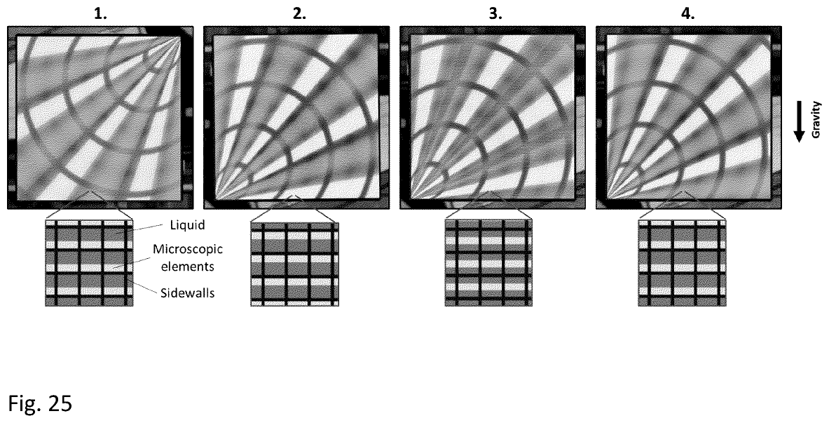

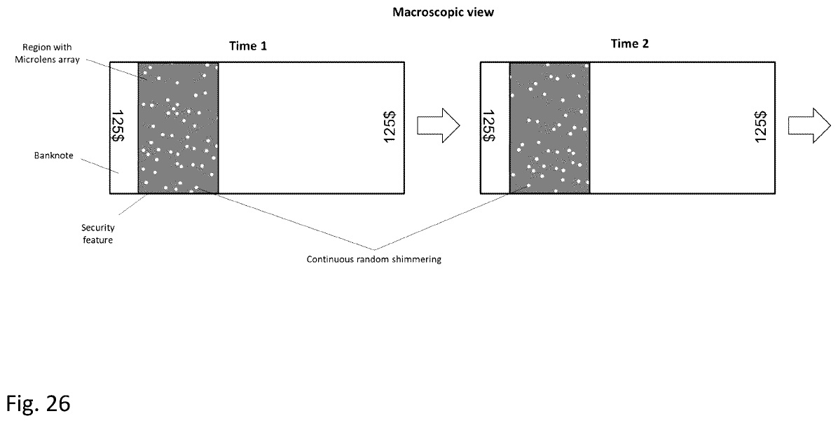

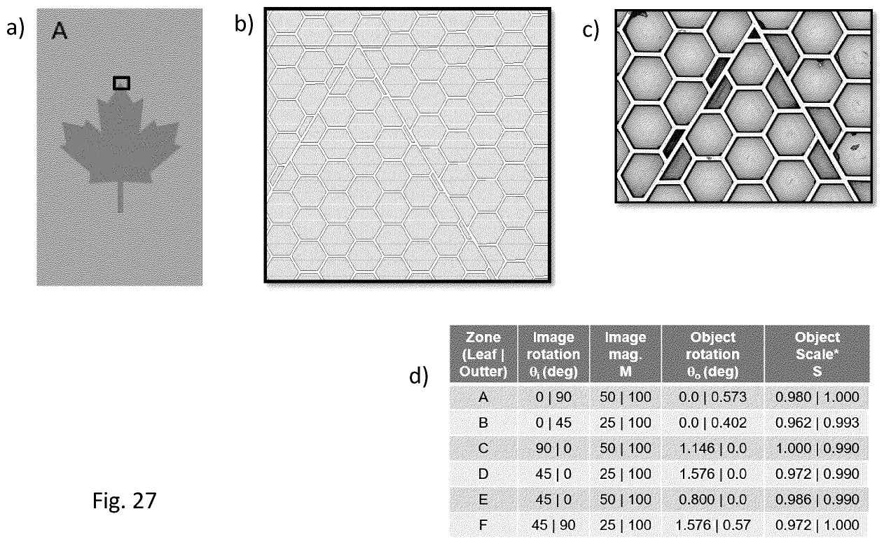

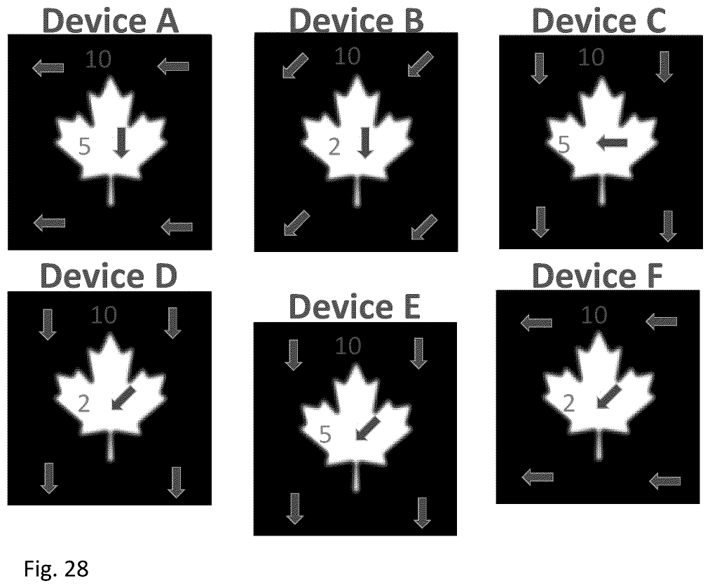

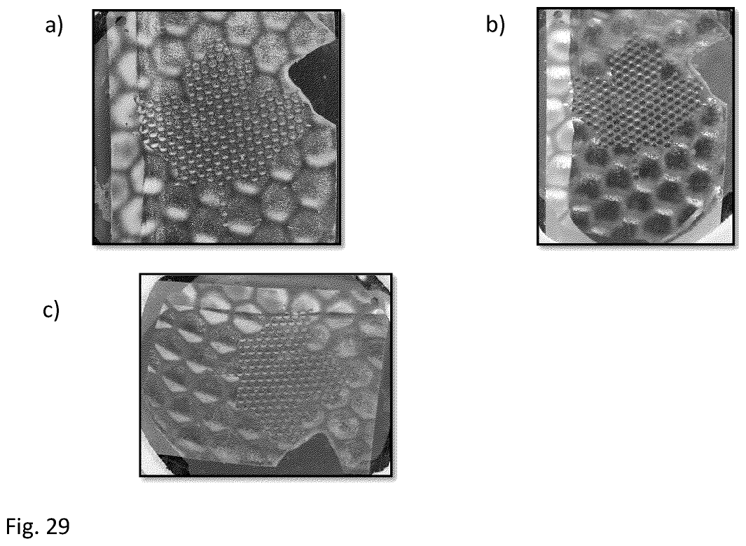

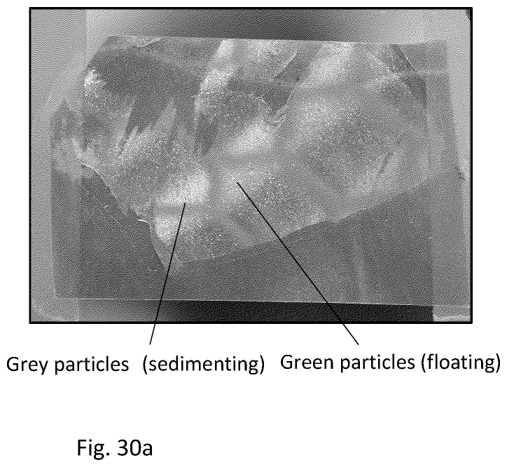

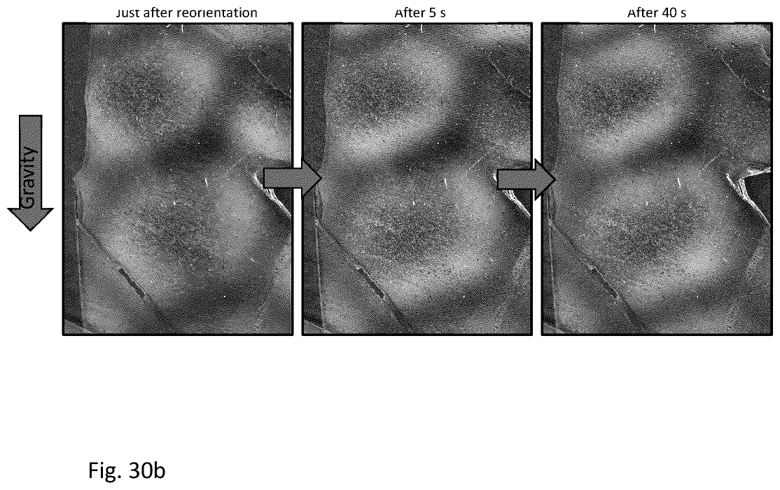

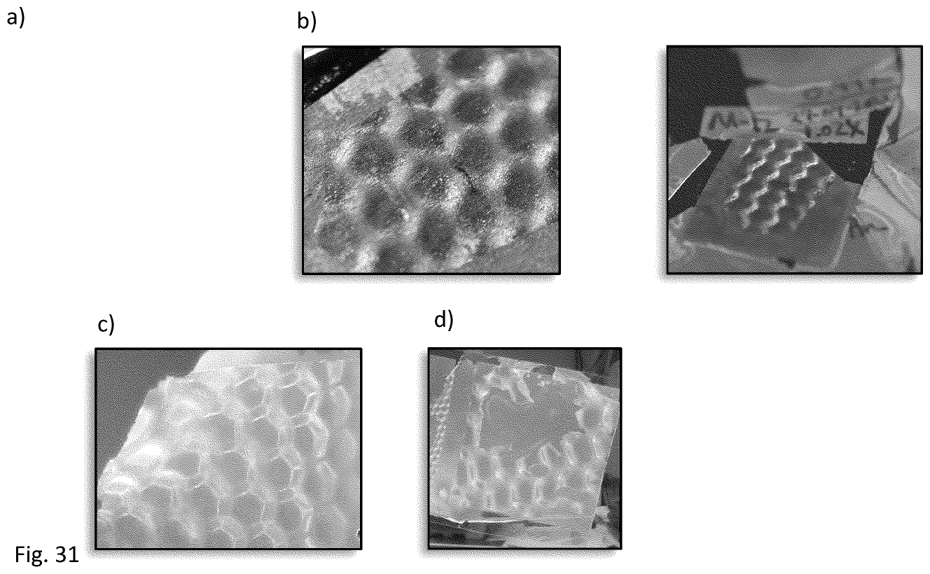

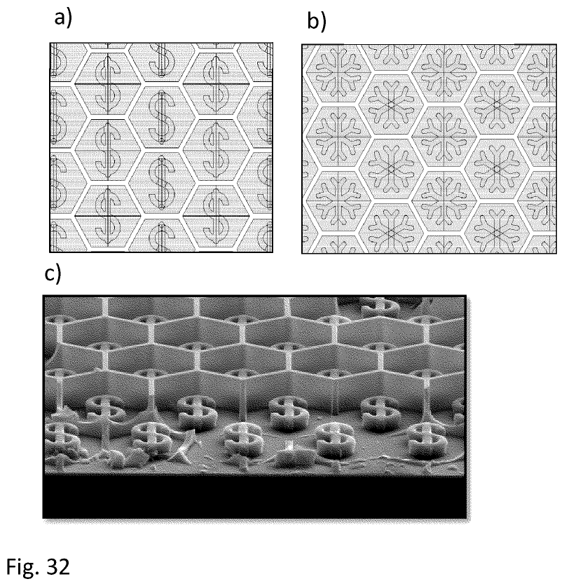

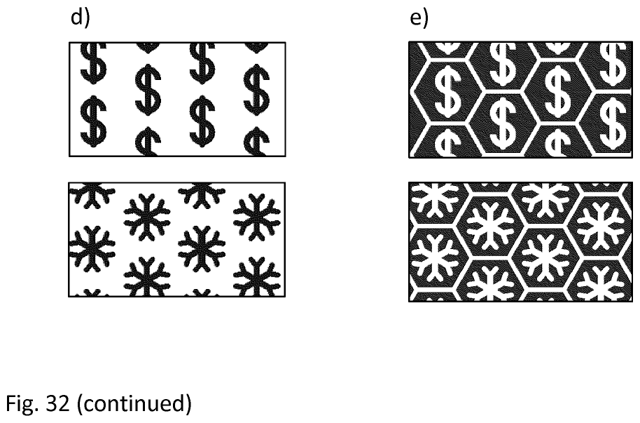

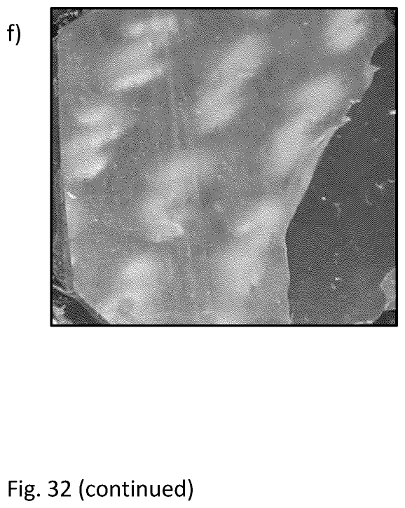

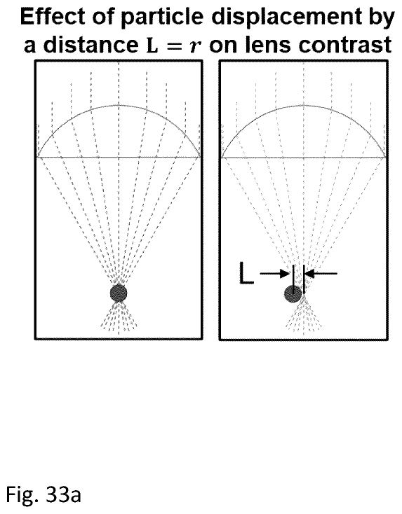

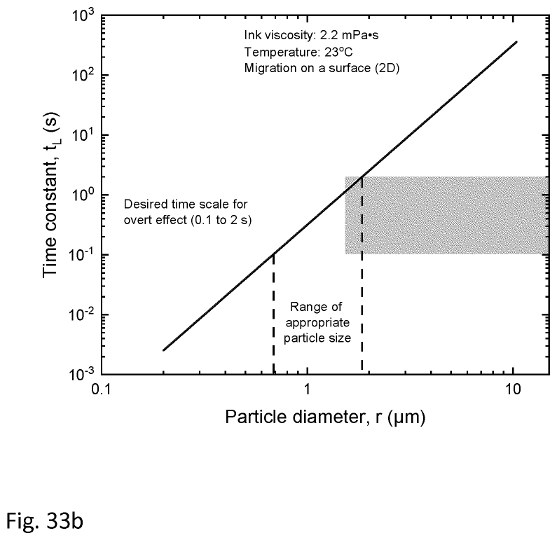

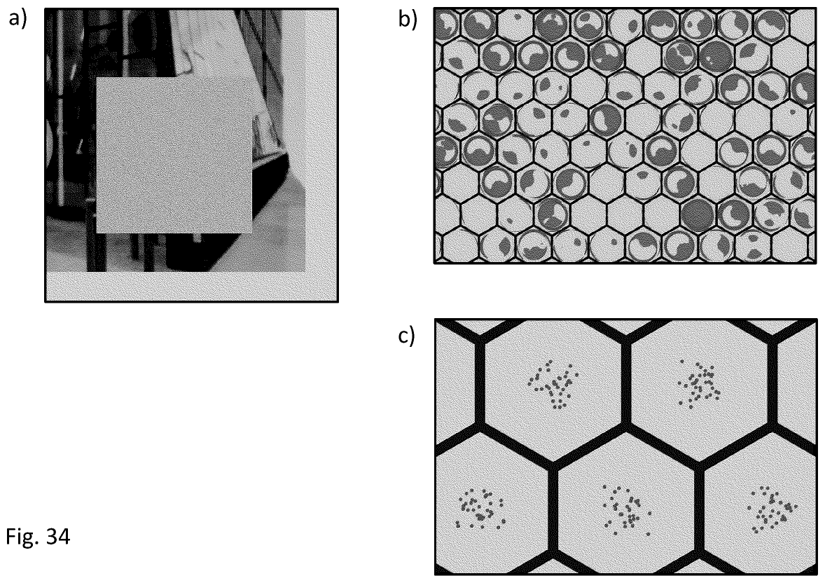

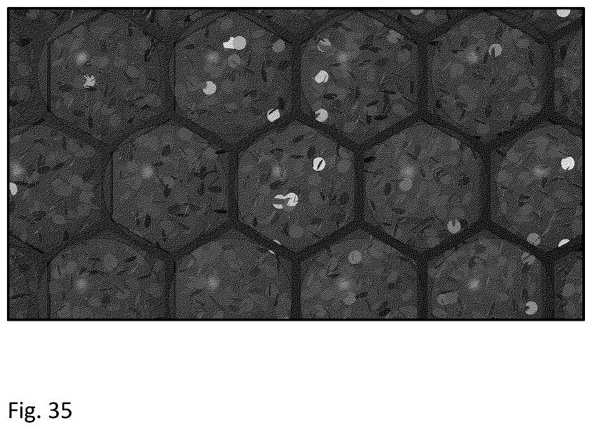

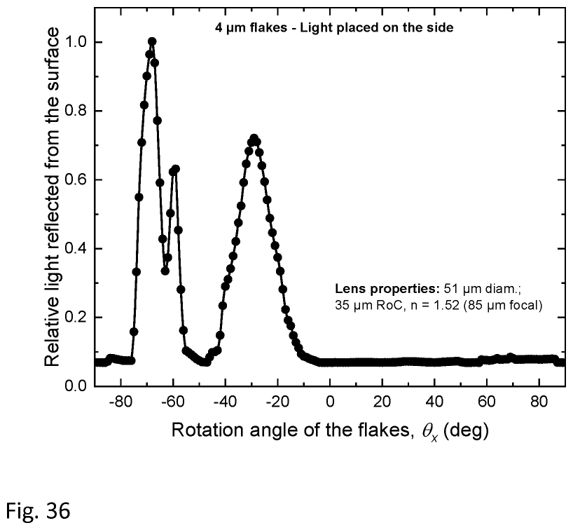

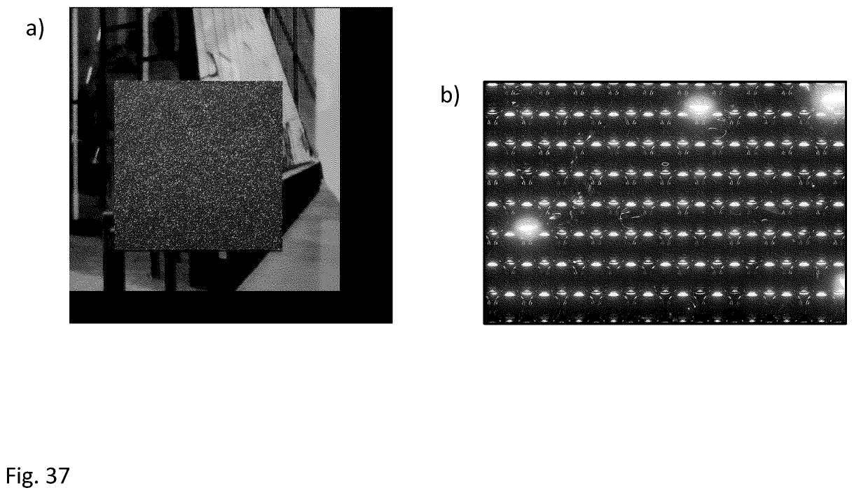

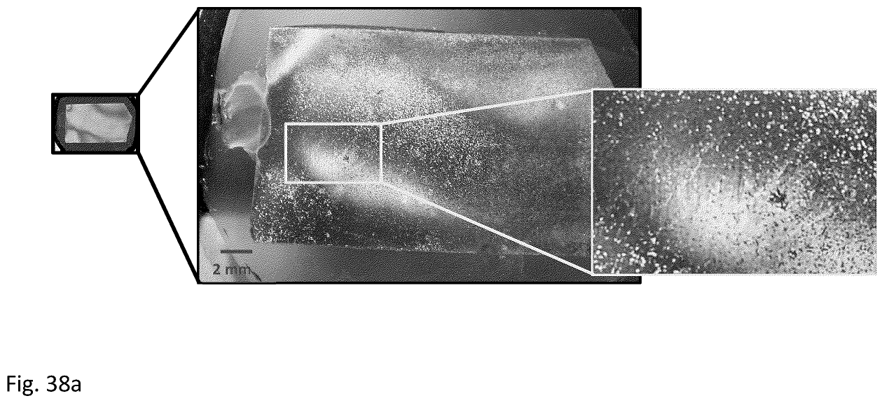

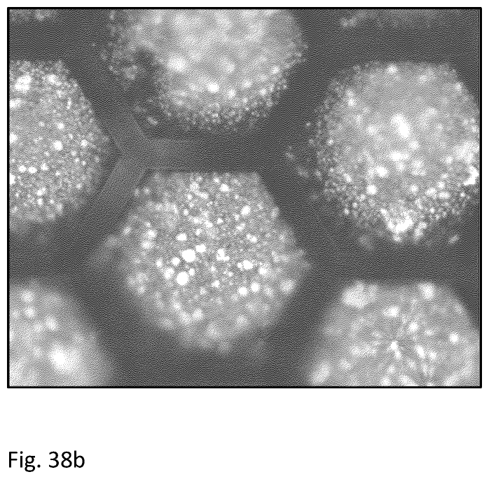

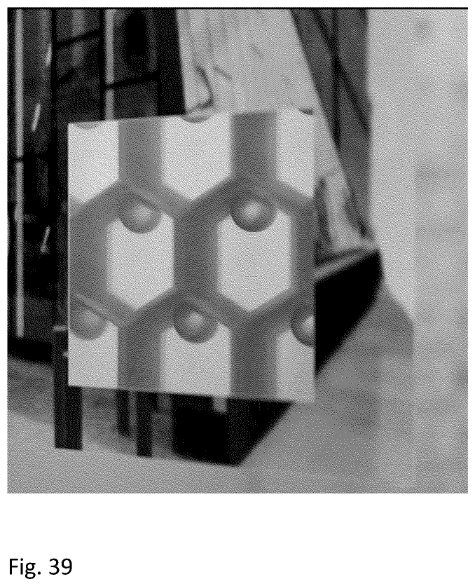

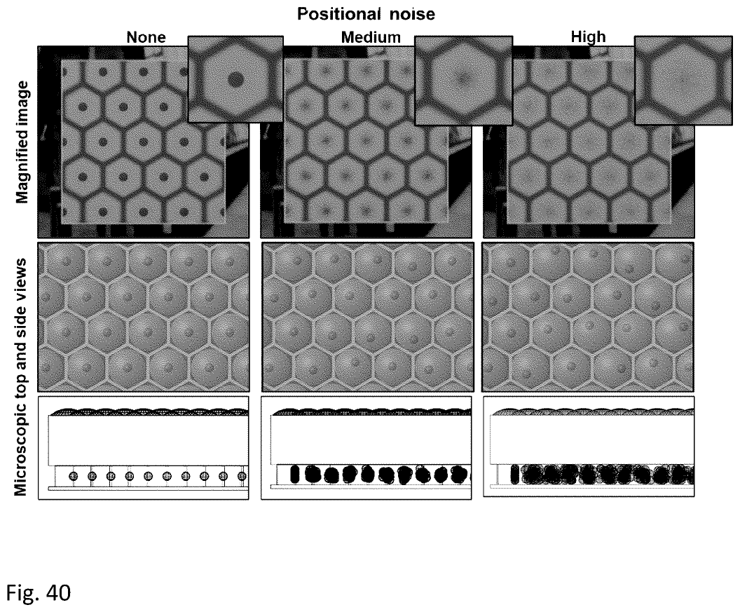

For example, FIG. 9 in general shows an embodiment were several types of microscopic entities with different properties are included in each of the microchambers. In this case, one bubble and a plurality of microscopic elements are added in each of the microscopic chambers, both of which have a density less than that of the liquid allowing them to float in the liquid toward the top of the chamber. For example, the quantity and size of the floating microscopic elements introduced in each microchamber may be selected to produce a mostly continuous layer on the top surface of each microchamber. The layer also preferably has a thickness less than the size or diameter of the bubble. In this configuration, the contrast of the magnified image of the bubble can be enhanced if the microscopic elements have a contrasting color compared with that of the liquid (i.e. each bubble creates a similar region without microscopic elements in each microscopic chamber). As the device is tilted, as shown in FIG. 9a step 2, the resulting displacement of the bubble is shown in FIG. 9a steps 3 and 4, which disturbs the positions of the microscopic elements in a more complex manner (i.e. they need to flow around the bubble). This interaction can lead to an enhanced dynamic contrast change in the magnified image through the processes herein described.

FIG. 9b provides top plan view photographic images in row (a) that show a top view example of the dynamic macroscopic visual dynamic effect that was generated after flipping a device similar to that described in FIGS. 3a and 7a, except that one bubble was additionally introduced in each microscopic chamber in addition to silver-colored particles, which in this case are denser than the fluid (i.e. having a reverse sedimentation direction compared with the microscopic elements shown in FIG. 7a). Just after flipping (FIG. 9b, row (a) column 1), the magnified image of the microscopic chambers is seen to take the color of the particles, as they were then closer to the observer. This is also visible in FIG. 9b, row (b) column 1, showing the corresponding microscopic top plan view of a corresponding device with no microlens present in front of the microchambers. About one second later (FIG. 9b, row (a) column 2), the bubbles present in each chamber reached the top of the microscopic chambers, creating a visible regular pattern caused by the displacement of the particles by the bubbles. This regular pattern is captured by the image generator, leading to a visible macroscopic local contrast change in the magnified image (FIG. 9b row (a), column 2). This is also visible in FIG. 9b, row (b) column 2, showing the corresponding microscopic top view of a corresponding device. A few seconds later, the microscopic elements sediment away from the observer and out of the focal plane of the microlenses, “revealing” the blue color of the liquid in both the macroscopic and microscopic views (FIG. 9b rows (a) and (b), step 3). In this particular example, the bubbles were not visible anymore at this stage in the magnified image possibly due to the poor contrast with surrounding liquid or suboptimal collective alignment of the bubbles in the array.

FIG. 9c shows photographic top plan microscopic photographs of devices where regular arrays of bubbles have been trapped in devices, and where the microchambers are otherwise filled with liquids of different colors: (a) blue, (b) red, (c) transparent. The size of the bubbles is also different for the three examples from smaller in (a) to larger in (c). These examples highlight that the visual contrast provided by the presence of bubbles can be tuned by adjusting various parameters, including ink color, bubble size, interaction with other microscopic entities, lightning configuration, and background color (etc.), which may impact the contrast of the magnified image. Typically, in some embodiments there may be only one type of bubble or droplet per chamber since, during manipulation of the device any bubble or droplet merging may occur in each chamber. However, it is possible to have one bubble and one droplet in each chamber. In further embodiments, one bubble and several droplets may be present in each chamber, each droplet being immiscible with the other droplets and the dispersion liquid. In still further embodiments, multiple droplets may be present in each chamber without air bubbles or any other possible configurations.

Various strategies can be implemented to control the integration of a regular array of bubbles in the microscopic chambers. Gas bubbles can be trapped during the encapsulation process by selecting geometries, materials or processing parameters (such as encapsulation speed, etc.) that favor bubble entrapment. Alternatively, bubbles can be generated by saturating or oversaturating the liquid with a gas and allowing release of gas in the liquid upon equilibration. Ultrasound, shaking actions, or changes in temperature can optionally be used to trigger bubble formation in the devices after encapsulation. Various gases can be selected for the bubbles. Gases that are in equilibrium with atmosphere (pressure and composition) can offer good long term stability as any diffusion through sidewalls of the device is more likely to be in equilibrium. Alternatively, gases that consist of larger molecules can in some embodiments help to reduce diffusion through sidewalls and provide improved long term stability. Droplet integration may be obtained through emulsification of the main ink just before final encapsulation, oversaturation of the main dispersion fluid with a partially miscible liquid, integration of regular droplets in the ink before encapsulation, for example generated through microfluidic process, emulsification or other processes known in the art. The processes above described may in some embodiments be combined for the integration of bubbles and droplets in the same microscopic chambers.

Bubbles or droplets within microchambers of the same array may optionally all be of similar shape and size to help proper replication in any virtual image combining the appearances of the bubbles or droplets. Alternatively, bubbles or droplets may optionally be made of slightly different sizes from one chamber to another to create a ghost or blurry image of the virtual bubbles or droplets in the magnified image. In some embodiments bubbles or droplets may be made of different sizes in different sections of the devices. This can lead to effects where the magnified images of the bubbles appear to grow or shrink as they travel within the magnified image. The size of the bubbles can be changed abruptly or gradually from one location to another, which can lead to effects where the magnified images of the bubbles can appear or disappear as they travel within the magnified image during device manipulation or use of an external force.

Various gases can be selected for the bubbles. Gases that are in equilibrium with atmosphere (pressure and composition) can offer good long-term stability as any diffusion through sidewalls of the device is more likely to be in equilibrium. Alternatively, gases that consist of large molecules may help to minimize diffusion through sidewalls and provide improved long-term stability. Droplet integration can be obtained through emulsification of the main ink just before final encapsulation, oversaturation of the main dispersion fluid with a partially miscible liquid, integration of regular droplets in the ink before encapsulation (generated through microfluidic process, emulsification or other processes known in the art) or other processes known in the art. The processes above described can be combined for the integration of bubbles and droplets in the same microscopic chambers.

Bubbles or droplets may, in selected embodiments, all be of similar shape and size to ensure proper replication in the virtual image. Alternatively, bubbles can be made slightly different from one chamber to another to create a ghost or blurry image of the virtual bubbles in the magnified image. Bubbles can be made of different sizes in different sections of the devices. This can lead to effect where the magnified images of the bubbles appear to grow or shrink as they travel within the magnified image. The size of the bubbles can be changed abruptly or gradually from one location to another, which can lead to effects where the magnified images of the bubbles can appear or disappear as they travel within the magnified image during device manipulation or use of an external force.

FIG. 10 shows a side view example of the macroscopic visual dynamic effect that was generated after placing the device shown in FIG. 9a in vertical orientation. The overall magnified image and dynamic effects associated with a change in the vertical orientation of the device was found to be similar to that described in FIG. 7a. However, the array of bubbles is seen to generate a visible dynamic contrast in the magnified image (highlighted by the arrows). Upon reorientation of the devices (in FIG. 9d step 2), the magnified contrast created by the bubble array is seen to move rapidly toward the top of the magnified image of the microchambers. Also, in FIG. 10 steps 4 and 5, it was observed that upon additional reorientation of the devices, the magnified images of the bubbles may interact with the magnified images of the particles also present, to create a visible “trail” of displaced particle (displaced by the motion of the bubble) in the magnified image. In FIG. 10 step 6, the device is brought back to a new equilibrium, showing the magnified images of the bubbles and the particles respectively toward the top and the bottom of the magnified images of the microscopic chambers. This example illustrates that bright, overt and complex dynamic contrast changes can be generated in selected embodiments that would be overt and readily identifiable by the general public, and yet difficult to deconstruct and replicate. The magnified image can also be rotated (as described previously) which can lead to effects where the magnified image of the bubbles will appear to fall downward instead of floating upward, or travel in another unexpected direction with respect to gravity.

While these examples employ microbubbles, the principles apply to any moveable entity or entities within the microchambers that has a density less than that of the fluid within which it is contained. Other embodiments may employ a combination of moveable entities within each microchamber, some of which are more dense than the liquid, and some of which are less dense that the liquid, within which they are contained. The choice and combination of different types and densities of moveable entities will depend upon the desired optical effect.

### Example 5—Microchambers with Content or Surface Relief

FIGS. 11 and 12 illustrate an embodiment comprising microchamber walls with content or surface relief. In this example, text content may be caused to appear or to reveal itself as part of the Moiré magnified image, depending upon the orientation of the device with respect to gravity. FIG. 11, schematically illustrates at the top section of the figure side cross-sectional views of the device in which, as for previously illustrated embodiments, only two microchambers and two microlenses are shown in cross-section for simplicity. Just after flipping the device over by 180°, and placing the device back down on a horizontal surface such as a table, the particles or flakes are positioned for a short time at the “top” of the microchambers as shown in the upper part of FIG. 11, before they begin to fall within the liquid of the microchambers under gravity. However, after a period of time the flakes (which are more dense than the liquid within which they are contained) begin to fall under gravity to the “bottom” of the microchambers. However, due to the raised structures affixed to or forming part of the “lower” wall of the microchambers in this orientation, the flakes, as they sediment at the bottom of the microchambers with respect to gravity, tend to distribute themselves about the raised structures as shown, and tend to fall down the side of the raised structures under the influence of gravity. In this way, the raised structures and their shape or configuration may become revealed to an observer by the distribution of the settled particles about the surface relief, as part of a moiré magnified image when viewed from above. This concept is illustrated schematically in the lower portion of FIG. 11. This shows how the moiré magnified image of the device may appear when the device is initially oriented as shown in the upper left of FIG. 11, just after it has been flipped over with the flakes briefly located at the ‘top’ of the microchambers with respect to gravity, essentially blocking any view of the rest of the microchambers beneath them. Then, as the flakes fall and sediment into their new sedimented positions, the content of the raised structures is revealed to an observer in the form of text (or other content), as shown in the moiré magnified image illustrated in FIG. 11 lower right portion. Effectively, therefore, the device components and structure permit a hide/reveal effect for content within the microchambers, that may be too small to perceive were it not for the capacity of the microlenses to generate a virtual, moiré magnified image of the content when the flakes are appropriately positioned in the microchambers under gravity, i.e. sedimented and distributed about the surface or relief of the inner microchamber walls.

FIG. 12 schematically illustrates the device illustrated in FIG. 11 in top plan view, just after it is flipped over (left side) and some time after it has been flipped over and left to settle in a horizontal position (right side FIG. 13 illustrates how the device illustrated and described with reference to FIGS. 11 and 12 may appear for a device forming part of a document such as a bank note. FIG. 13 shows the same bank note in the same horizontal orientation, with the device forming a large section of the left-hand portion of the bank note, with a virtual moiré magnified image of microchambers visible to a user from above when observing the bank note in top-plan view as if placed horizontal and motionless on a horizontal surface. However, the left illustration FIG. 13 shows the Moiré magnified image comprising at least substantially a composite view dominated by the flakes, as the device has only just been flipped over and the flakes are temporarily located at the “top” of the microchambers, so that they mask any observation of the content provided by the raised structures at the “bottom” of the microchambers. However, in the right illustration of FIG. 13 the flakes have then fallen under gravity and sedimented about the raised structures, such that the contents of the raised structures is revealed as text forming part of the Moiré magnified image. For example, when distributed about the surface relief, the particles may exist within the focal place of the microlenses to reveal their distribution. Notably, either floating or sinking moveable entities (or both) may be employed to achieve such effects, with surface content or relief present on multiple or opposing walls of the microchambers. For example, with appropriate microchamber design and the use of appropriate moveable entities within the microchambers, different content may be revealed or hidden as the device is oriented in different directions relative to gravity, or different content may be revealed as the device is first flipped over one way, and then back over to its starting position. Moreover, selection of moveable entities and the fluid within which they are contained permits tailoring or colour or content, as well as the rate of appearance or disappearance of the content. Accordingly, the devices encompassed by such embodiments present enormous potential with regard to content appearance and disappearance by simple reorientation of the device, which in turn may provide striking, overt and readily changeable level 1 security features.

While the patterned structures are shown as raised features in this example, various other possible configurations are possible. Structures can also be holes, channels, ridges, arrays, complex patterns (creating images, etc.) that are sharply defined or smooth. The patterned structures can be patterned on the top side, bottom side or the sidewalls of the microscopic chambers, or any combination thereof. This can lead to a wide range of effects where the content is gradually or partially revealed or hidden as the devices are manipulation in various ways (orientation, flipping, shaking, external forces, etc.)

Optionally, the microscopic entities can be Janus particles. One or more Janus particle can be integrated in each of the microchambers. The collective and substantially synchronized rotation of the Janus particles and/or their selective interaction with side walls of the microchambers, may give rise to a dynamic contrast that is magnified by the image generator to generate a macroscopic dynamic contrast or image change.

### Example 6—Random or Brownian Motion Observation with Microlenses

Further experiments were conducted to test the capacity of microlenses to enhance or enable observation of random or Brownian motion of moveable entities within microchambers. This is shown schematically in FIG. 14, which illustrates a bank note in plan view with a security device shown to occupy the left-hand portion of the bank note. The device includes moveable entities such as flakes suspended in a liquid, with the liquid contained within the device, or compartmentalized into compartments for ease of management and to reduce liquid loss or evapouration in the event of device damage. The inventors have observed random movement and/or orientation of flakes can give rise, in some embodiments, to rapid “on” and “off” appearance, or rapid colour switching, of microlenses in a microlens array overlaying the liquid containing the flakes. This may, in some embodiments, give rise to a shimmering effect as the microlenses in terms of their apparent colour or shade, in a randomized way independently from one another. The effect may be continuous providing the flakes remain in suspension for random motion. However, in some embodiments the flakes may have a tendency to sediment in the device, and accordingly may be induced to move into suspension, in order then to undergo a degree of random or Brownian motion, by applying an external influence to the device such as a force. In this way, the shimmering or similar effect of the microlenses may be induced, and then may fade as the flakes settle or sediment again under gravity.

FIG. 15 provides rendered images to compare simulations the effects of microlens magnification upon the visualization of random or Brownian motion, as caused by insertion of a moving texture into hexagonal chambers of a numerical simulation framework. The moving texture was placed at the focal points of the microlenses. As may be observed in the photograph shown in FIG. 15a, a comparison of the moving texture with the microlens overlay (upper portion) and without the microlens overlay (lower portion) illustrates how the microlenses display either a black or white appearance according to what shade is currently intersecting their focal point. FIG. 15b shows a closer view of the hexagonal chambers without the microlens array, whereas for comparison FIG. 15c shown a closer view of the hexagonal chambers with the microlens array, to emphasize this point.

The present technology may permit amplification for visualization of the random or Brownian motion to a level that permits such motion to be observable by the naked eye, or at least with the assistance of a further screening or observation tool. For this purpose, larger lenses greater than 100 microns in diameter may in some embodiments be preferred, with a very small focal spot ideally less than 1 micron in size with minimal spherical aberration. Moreover, in some embodiments, observation of random or Brownian motion in transmitted light may be preferred, for example using chambers filled with transparent fluid other than the presence of the moveable entities, preferably with some control over particle filling ratio to block out some, optionally 40-60%, of the transmitted light. In this way, as the particles experience Brownian motion, they can block and unblock light transmitted through the device and captured by each microlens, also leading to certain optical effects such as shimmering.

In selected embodiments that employ Brownian motion, the properties of the microscopic entities may be selected to create sedimentation or floatation in the liquid, and/or favour positioning of the entities in a specific location or locations within microchambers, for example close to the focal point of the microlenses.

In other embodiments, the entities may be at equilibrium or close to equilibrium diffusion of the entities inside each of the microchambers, and this in turn can favour a similar visualization of a magnified shimmering effect independent to the orientation of the devices.

In further embodiments the concentration of the entities in the microchambers can optionally be selected (i) to be high enough to ensure presence of some particles under a significant proportion of the microlens focal points but (ii) to be low enough to avoid circumstances where microscopic entities are always or nearly always present under the microlens focal points.

Accordingly, in selected embodiments it was found that the presence of an image generator such as microlens array can be used to amplify the visualisation of random or Brownian motion, possibly even to a level that may be seen by the naked eye. The effect, which is shown schematically in FIG. 14, may for example generate a continuous shimmering of the security device that does not require any manipulation of the note or change in the angle of observation. In this case, the dynamic effects shown by the device may, in some embodiments, be derived directly from the thermally induced random displacement of the microscopic entities in the microscopic chambers. As the microscopic entities diffuse toward and away from the focal point of a microlens, or rotate within the focal point of a microlens, the entire surface of the microlens can experience significant contrast change. If the lenses are large enough, this contrast change may lead to shimmering effects that may be visible to the naked eye, or visible at low magnification that can be achieved using a simple magnifier or a cell phone camera. It is important to note that the amplification of random Brownian motion may be independent of the Moiré magnification of the image magnifier. Indeed, as Brownian motion involves random motion of the microscopic entities, its effect does not typically lead to a collective and substantially synchronized displacement of the entities within microchambers. Accordingly, random or Brownian motion effects therefore typically are not enhanced or made more conspicuous by moiré magnification. Parameters such as pitch difference or angle between the microchambers and microlens arrays do not typically affect magnification of Brownian motion. On the other hand, it was found that the microlenses can be used to amplify or magnify directly the visual shimmering caused by Brownian motion. Further, as Moiré magnification is not generally required for such random or Brownian motion embodiments, microlenses may be employed that are much larger than the microchambers present, thereby to further enhance the direct magnification provided by the microlenses.

To favor visualisation of Brownian motion by naked eye, the microscopic entities experiencing Brownian motion may in selected embodiments exhibit a strong color contrast with surrounding fluid, either through their properties or through illumination (e.g. strong backlight with opaque particles and transparent liquid, etc.). Further, the design of the device may favour positioning of the microscopic entities close to the focal point of the microlenses to ensure that small random displacements of the entities lead to strong color contrast change once magnified by the microlens. To favor high alignment accuracy, the properties of the microscopic entities may optionally be selected to create a degree of sedimentation or floatation in the liquid to favor more precise positioning to a specific location close to the focal point of the microlenses (Péclet number >1). The shape of the microscopic chambers can also be optimized (e.g. curvature, structures, patterns, etc.) to favor in plane alignment of the microscopic entities close to the focal point of the microlens array. Alternatively, microscopic entities may be at equilibrium or close to equilibrium (Péclet number <1). This in turn may allow diffusion of the microscopic entities in three dimensions inside each microchamber, and may favor similar visualisation of the magnified shimmering effect independently of the orientation of the devices. Microlenses may optionally be large (preferably diameter >100 μm) and have a very small focal spot (ideally <1 μm) with small amount of spherical aberration (i.e. shallow or aspherical microlenses are an option) that lead to a large contrast globally affecting the entire surface of each microlens when a microscopic entity is at the focal point of the microlens. The concentration of microscopic entities in the microscopic chambers can optionally be selected to ensure presence of some particles under a significant proportion of the microlens focal points. However, in some embodiments their concentration should preferably not be so high that the microscopic entities are always or nearly always present under the microlens focal points (i.e. cases where a particle is always replaced with another one when it diffuses away).

The shape of the microscopic entities, in some embodiments, also be used to enhance the contrast generated by their random displacement or to affect their Brownian motion. Magnified Brownian motion effects can be achieved not only through translational Brownian motion but also through rotational Brownian motion. For example, Janus particles with two or more colors on their surface experiencing random rotational Brownian motion may lead to contrast change even without significant translational Brownian motion. Liquid viscosity may, in some embodiments, be low to maximize Brownian motion. However, high liquid viscosity may in some embodiments be favorable to reduce the speed of the contrast change caused by magnified Brownian motion, to aid visualization of the effect. While affected by temperature, Brownian motion typically remains relatively stable under temperature fluctuations close to room temperature, ensuring compatibility of the effect with usual temperature range under which level 1 or 2 features are typically tested.

There is a distinction between magnification of the direct shimmering caused by Brownian motion and magnification of a diffusion process. While the former is a random process that may not be amenable to magnification through Moiré magnification (generally only though direct magnification provided by the microlens array), the latter is an average effect that can be similar across all the microscopic chambers. Therefore, the image generator may be used to magnify diffusion of particles (e.g. following the removal of an external force) through moiré magnification, or may cause the diffusion to be visible through moiré magnification. The microscopic chambers and the microscopic entities can also be modified to generate a preferential diffusion (or a biased/frustrated motion) along some directions to generate more complex effects that are gradually revealed in the magnified image as the average substantially synchronized diffusion of the microscopic entities take place in each microscopic chamber.

### Example 7—Optimization Strategies

In selected embodiments presented so far, the fluid and microscopic entities may have contrasting optical properties that, once magnified through the image generator, lead to overt dynamic contrast changes following the collective and substantially synchronized displacement of the microscopic entities. The fluid can optionally be transparent. In this case, the displacement of the microscopic entities can still block, reflect, refract, or alter the light entering in the device to generate a clear visual effect in the magnified image. The fluid is optionally a liquid but can also be an emulsion, a dispersion, a mixture of various liquids, a gas, a foam, or any combinations thereof. However, at microscopic scale, gravity or change of orientation may not be strong enough to overcome electrostatic, Van der Waals and other forces naturally present in the system without a liquid. Optionally, the fluid or liquid may contain surfactants, dispersants, synergists, stabilizers, dispersion agents, emulsifiers, charge control agents, anti-static agents, anti-foaming agent or other additives to help reduce interaction between the microscopic entities and sidewalls of the microscopic chambers.

External forces such as magnetic, electric, acceleration, shaking, pressure, centrifugal force, light, sound, or other forces affecting the microscopic entities collectively can alternatively or additionally be used to generate targeted dynamic effects in the magnified image. The microscopic entities can have characteristics that favor interaction with specific external forces (e.g. they can be magnetic, have a high density, or b charged, etc.).

Optionally, the microscopic entities may have significant variety of properties (size, shape, color, roughness, density, etc.) and the local amount of microscopic entities in each microscopic chamber may also be substantially different between microchambers, although the overall averaged characteristics of the microscopic entities that affects the final magnified image are preferably, substantially similar from one chamber to another. If local random variations in the amounts of entities present in the microchambers, or if the properties affecting the displacement or optical contrast of the microscopic entities are present (e.g. random noise), then the moiré magnified image of the microscopic entities may become less well defined or even blurry, which may be detrimental to the targeted visual effects (but which could also be useful to generate specific types or styles of visual effects). However, abrupt changes in the types or properties of microscopic entities, the fluid within which they are contained, the microchambers or the image generator, can optionally be integrated in the devices if desired, in order to create visually distinct zones that would be apparent to the end user. As an example, this can be used to create images where the magnified image of the microscopic entities appears or disappear, reappear, or with lesser or greater degrees of magnification, rotation or virtual image clarity, in different areas of the device. For example, in some example devices a more central region defining a certain shape or image may have, compared to the areas of the device surrounding the shape or image, a different depth effect, rotation effect, or different degrees (lesser or greater) image blurring by intentional increased or decreased image noise as discussed herein.

In other embodiments, the physical properties of the fluid (viscosity, density, etc.) and the physical properties of the microscopic entities present (density, size, etc.) may also be selected to control the speed of the dynamic effects as required, for example to make the user's interaction with the device more dynamic or overt, or to make the devices easier or quicker to use and authenticate. For example, the dynamic effects generated following the manipulation of the device, or by initiation of an external influence, may optionally cause a dynamic observable change in the device over a duration in the 0.1 to 100 s range, or in the 1 s to 10 s range. Also, while the dynamic effect may last for a long duration, the effect may provide a quick visual dynamic contrast change that is sufficient to allow rapid authentication of the device, in some embodiment in less than 10 s, and in other embodiments in less than 2 s.

Moreover, in some embodiments the microfluidic chambers may be independent or sealed from one another (i.e., fluidically isolated one from another) to provide good long term durability and to prevent local defects in the device from causing failure of the entire device. This is, however, is not a requirement for all embodiments, as working devices may be useful with fluidic connections between the chambers. However, for some embodiments it may be desirable to at least substantially prevent microscopic entities from travelling significantly from one microchamber to another, to prevent changes in the concentration of entities in each chamber, which in turn could have a detrimental effect upon the quality of the magnified image.

In some embodiments, static printed features may be added to the devices to generate additional interesting effects. For example, the dynamic effects generated in the magnified image on the surface of the devices may be designed to appear to interact with static features otherwise printed on or near the device. For example, in some embodiments a sedimentation direction for entities within a device may be altered to appear to move locally around a printed feature to give the impression that the static feature interacts with (e.g. pushes, deflects, collide with, etc.) the observed dynamic movement or displacement of the microscopic entities in the moiré magnified image.

As discussed previously, the apparent displacement direction of the microscopic entities in the moiré magnified image may be different than the actual displacement direction of the microscopic entities under gravity or another external influence or force, depending on the configuration of the image generator (e.g. rotation of magnified image). The magnification factor of the more device may also be readily modulated to create magnified images of different sizes. The following equations provide the theoretical magnification factor M and rotation angle θᵢ of the magnified image for regular object and microlens arrays magnified through moiré magnification:

$$M = \frac{S}{\sqrt{1 - 2 S cos ( {θ}_{o} ) + {S}^{2}}} \qquad ( eq . 1 )$$

$$tan ( {θ}_{i} ) = \frac{sin ( {θ}_{o} )}{cos ( {θ}_{o} ) - S} \qquad ( eq . 2 )$$

where, θₒ is the rotation angle of the object array compared with the microlens array and S is relative scale of the object array compared to the lens array (i.e., S=L₀/L where L₀ is the pitch of the object array (for e.g., the microscopic chambers) and L is the pitch of the microlens array).

FIGS. 16 and 17 provides calculated examples of the magnification and rotation angle of the magnified image that is obtained for various values of θₒ and S. In these calculations was observed that very high magnifications above 100 may be achieved if both arrays have similar scale and direction (i.e. low rotation angle of the object array). Also, it was observed that the rotation angle of the magnified image can be changed from −180 to 180 degrees with very small rotation angles of the object array compared to the lens array. The fact that small changes in the scale and direction of the array can lead to important or significant effects in the magnification and rotation angle of the magnified image simplifies the elaboration of devices with a wide range of rotation or magnification.

Simulation work also illustrated that interesting and intriguing effects can additionally be generated by controlling locally the rotation angle θᵢ and magnification factor M of the magnified image on different regions of the devices. For example, by generating microchamber arrays that show slight local irregularities compared with the microlens array, it was possible to create magnified images where the sedimentation direction (or more generally, the displacement direction of the microscopic entities) is locally distorted leading to multiple apparent sedimentation directions within the same device. Alternatively, it is possible to increase magnification locally in some regions of the device to better highlight the collective and substantially synchronized displacement of the microscopic entities in some areas of a device relative to other areas. It is also possible to affect both the local direction of sedimentation and magnification in complex ways to increase the overall impact and overtness of the security device (for example local lensing effects, integration of complex artworks, sedimentation that appears to converge toward one point, etc.).

FIG. 18 illustrates schematically a process developed to generate local perturbations in the magnified images. The process starts by selecting a map detailing the desired rotation angle of the magnified image at every point on the device surface. A similar map detailing desired magnification of the magnified image at every point on the device surface is also created. By solving equations 1 and 2 for θₒ and S:

$$tan ( {θ}_{o} ) = \frac{sin ( {θ}_{i} )}{cos ( {θ}_{i} ) + M} \qquad ( eq . 3 )$$

$$S = \frac{M}{\sqrt{1 - 2 M cos ( {θ}_{i} ) + {M}^{2}}} \qquad ( eq . 4 )$$

it is then possible to calculate modulation maps for the object rotation and object scale that would lead to the desired image rotation and magnification on the entire surface of the device. These modulation maps are then applied to the regular object array to generate a new deformed or modified object arrays. Once this modified object array is placed under the regular microlens array, the target magnified image may be generated that matches the initial specifications provided in the maps of desired image rotation and magnification.

To evaluate this concept, a numerical framework was developed based on a stochastic path tracing algorithm to simulate moiré magnification effects. The framework allows determination of moiré effects for arbitrarily patterns placed in any possible relative orientations, allows for simulation effects of viewer position and angle of observation, and may include various materials with different refractive index, colors, roughness, etc.

FIG. 19 provides a general configuration that was considered for the numerical simulations shown below. As shown in FIGS. 19a and 19b, an object plane array (representing the microchambers or any other artwork; in the case, an array of the letters “NRC”) was placed close to the focal point of a microlens array (focal length: 75 μm, Pitch: 54 μm, Diam. 51 μm, Height: 17 μm, n=1.39, Spherical). The numerical framework then provided directly the magnified image for a 2×2 cm device containing about 150,000 microlenses through the path tracing algorithm. In the example shown in FIG. 19c the arrays parameters were selected to provide a magnification factor of about 100 and rotation angle of 0 deg. As the angle of observation changed (FIG. 19d), the numerical system provided the correct “sink”, “float” or orthoparallactic effects typically associated with micro-optic security devices based on moiré magnification.

FIGS. 20 and 21 show the results of a numerical simulation showing an example of local perturbations in the magnified image. In this example, the map of desired rotation for the magnified image contains a central region where the rotation angle is set to 90° and the map of desired image magnification is set to a constant value of 100 (FIG. 20a). On the basis of the algorithm described previously, the modulation maps for the object rotation and object scale were calculated (FIG. 20b). The actual deformation of the object array remained very small (rotation from 0 to about 0.6 deg and scale from 0.99 to 1.00), therefore minimizing the impact on the fabrication and filling of the microchambers. The deformed object array (i.e. the microchambers) was then inserted in the numerical framework described above to generate the 2×2 cm magnified image shown in FIG. 20c. It was clearly seen that the magnified image of the microchambers (shown as an inset of FIG. 20c) was strongly deformed closed to the centre of the device, matching the specifications provided with the maps of desired image rotation and magnification. FIG. 21 shows the effect that would be obtained when the device is placed vertically (step 1) and rotated by 180° (step 2). This would be predicted to generate sedimentation of the microscopic entities that are represented as lighter silver-colored particles moving in a darker blue liquid (steps 3 and 4). It was observed that the sedimentation direction in the magnified image followed the deformation of the image and was rotated by 90° in the center of the device.

FIGS. 22 and 23 provide another example of a more complex image deformation. In this case, a rotation was specified of the magnified image by 90° along a maple-leaf shaped region, with a magnification going from 50 on the edge of the device to 100 in the centre of the device. Following the same procedure as described previously, the resulting magnified image is shown in FIG. 22c and the effect of rotation for a device placed vertically is shown in FIG. 23. The maple leaf was observed to appear in the magnified image despite the very small modulations applied to the object plane (rotation from 0 to about 1.0 deg and scale from 0.98 to 1.00; see FIG. 22b). The direction of sedimentation highlighted in FIG. 23, steps 2 to 4, is also seen to follow the maps shown in FIG. 22a.

FIGS. 24 and 25 provide another example of a more complex image deformation. In this case, a rotation angle was specified for the magnified image changing continuously from 180 to 270 degrees about a central point located in the corner of the device, with a constant magnification factor of 100 (FIG. 24a). Following the same procedure as described previously, the resulting magnified image is shown in FIG. 24c and effect of rotation for a device placed vertically is shown in FIG. 25. The magnified image of the microscopic chambers was observed to be severely distorted in order to follow the requested change in image rotation. Also, as the device was rotated, the direction of sedimentation was observed to follow an axial circular motion around the corner of the device (FIG. 25).

In summary, the capacity to control local rotation angle and magnification of the simulated moiré magnified images facilitated the generation of more complex dynamic effects that may, at least in some embodiments, be overt and surprising to a user of the device. While similar deformations of magnified images are also possible for more traditional “static” micro-optic devices, the devices disclosed herein have the distinct characteristics of providing a reference direction to the end user through the influence of gravity (or other external forces). Therefore, any rotation angle of the magnified image (either local of global) overt and/or surprising to a user of the device, with dynamic effects that are distinct or unexpected, further enhancing the effectiveness of the invention as a level 1 security feature. The relative sedimentation speed or displacement speed of the microscopic entities in the magnified image may also be used as a reference to evaluate the local magnification factor. For more traditional “static” micro-optic devices, this reference may not be readily determined, as the device user simply has no way to identify the rotation angle or magnification factor of the magnified image (for example, for such static device this would require imaging the device under a microscope, etc.). Accordingly, this presents yet further advantages to the devices disclosed here

### Example 8—Further Moiré Magnification with Different Zones

FIG. 27 illustrates further example embodiments for devices comprising different zones with alternative optical effects. Such alternative optical effects may be caused by different properties of either the microchamber array and/or the microlens array in different areas of the device. For example, FIG. 27 parts a) and b) illustrate top plan views of an example device, with an area in the shape of a maple leaf exhibiting alternative microchamber rotation and scale compared with the surrounding area. FIG. 27 part b) shows how the optical properties of the microchamber array for the leaf area are different from those of the surrounding area—in this instance the leaf area is scaled and rotated by a different amount relative to the microlens array (0.990× and 0.0°), and relative to the surrounding area of the device (1.010× and 0.573°). In this way, the shape of the leaf can be distinguished by a user or observer of the device over its surrounding area, by virtue of the properties of the microlens arrays and/or the properties of the microchamber array, even if the array of the other of the microlens or microchamber array is consistent or non-varying across the device. In this example, a difference in rotation and/or magnification of the leaf area may achieve a dynamic float or depth effect for the leaf, together with alternative perceived motion of particules retained within the microchambers. FIG. 27 part d) provides a table of selected parameters of example devices designed and fabricated.

FIG. 28 provides schematic illustrations showing how the devices A-F listed in FIG. 27 part d) may appear from the perspective of a user when held vertically, with the numbers showing degrees of magnification (the maple leaf areas exhibiting 50% or 25% magnification relative to the magnification in the surrounding area), together with the arrows showing the apparent dynamic motion of particles collectively observed in the moiré magnified images, resulting from degrees of rotation of the images.

FIG. 29 provides photographs a), b) and c) of devices corresponding to those schematically illustrated in FIGS. 27 and 28, showing a maple leaf shape with a lower magnification and different rotation relative to the surrounding areas. In each photograph the device is positioned within a window of a sample banknote substrate. Dynamic movement and collective virtual imaging of the movement of particles within microchambers (which have a lighter colour within the hexagonal moiré magnified microchambers relative to the darker liquid also present) may be observed as the device is tilted or flipped over. The alternative direction of the dynamic motion within the maple leaf relative to the surrounding area is notably similar to device layout B illustrated schematically in FIG. 28.

### Example 9—Testing Dual or Multiple Particle Systems

Testing was carried out with devices comprising microchambers, each comprising a liquid media containing more than one type of particle or moveable entity. Specifically, the different types of particles or moveable entities included those with different densities relative to one another, and relative to the liquid media within which they are contained.

For example, such devices may generate more complex or overt visual effects by the inclusion of particles some of which have a tendency under gravity to float in the liquid (because they are less dense than the liquid within which they are immersed) while others have a tendency under gravity to sink in the liquid (because they are more dense than the liquid within which they are immersed). Various combinations of particles were tested, as illustrated in FIG. 30.

FIG. 30 provides photographs of a working example device with microchambers each containing a liquid and floating green particles together with sedimenting grey particles, with moiré magnification of the microchambers achieved with an associated microlens array. A virtual moiré magnified image as observable by a user is provided in FIG. 30a showing the relative positions within the magnified microchamber images of the different particle types. FIG. 30b provides a series of photographs of the same device at various times after reorientation by rotating the device about its plane. Common motion of particles within the microchambers was observed in the moiré magnified image, as the lighter green particles floated up one side of the magnified microchamber image, while common motion of the sedimenting grey particles was observed as they passed down an opposite side of the magnified microchamber image.

### Example 10—Moiré Magnification of 3D Microstructures

Optical association of image generators, such as microlens arrays, with arrays of microchambers, is noted to result in additional optical effects compared to those involving motion of entities within the microchambers. For example, moiré magnification of the three-dimensional structures of the microchambers themselves, and the walls of the microchambers, is achievable with appropriate moiré magnification, which in turn may contribute to the overall optical effect and perception of the device by a user. Such effects and perceptions may be tailored according to the properties of the microlenses and the microchambers, for example to adapt the focal lengths of the microlenses relative to the walls and the sizes of the microchambers.

FIG. 31 provides photographs showing moiré magnified images of selected embodiments, in which the three-dimensional structures of the microchambers are visible and perceptible in the magnified image when the device is manipulated and/or tilted, thereby providing a corresponding three-dimensional virtual image of the microchambers. For example, FIGS. 31a and 311b provide still images of this effect, with magnification of microchambers containing a liquid. Even microstructures of empty microchambers (empty in that they contain air rather than liquid) are amenable to such three-dimensional moiré magnification, as may be seen for example in the photographs provided in FIGS. 31c and 31d.

Accordingly, further embodiments include devices in which the three-dimensional moiré magnification of microchamber arrays contributes to, or replaces in terms of visual perception, moiré magnification of the contents of such microchambers.

### Example 11—Testing Alternative Microchamber Geometries

Various microchamber internal surface geometries and relief structures have been generated for testing purposes, some of which have already been described. Such fabrication included surface relief within microchambers with two depth levels to explore how raised/etched structures can be used to further enhance the magnified dynamic images of the moveable entities or particles within the microchambers.

For example, microchambers were generated with various geometries (e.g. $/dollar signs, snow flakes, etc.) and tested in terms of their capacity to be filled with liquid, optionally with moveable entities immersed in the liquid. Through moiré magnification, such devices reveal to the observer both the shape of the microfluidic chambers and/or the relief features they contain, as well as the displacement of the particles or other moveable entities if additionally present within the microchambers. For example, the user may observe magnified snowflake chambers with particles or bubbles moving during note manipulation, with interaction with the complex shape of the sidewalls.

Alternatively, in other embodiments, the overall shape of the microchambers may be preserved, but the patterned relief structures may be extended up to the roof of the chambers.

Further example embodiments are described and illustrated with reference to FIG. 32. In FIG. 32a there are shown schematically a top plan view of a hexagonal array of microchambers each comprising surface relief at the “bottom” of each microchamber (opposite the microlens array), comprising relief of dollar signs approximately 5 μm in height extending from the floor of each microchamber. FIG. 32b shows schematically a top plan view of a hexagonal array or microchambers similar to FIG. 32a, but with each microchamber comprising surface relief in the shape of snowflakes extending 3-5 μm in height from the floor of each microchamber. FIG. 32c shows a perspective scanning electron micrograph of a fabricated device corresponding to that shown in FIG. 32a, showing microchambers with fabricated dollar signs in relief extending in height only part way of the full height of the walls of the microchambers. In this way, the surface relief generated in each microchamber may be similar to that illustrated schematically in FIG. 11.

FIG. 32d shows schematically a top plan view of arrays of microchambers, with the darker dollar sign or snowflake shapes indicative of the shapes of the microchambers themselves, and their side walls. However, by way of contrast to FIG. 32d, FIG. 32e schematically illustrates alternative concepts in which the microchambers are effectively a “negative” of those shown in FIG. 32d. Again, the darker dollar signs and snowflake shapes are indicative of the shapes of the microchambers themselves, and their side walls, which are defined as the areas surrounding the dollar signs and the snowflakes, and which themselves do not contain any fluid as they comprise microchamber side-wall material or a similar structure. Accordingly, the microchambers may comprise any shape or configuration, and be generated by any means of fabrication, including printing, etching and molding techniques, that are known in the art.

FIG. 32f provides a photograph of a top plan view of a working example moiré magnification device, where the microchambers are each in the shape of a dollar symbol ($).

### Example 12—Further Testing of Brownian Motion Embodiments

Selected embodiments that involve Brownian or random motion of particles have been described previously, for example with reference to Example 6. Further studies as described in the present example have helped develop and tune such embodiments for practical application.

As described in Example 6, the use of microlenses can be combined with particles, e.g. microscopic particles, suspended in a fluid to enable visualization of the particles as they pass through the focal points of the microlenses. For example, with such features the inventors have shown a capacity to create overt, continuously or selectively dynamic shimmering caused by magnified images of the Brownian motion of microparticles.

A series of new investigations were undertaken to evaluate in more detail useful conditions for Brownian motion to be amplified by a microlens array, to generate overt shimmering visual effects. Selected questions that were considered for such investigations included: What is the typical speed associated with Brownian motion of various types of particles after amplification through microlens arrays? What shimmering frequency leads to the most overt effects? What is the effect of the particles size, shape, and optical properties (color, roughness, etc.) on the contrast that microlenses can provide? What is the optimal trade-off between high contrast and effective time constant? Are there some specific lighting configurations that can significantly amplify the visualization of random or Brownian motion? What are the minimal microlens array sizes that may lead to overt effects? Can the microfluidic devices be combined with other fixed masking features to amplify further the effects of particle displacement in the device? How do the key intrinsic properties of Brownian motion affect particle motion and speed under the microlens arrays?

Experiments were conducted using both numerical modelling as well as working examples

From Einstein's theory of Brownian motion, the mean squared displacement (i.e. variance) of a particle distribution is given by:
[symbol] x² [symbol] =2nDt, or standard deviation: σ=\sqrt{2nDt}
where D is diffusivity, t is time elapsed and n is the number of dimensions where the random displacement takes place. For a spherical particle, the diffusivity is given by:

$$D = \frac{{k}_{B} T}{6 πη r}$$

where k_{B} is Boltzmann's constant, T is temperature, η is the dynamic viscosity of the fluid, and r the particle radius.

A “time constant” t_{L} can be defined as the time required for the particles distribution to reach a mean square displacement equal to L² (i.e., [symbol] x² [symbol] ≡L²).

$$〈 {x}^{2} 〉 ≡ {L}^{2} = 2 {nDt}_{L} ⇒ {t}_{L} = \frac{6 πη {rL}^{2}}{2 {n}_{B} T}$$

This time constant provides a practical value indicative of the time needed for the particles to migrate by a distance L.

Accordingly, assuming perfect microlenses, the characteristic time constant that a particle stays in the focal point of a microlens, as shown in FIG. 33a, may be estimated by considering that the characteristic distance associated with a change in the image contrast is given by the particle radius (i.e. L˜r). Thus, in accordance with FIG. 33b the time constant required to change significantly the image of the microlens increases very rapidly with the particle size (˜r³). Using this simple approximation, it may be found that, for translational BM, appropriate particle size to provide effects with the ideal time scale of 0.1 to 2 s appears to lie in the preferred range of 0.7 to 2 μm, whereas particles larger than 3 μm may lead to slower effects by comparison.

A 3D random walk algorithm was programmed to simulate the translational and rotational Brownian motion of thousands of particles simultaneously. This software has certain limitations. For example, the software used did not allow for particle-to-particle or particle-to-sidewall interactions. For each time step Δt, uniformly distributed random values are added to the position (x, y, z) and rotation angles θₓ, θ_{y} and θ_{z} of each particle. The width a of the uniformly distributed random values is computed to provide a the target variance [symbol] x² [symbol] associated with the physics of Brownian motion for the specific target particle:

$$〈 {x}^{2} 〉 = \frac{{a}^{2}}{3} = 2 D Δ t$$

For example, for a spherical particle:

$$a = \sqrt{6 D Δ t} = \sqrt{\frac{{k}_{B} T Δ t}{πη r}}$$

FIG. 34 shows various top plan views of a simulated feature or device on a bank note, with Brownian motion of spherical particles of 1.5 μm size placed under a microlens array, with FIG. 34 part a) showing a 1× view, FIG. 34 b) showing a 100× microscopic view through simulated microlenses, and FIG. 34 c) showing a 400× microscopic view without microlenses present.

Further analyses were performed to see if interesting visuals effects can be achieved from the rotation of flat reflective particles. The mean squared displacement [symbol] x² [symbol] and rotation angle [symbol] θ² [symbol] for a particle distribution is given by:

[symbol]

x² [symbol] =2nDt [symbol] θ² [symbol] =2nD_{θ}t

For spherical particles:

$$D = \frac{{k}_{B} T}{6 πη r}$$

$${D}_{θ} = \frac{{k}_{B} T}{8 πη {r}^{3}} ⇒ {t}_{θ} = \frac{{θ}_{0}^{2}}{2 {nD}_{θ}} = \frac{4 πη {r}^{3} {θ}_{0}^{2}}{{nk}_{B} T}$$

Whereas, in contrast, for simulated thin ellipsoid particles:

$${D}_{‖} = \frac{{k}_{B} T}{16 η r} , {D}_{⊥} = \frac{3 {k}_{B} T}{32 η r} ( Independent of thickness )$$

$${D}_{θ} = \frac{3 {k}_{B} T}{32 η {r}^{3}} ⇒ {t}_{θ} = \frac{{θ}_{0}^{2}}{2 {nD}_{θ}} = \frac{16 η {r}^{3} {θ}_{0}^{2}}{3 {nk}_{B} T}$$

$$Note : rotational diffusivity may be the same for any axis through the center mass .$$

For example, 4 μm diameter flakes that rotate by 15 deg (in 2.2 cP liquid at 23° C.) have a time constant t_{θ}≈0.5 s. Accordingly, while the translational and rotational diffusivity for cylindrical particles cannot be readily computed analytically, Brownian motion of thin flakes can be estimated from analytical values computed for ellipsoids.

To illustrate this model, FIG. 35 shows a schematic microscopic view of 4 μm cylindrical flakes placed under a microlens array experiencing translational and rotational Brownian motion. The simulation studied the effects of flake rotation upon the perception of the flakes as they undergo Brownian motion, first evaluated for 4 μm diameter flakes, with illumination by a 20 cm diameter light source placed on the side of the bank note. In the simulations, flakes were free to rotate in all orientations. In practice, flakes may, in some embodiments, be more likely to sediment on a surface of the device (for example internal surface of microchambers), which might limit their freedom for rotation depending on the relative importance of rotational Brownian motion and convective gravitational forces (Peclet number).

FIG. 36 shows the amount of reflected light visible by an observer as a function of rotation angle of the flakes placed under a microlens array. Large contrast changes (>20 to 1) with small changes in the flake angle were obtained in this configuration. Various reflections spikes were also observed due the complex light path through the microlens array and flake reflection.

FIG. 37, illustrating a further simulation, shows that fast shimmering and good contrast could be obtained through rotational Brownian motion of reflective flakes—in this case 4.0 μm low roughness cylindrical flakes, with a large side light are shown in FIG. 40a with a 1× view, and FIG. 40b with a 100× microscopic view. As the flakes were reflecting the light source only for a narrow range of angles, fast shimmering was observed in the simulation (time constant of about 0.5 s). Further, depending on scene illumination, the reflected light intensity could be very high compared with background light levels, leading to clearly visible shimmering with good contrast despite the use of very small microlenses (50 μm).

FIG. 38 illustrates a working example to evaluate Brownian motion effects with a 54 μm pitch MLA at high Moiré magnification, with an ink containing flat reflective flakes. While Moiré magnification does not affect Brownian motion directly, high magnification indicates that that shimmering is much more visible at the transition between regions with and without flakes. In these regions, flakes may be less packed and therefore free to experience more significant translational and/or rotational Brownian motion. FIG. 38a shows photos (stills from videos) of a device in a window of a bank note at various magnifications, showing moiré magnification of particles undergoing Brownian motion. FIG. 38b shows a microscopic bottom view of the microchambers present in the device, without moiré magnification as no microlenses are present from this bottom view.

These additional analyses and embodiments that employ Brownian motion of particles, optionally with moiré magnification of the same, illustrate that the use of different particle types, shapes and configurations may confer specific advantages in terms of the visual effects generated. Notably, particles that include flat or reflective surfaces may, in some instances, generate striking visual effects resulting from rotational random or Brownian motion of particles, near to or within focal points of microlenses, thus aiding visual perception of the device by a user. Such effects may include, but are not limited to, magnification of the dynamic optical contrast generated by the random motion of the microscopic entities, ideally allowing naked eye visualization of Brownian motion-induced shimmering under appropriate lighting and visualization conditions.

### Example 13—Further Examples of Numerical Simulations and 3D Modelling

Computer simulation and numerical modelling of selected embodiments has proven valuable to assess device potential and optical effects. The predictions of such simulations have been shown to be strikingly useful and accurate in some instances. This permits tailoring of optical properties by simulation before device manufacture. For example, significant developments have been made by the inventors to the numerical framework utilized to simulate moiré magnification.

In selected software versions, it is possible to simulate the complete 3D geometry of an entire micro-optic microfluidic feature using a parametric modelling scheme that can be readily tailored and adjusted during use. This in turn has enabled various configurations of the micro-optic microfluidic devices to be assessed more rapidly in terms of the visual effects generated.

Some advantages of such modelling include:
Fully parametric modelling that includes adjustment of microlens or microchamber array size and pitch, lens properties, microfluidic chamber properties, rotation and scale of arrays.
Integration of 3D objects in the chambers such as particles and bubbles. Adjustment of the level of particle/bubble synchronization between chambers.
Photorealistic path-tracing algorithms with full control of illumination of the simulated devices and materials properties of all components.
   This in turn has assisted the inventors to ask the following example questions, amongst others:
What is the optimal configuration to create overt magnified bubbles?
Can we magnify the 3D depth of the chambers?
What is the impact of imperfect synchronization of particles?
Should the lens focal point be on the top, middle or base of the microfluidic chamber for certain optical effects?
What is the impact of particles displacement in the Z direction on the sharpness of their magnified image?
What is the optimal device configuration to create overt effect from Brownian motion induced displacement of particles?

FIG. 39 shows an example computer simulated micro-optic device incorporated into a simulated bank note showing magnified image of microchambers filled with a transparent liquid and each containing a gas bubble. Simulation shows that overt visual effects are possible with such configuration. The simulated moiré magnified image reveals clearly the 3D geometry of the chambers and bubbles, as well as their dynamic movement, according to specific lighting conditions and simulated external influences. In this particular example, the following parameters were set for the simulation:
Array size: 20×20 mm
Array pitch: 54 μm
Chamber depth: 30 μm
Wall thickness: 4 μm
Lens substrate thickness: 72 μm
Lens RoC: 38 μm
Lens base diameter: 51 μm
Chamber relative scale: 0.995 vs microlenses
Chamber rotation angle: 0.0 deg
Bubble relative size: 30% of microchamber size
Liquid IOR: 1.30
Lens, substrate IOR: 1.56
Theoretical magnification: 199
Illumination: Simulated Interior illumination

FIG. 40 provides another example computer simulated devices. Particle positional noise is seen to create a gradual blurring of the magnified image of the particles. This allows quantification of the synchronization tolerance for particle and bubble position to generate good visualisation of particle/bubbles in a magnified image for subsequently manufactured devices. The following parameters were established for the simulation:
Array size: 20×20 mm
Array pitch: 54 μm
Chamber depth: 30 μm
Wall thickness: 4 μm
Lens subs thickness: 72 μm
Lens RoC: 38 μm
Lens base diameter: 51 μm
Chamber rel. scale: 0.99 vs microlens
Chamber rot. angle: 0.0 deg
Particle relative size: 20% of microchamber size
Particle material: Red color
Liquid IOR: 1.30.
Lens, substrate IOR: 1.56
Theoretical mag.: 99
Illumination: Simulated Interior illumination

In the top row of images for FIG. 40 (with magnified versions inset) top plan views of a device comprising an array of hexagonal microchambers, each containing a single red particle, are observed in the simulation, with higher degrees of positional variation or uncertainty in the particle position causing blurring of the bubble's appearance in the simulated moiré magnified image. The middle and lower images show microscopic (without simulated moiré magnification) top and side schematic views of the same device (without simulated moiré magnification), showing increasing degrees of positional variation for the particles in the microchambers from left to right, which in turn gives rise to increased degrees of blurring of the particle magnified images as visible in the top row from left to right.

These further example images demonstrate the existing value and future potential for computer and numerical simulations for the devices disclosed herein, to tailor the devices to achieve or design specific optical properties.

### EMBODIMENTS

The following, non-limiting list of example embodiments are encompassed within the present disclosure:
Embodiment 1: a device comprising:
   an array of compartments;
   one or more entities, with at least a majority of the compartments containing one or more of the entities therein, each entity moveable within the compartment within which it is contained when the device is subjected to an external influence or force, wherein resulting movement of at least some of the entities includes common, at least partially synchronized movement thereof, within and relative to their respective compartments, across at least a portion of the compartments; and
   an image generator to selectively combine at least some of the common, synchronized movement of the entities within and relative to their respective compartments into an observable image.
Embodiment 2: the device of claim 1, wherein the entities comprise one or more of: liquids, gases, solids, particles, flakes, beads, Janus particles, liquid-containing particles, gas-containing particles, bubbles, foam particles, foam beads.
Embodiment 3: the device of embodiment 1 or 2, wherein the compartments comprise walls to prevent loss or leakage of the one or more entities contained in each compartment, and to separate the contents of the compartments from one another.
Embodiment 4: the device of embodiment 1, 2 or 3, wherein the entities also undergo random or non-synchronized movement that does not substantially contribute to the observable or detectable image, or that is selectively removed from the observable or detectable image.
Embodiment 5: the device of any one of embodiments 1 to 4, wherein the external influence or force comprises gravity, and at least some of the entities are caused to fall or to float within the compartments under the influence of gravity, thereby to generate said common, synchronized movement.
Embodiment 6: the device of any one of embodiments 1 to 5, wherein the external influence comprises one or more selected from:
   shaking the device;
   tipping the device;
   flipping the device;
   applying pressure to the device;
   removing pressure from the device;
   applying a discontinuous or continuous force to the device;
   rotating the device;
   re-orienting the device with respect to gravity;
   bending the device;
   spinning the device;
   folding the device; and
   crumpling the device.
Embodiment 7: the device of embodiment 1 wherein, to provide the common, synchronized movement, at least some of the entities undergo one or more of the following types of movement in response to the external influence or force:
   translocation;
   rotation;
   diffusion;
   falling under the influence of gravity in a gaseous or liquid medium;
   floating in a gaseous or liquid medium.
Embodiment 8: the device of embodiment 1 wherein, other than the one or more entities, each compartment comprises one or more selected from the group consisting of: fluid media, dispersion media, compressible media and deformable media.
Embodiment 9: the device of embodiment 8, wherein the fluid media within each compartment is flowable about the compartment in response to the external stimulus.
Embodiment 10: the device of embodiment 8, wherein the fluid media fills each compartment and otherwise further contains the one or more entities in particulate form.
Embodiment 11: the device of embodiment 10, wherein the fluid media comprises a liquid, a gaseous media, or a mixture thereof.
Embodiment 12: the device of any one of embodiments 1 to 11, which is a moiré magnification device, comprising:
   as the image generator, an array of microlenses or micromirrors;
   as the array of compartments, a 2-dimensional array of microchambers in association with the array of microlenses;
   wherein the microlenses and microchambers are arranged such that the array of microlenses or micromirrors generate a moiré magnified image of at least a portion of selected microchambers and/or their at least a portion of their contents, as the observable image.
Embodiment 13: the device of embodiment 12, wherein each microchamber is filled with a composition comprising:
   (i) a liquid, such that the liquid is sealed into each microchamber; and
   (ii) at least one entity immersed in the liquid within at least a majority of the microchambers, the at least one entity insoluble or immiscible in the liquid, the at least one entity freely movable by rotation and/or translocation within the liquid when the device is subjected to an external influence or force.
Embodiment 14: the device of embodiment 12, wherein the array of microchambers comprises an area of adjacent microchambers each filled with the same or substantially the same compositions compared to other microchambers in said area, so that when the device is subjected to the external influence or force, the compositions within the adjacent microchambers within said area react within their respective microchambers in a uniform or substantially uniform manner in terms of movement of the entities they contain, such that the collective movement of the entities within the microchambers of the area forms at least a part of the moiré magnified image.
Embodiment 15: the device of embodiment 12, wherein at least some of the entities are freely movable within and through the liquid within which it is immersed, by dynamic displacement of the liquid, when the device is subjected to an external influence that is an external force.
Embodiment 16: the device of embodiment 14, wherein the array of microchambers comprises an area of adjacent microchambers each filled with the same or substantially the same compositions compared to other microchambers in said area, so that when the device is subjected to the external influence or force the compositions within the adjacent microchambers within said area react in a uniform or substantially uniform manner in terms of translating movement of the entities they contain and/or the resulting dynamic displacement of the liquid caused by translating movement of the entities they contain, such that the collective translating movement and/or the dynamic displacement forms at least a part of the moiré magnified image.
Embodiment 17: the device of any one of embodiments 12 to 16, wherein at least some of the entities, or at least a portion of at least some of the entities, have a density that is different compared to the density of the liquid within which it is immersed.
Embodiment 18: the device of any one of embodiments 12 to 16, wherein the microlenses are convex microlenses, or concave micromirrors, each with an average diameter of less than 200 μm, preferably less than 60 μm.
Embodiment 19: the device of embodiment 12, wherein the microchambers each contain a composition that comprises an aqueous liquid.
Embodiment 20: the device of embodiment 12, wherein at least some of the entities each have an overall average density that is greater than the density of the liquid within which they are immersed, such that they have a tendency to sink and/or to sediment within the microchambers under the force of gravity.
Embodiment 21: the device of embodiment 19, wherein the at least one entity in each microchamber comprises one or more of: particles, flakes, beads, Janus particles, immiscible liquid particles or droplets, liquid-containing particles, gas-containing particles, microfabricated particles and engineered particles.
Embodiment 22: the device of embodiment 21, wherein the at least one entity in each microchamber comprises metal, metallic particles or flakes.
Embodiment 23: the device of embodiment 20, wherein at least 90% of the entities that each have an overall average density that is greater than that of the liquid within which they are immersed, sediment under the influence of gravity to the bottom surface of the microchambers within 0.1-30 seconds following stationary placement of the device.
Embodiment 24: the device of embodiment 12, wherein at least some of the entities forming part of the compositions each have an overall average density that is less than the density of the liquid within which they are immersed, such that they have a tendency to float within the microchambers under the force of gravity.
Embodiment 25: the device of embodiment 24, wherein the at least one entity in each microchamber comprises one or more selected from: particles, flakes, beads, Janus particles, immiscible liquid particles or droplets, gas-containing particles, bubbles, foam particles, and foam beads.
Embodiment 26: the device of embodiment 25, wherein at least 90% of the entities that each have an overall average density that is less than that of the liquid within which they are immersed float to the top surface of the microchambers within 0.1-30 seconds following stationary placement of the device.
Embodiment 27: the device of embodiment 17, comprising at least some entities each having an overall average density that is greater than the density of the liquid within which they are immersed, such that they have a tendency to sink and/or to sediment within the microchambers under the force of gravity, and also comprising entities each having an overall average density that is less than the density of the liquid within which they are immersed, such that they have a tendency to float within the microchambers under the force of gravity
Embodiment 28: the device of any one of embodiments 12 to 27, wherein at least some of the microchambers comprise one or more of the following features or configurations:
   cuboid microchambers;
   hexagonal prism microchambers
   spherical or elliptical microchambers;
   asymmetrical microchambers;
   microchambers comprising at least some curved walls;
   microchambers with an hour-glass configuration;
   microchambers with sloped walls; and
   microchambers with walls comprising surface content or relief.
   microchambers having walls arranged in a distinctive pattern or shape.
Embodiment 29: the device of any one of embodiments 12 to 28, wherein at least some of the microchambers are structured to guide or to position selected moveable entities, optionally upon application of the external influence, or optionally upon removal of the external influence, to position the moveable entities into or out of the focal plane of the microlenses, or to transition the moveable particles through the focal place of the microlenses.
Embodiment 30: the device of embodiment 29, wherein the moveable entities dissipate or diffuse within the compartments when not guided or positioned within the compartments by the presence or absence of the external influence and/or the structure of the compartments.
Embodiment 31: the device of embodiment 28, wherein at least some of the microchambers comprise walls with surface content or relief, wherein the surface content or relief is visible as part of the moiré magnified image when the entities within the microchambers to arrange themselves with respect to the surface content or relief following exposure of the device to an external influence or force.
Embodiment 32: the device of embodiment 30, wherein at least some of the entities have an overall average density that is greater than the liquid medium within which they are immersed, such that those entities sink within the microchambers, thereby to fill, to become distributed by, or to surround the surface content or relief when positioned at a bottom of the microchambers when appropriately oriented with respect to gravity.
Embodiment 33: the device of embodiment 27, wherein at least some of the entities have an overall average density that is less dense than the liquid medium within which they are immersed, such that those entities float within the microchambers thereby to fill, distribute themselves about, or surround the surface content or relief positioned at a top of the microchambers when appropriately oriented with respect to gravity.
Embodiment 34: the device of embodiment 12, wherein the liquid within at least some microchambers comprises one or more of: aqueous liquids, water, organic liquids, oils, solutes, salts, buffers, dyes, viscosity enhancing agents, viscosity reducing agents, surfactants, dispersants, synergists, stabilizers, dispersion agents, emulsifiers, charge control agents, anti-static agents, anti-foaming agent and other additives, or mixtures thereof.
Embodiment 35: the device of any one of embodiments 12 to 34, wherein the relative pitches and/or angles of the microlenses relative to the microchambers within at least some portions of the device, provide a moiré magnified image in which the movement of the entities and/or the dynamic displacement of the liquid within the microchambers is observed to progress non-parallel with the force of gravity, or opposite to the force of gravity, such that the movement and/or the dynamic displacement appears to defy gravity.
Embodiment 36: the device of embodiment 35, comprising multiple areas of the device with alternative pitches and/or angles of the microlenses relative to the microchambers within the different areas, to provide a composite moiré magnified image in which the movement of the entities and/or the dynamic displacement of the liquid within the microchambers is observed to progress in multiple non-parallel directions relative both to gravity and a plane of the microlens array, such that the movement and/or the dynamic displacement appears to defy gravity in multiple directions.
Embodiment 37: the device of any one of embodiments 12 to 36, wherein the relative pitches and/or angles of the microlenses as arranged relative to the microchambers within at least some portions of the device permit the degree of magnification of the image to differ locally in the device, to alter the virtual image and/or the perceived displacement speed and/or direction of displacement of the entities.
Embodiment 38: the device of any one of embodiments 12 to 37, wherein the relative pitches and/or angles of the microlenses as arranged relative to the microchambers within at least some portions of the device permit the magnification and/or rotation of the image to differ locally in the device to alter the virtual image and/or the perceived displacement speed and/or direction of displacement of the entities.
Embodiment 39: a security device comprising:
   one or more compartments, optionally arranged as an array of compartments, each containing one or more entities that each have the capacity for independent movement within the compartments, said movement comprising randomized or Brownian motion of entities within at least a portion of the compartments; and
   a magnifier to magnify said randomized or Brownian motion within each compartment, or a plurality of compartments, into an observable optical dynamic effect or dynamic image.
Embodiment 40: the device of embodiment 39, wherein the entities comprise one or more of: liquids, gases, solids, particles, flakes, beads, Janus particles, liquid-containing particles, gas-containing particles, bubbles, foam particles, and foam beads.
Embodiment 41: the device of embodiment 39 or 40, wherein the compartments comprise walls to prevent loss or leakage of the one or more entities, and to separate the contents of the compartments from one another.
Embodiment 42: the device of embodiment 39, wherein a degree of the randomized or Brownian motion of entities is influenced by an external influence or force, that comprises one or more selected from:
   shaking the device;
   tipping the device;
   flipping the device;
   applying more or less pressure to the device;
   applying a brief, discontinuous or continuous force to the device;
   rotating the device; and
   re-orienting the device with respect to gravity.
Embodiment 43: the device of embodiment 42, wherein the one or more entities are particulate, and other than the one or more entities, each compartment is filled with one or more liquid, each compartment otherwise containing the one or more entities immersed therein.
Embodiment 44: the device of any one of embodiments 39 to 43, comprising:
   as the magnifier, an array of microlenses or micromirrors;
   as the array of compartments, an array of microchambers in association with the array of microlenses or micromirrors;
   wherein the microlenses or micromirrors, and the microchambers, are arranged such that each microlens or micromirror magnifies a small portion of an associated microchamber corresponding to the microlen's or micromirror's focal point, to provide an image of the small portion of the microchamber to an observer.
Embodiment 45: the device of embodiment 44, wherein each microchamber is filled with a composition comprising:
   (i) a liquid, such that the liquid is sealed into each microchamber; and
   (ii) a plurality of particulate entities immersed in the liquid within each microchamber, the entities insoluble or immiscible in the liquid, the entities freely movable by rotation and/or translocation within the liquid through the action of random or Brownian motion;
   (iii) the particulate entities have the capacity either for independent random or Brownian motion within the compartments, or random or Brownian motion when the device is subjected to an external influence or force.
Embodiment 46: the device of embodiment 45, wherein the entities comprise particles or flakes, and wherein the random or Brownian motion of the particles or flakes causes each microlens to appear to flash on or off when viewed with the assistance of a corresponding microlens or micromirror, depending upon the relative position and/or orientation of one or more of said particles or flakes as they intersect or pass across the focal point of each microlens or micromirror by random or Brownian motion, at any given time.
Embodiment 47: the device of embodiment 45 or 46, wherein each entity is freely movable within and through the liquid within which it is immersed, by dynamic displacement of the liquid, when the device is subjected to an external influence or force.
Embodiment 48: the device of any one of embodiments 44 to 47, wherein the microlenses are convex microlenses, or the micromirrors are concave micromirrors, each with an average diameter of greater than 200 μm.
Embodiment 49: the device of any one of embodiments 44 to 48, wherein the microchambers each contain a composition that comprises an aqueous liquid.
Embodiment 50: the device of any one of embodiments 44 to 49, wherein the at least one entity in each microchamber comprises metal, metallic particles or flakes.
Embodiment 51: the device of any one of embodiments 44 to 50, wherein comprising reflective entities that reflect light or other incident electromagnetic radiation, the entities optionally each comprising one or more flat or substantially flat reflective surfaces that reflect radiation to a user as the entity moves or rotates during said random or Brownian motion.
Embodiment 52: the device of any one of embodiments 44 to 51, wherein the liquid within at least some microchambers comprises one or more of: aqueous liquids, water, organic liquids, oils, solutes, salts, buffers, dyes, viscosity enhancing agents, viscosity reducing agents.
Embodiment 53: the device of any one of embodiments 1 to 38, wherein the compartments and the image generator are physically distant from one another.
Embodiment 54: the device of embodiment 53, wherein the compartments and the image generator are adhered to opposite sides of an item or document, in optical association with one another.
Embodiment 55: the device of any one of embodiments 1 to 54, for use as a security or authentication device.
Embodiment 56: use of the device of any one of embodiments 1 to 54, to provide security or authentication to a document or device.
Embodiment 57: a security or authentication device, comprising the device of any one of embodiments 1 to 54.
Embodiment 58: a document or device comprising, as a security or authentication feature, one or more device according to any one of embodiments 1 to 54.

The examples described and illustrated herein are exemplary only. The nature of the devices, the microchambers, the liquids and moveable entities they may contain, or other aspects of embodiments herein described, may be adapted or tuned to achieve different degrees of motion, different rates of motion, and different optical effects depending upon the nature of the fluid media and moveable entities present, as well as the nature of the moiré magnification.

It is understood that the security devices and features, and methods for their production and use, as well as related technology employed in the embodiments described and illustrated herein, may be modified in a variety of ways which will be readily apparent to those skilled in the art of having the benefit of the teachings disclosed herein. All such modifications and variations of such embodiments thereof shall be deemed to be within the scope and spirit of the present invention as defined, or defined in part, by the claims appended hereto.

1. A device comprising:
an array of compartments;
one or more entities, with at least a majority of the compartments containing one or more of the entities therein, each entity moveable within the compartment within which it is contained when the device is subjected to an external influence or force, wherein resulting movement of at least some of the entities includes common, at least partially synchronized movement thereof, within and relative to their respective compartments, across at least a portion of the compartments; and
an image generator to selectively combine at least some of the common, synchronized movement of the entities within and relative to their respective compartments into an observable image.

2. The device of claim 1, wherein the entities comprise one or more of: liquids, gases, solids, particles, flakes, beads, Janus particles, liquid-containing particles, gas-containing particles, bubbles, foam particles, foam beads.

3. The device of claim 1, wherein the compartments comprise walls to prevent loss or leakage of the one or more entities contained in each compartment, and to separate the contents of the compartments from one another.

4. The device of claim 1, wherein the entities also undergo random or non-synchronized movement that does not substantially contribute to the observable or detectable image, or that is selectively removed from the observable or detectable image.

5. The device of claim 1, wherein the external influence or force comprises gravity, and at least some of the entities are caused to fall or to float within the compartments under the influence of gravity, thereby to generate said common, synchronized movement.

6. The device of claim 1, wherein the external influence comprises one or more selected from:
shaking the device;
tipping the device;
flipping the device;
applying pressure to the device;
removing pressure from the device;
applying a discontinuous or continuous force to the device;
rotating the device;
re-orienting the device with respect to gravity;
bending the device;
spinning the device;
folding the device; and
crumpling the device.

7. The device of claim 1 wherein, to provide the common, synchronized movement, at least some of the entities undergo one or more of the following types of movement in response to the external influence or force:
translocation;
rotation;
diffusion;
falling under the influence of gravity in a gaseous or liquid medium;
floating in a gaseous or liquid medium.

8.-11. (canceled)

12. The device of claim 1, which is a moiré magnification device, comprising:
as the image generator, an array of microlenses or micromirrors;
as the array of compartments, a 2-dimensional array of microchambers in association with the array of microlenses;
wherein the microlenses and microchambers are arranged such that the array of microlenses or micromirrors generate a moiré magnified image of at least a portion of selected microchambers and/or their at least a portion of their contents, as the observable image.

13. The device of claim 12, wherein each microchamber is filled with a composition comprising:
(i) a liquid, such that the liquid is sealed into each microchamber; and
(ii) at least one entity immersed in the liquid within at least a majority of the microchambers, the at least one entity insoluble or immiscible in the liquid, the at least one entity freely movable by rotation and/or translocation within the liquid when the device is subjected to an external influence or force.

14. The device of claim 12, wherein the array of microchambers comprises an area of adjacent microchambers each filled with the same or substantially the same compositions compared to other microchambers in said area, so that when the device is subjected to the external influence or force, the compositions within the adjacent microchambers within said area react within their respective microchambers in a uniform or substantially uniform manner in terms of movement of the entities they contain, such that the collective movement of the entities within the microchambers of the area forms at least a part of the moiré magnified image.

15. The device of claim 12, wherein at least some of the entities are freely movable within and through the liquid within which it is immersed, by dynamic displacement of the liquid, when the device is subjected to an external influence that is an external force.

16. The device of claim 14, wherein the array of microchambers comprises an area of adjacent microchambers each filled with the same or substantially the same compositions compared to other microchambers in said area, so that when the device is subjected to the external influence or force the compositions within the adjacent microchambers within said area react in a uniform or substantially uniform manner in terms of translating movement of the entities they contain and/or the resulting dynamic displacement of the liquid caused by translating movement of the entities they contain, such that the collective translating movement and/or the dynamic displacement forms at least a part of the moiré magnified image.

17. The device of claim 12, wherein at least some of the entities, or at least a portion of at least some of the entities, have a density that is different compared to the density of the liquid within which it is immersed.

18. The device of claim 12, wherein the microlenses are convex microlenses, or concave micromirrors, each with an average diameter of less than 200 μm or less than 60 μm.

19. (canceled)

20. The device of claim 12, wherein at least some of the entities each have an overall average density that is greater than the density of the fluid within which they are immersed, such that they have a tendency to sink and/or to sediment within the microchambers under the force of gravity.

21. The device of claim 19, wherein the at least one entity in each microchamber comprises one or more of: particles, flakes, beads, Janus particles, immiscible liquid particles or droplets, liquid-containing particles, gas-containing particles, microfabricated particles and engineered particles.

22.-26. (canceled)

27. The device of claim 17, comprising at least some entities each having an overall average density that is greater than the density of the liquid within which they are immersed, such that they have a tendency to sink and/or to sediment within the microchambers under the force of gravity, and also comprising entities each having an overall average density that is less than the density of the liquid within which they are immersed, such that they have a tendency to float within the microchambers under the force of gravity

28. The device of claim 12, wherein at least some of the microchambers comprise one or more of the following features or configurations:
cuboid microchambers;
hexagonal prism microchambers
spherical or elliptical microchambers;
asymmetrical microchambers;
microchambers comprising at least some curved walls;
microchambers with an hour-glass configuration;
microchambers with sloped walls; and
microchambers with walls comprising surface content or relief.
microchambers having walls arranged in a distinctive pattern or shape.

29.-30. (canceled)

31. The device of claim 28, wherein at least some of the microchambers comprise walls with surface content or relief, wherein the surface content or relief is visible as part of the moiré magnified image when the entities within the microchambers to arrange themselves with respect to the surface content or relief following exposure of the device to an external influence or force.

32.-34. (canceled)

35. The device of claim 12, wherein the relative pitches and/or angles of the microlenses relative to the microchambers within at least some portions of the device, provide a moiré magnified image in which the movement of the entities and/or the dynamic displacement of the liquid within the microchambers is observed to progress non-parallel with the force of gravity, or opposite to the force of gravity, such that the movement and/or the dynamic displacement appears to defy gravity.

36.-37. (canceled)

38. The device of claim 12, wherein the relative pitches and/or angles of the microlenses as arranged relative to the microchambers within at least some portions of the device permit the magnification and/or rotation of the image to differ locally in the device to alter the virtual image and/or the perceived displacement speed and/or direction of displacement of the entities.

39. A security device comprising:
one or more compartments, optionally arranged as an array of compartments, each containing one or more entities that each have the capacity for independent movement within the compartments, said movement comprising randomized or Brownian motion of entities within at least a portion of the compartments; and
a magnifier to magnify said randomized or Brownian motion within each compartment, or a plurality of compartments, into an observable optical dynamic effect or dynamic image.

40.-57. (canceled)

58. A document or device comprising, as a security or authentication feature, one or more device according to claim 1.
